(19) United States
(12) Patent Application Publication
(10) Pub. No.: US 2026/0081722 A1
(43) Pub. Date: Mar. 19, 2026

(54) METHODS, SYSTEMS, AND APPARATUS FOR RATELESS POLAR CODING AND LOW-COMPLEXITY DECODING

(71) Applicant: Huawei Technologies Co., Ltd., Shenzhen (CN)

(72) Inventors: Huazi Zhang, Hangzhou (CN); Jun Wang, Hangzhou (CN); Wen Tong, Ottawa (CA)

(21) Appl. No.: 19/336,351

(22) Filed: Sep. 22, 2025

Related U.S. Application Data
(63) Continuation of application No. PCT/CN2023/103893, filed on Jun. 29, 2023.
(60) Provisional application No. 63/454,068, filed on Mar. 23, 2023.
(60) Provisional application No. 63/454,067, filed on Mar. 23, 2023.
(60) Provisional application No. 63/454,066, filed on Mar. 23, 2023.

(30) Foreign Application Priority Data
Mar. 23, 2023 (WO) PCT/CN2023/083345
Mar. 23, 2023 (WO) PCT/CN2023/083348
Mar. 23, 2023 (WO) PCT/CN2023/083350

(51) Int. Cl. H04L 1/00

(52) U.S. Cl. CPC H04L 1/0071; H04L 1/0057

(57) ABSTRACT

A reduced number of interleaved encoded bits is obtained by encoding input bits by a polar code and interleaving a subset of the encoded bits obtained by the encoding. The polar code comprises a number of bit indices for placing bit values before encoding, including a first set of bit indices for placing values of the input bits and a second set of bit indices for placing a predetermined bit value. The first set of bit indices comprises a first subset of bit indices and a second subset of bit indices. The subset of the encoded bits corresponds to the second subset of the bit indices, and is for reducing the number of the encoded bits. An input bit value placed on both a first bit index in the first subset and a second bit index in the second subset, and the second bit index is based on the interleaving.

### CROSS-REFERENCE TO RELATED APPLICATIONS

The present application is a continuation of International Application No. PCT/CN2023/103893, entitled “METHODS, SYSTEMS, AND APPARATUS FOR RATELESS POLAR CODING AND LOW-COMPLEXITY DECODING” and filed on Jun. 29, 2023, and claims the benefit of: U.S. provisional patent application Ser. No. 63/454,068, entitled “Methods, Systems, and Apparatus for Rateless Polar Coding and Low-complexity Decoding”, filed on Mar. 23, 2023; U.S. provisional patent application Ser. No. 63/454,066, entitled “Methods, Systems, and Apparatus for Partial Code Rate Reduction in Polar Coding”, filed on Mar. 23, 2023; U.S. provisional patent application Ser. No. 63/454,067, entitled “Methods, Systems, and Apparatus for Rateless Polar Coding”, filed on Mar. 23, 2023; PCT Application No. PCT/CN2023/083350, entitled “Methods, Systems, and Apparatus for Non-Sequential Decoding of Polar Codes”, filed on Mar. 23, 2023; PCT Application No. PCT/CN2023/083348, entitled “Methods, Systems, and Apparatus for Bit Value Placement in Polar Coding”, filed on Mar. 23, 2023; and PCT Application No. PCT/CN2023/083345, entitled “Methods, Systems, and Apparatus for Encoded Bit Reduction in Polar Coding”, filed on Mar. 23, 2023.

The present application is related to the following Patent Cooperation Treaty (PCT) applications by the same applicant:
PCT Application No. PCT/CN2023/097662, entitled “Methods, Systems, and Apparatus for Protograph-based Low Density Parity Check Coding”, filed on May 31, 2023;
PCT Application No. PCT/CN2023/092465, entitled “Methods, Systems, and Apparatus for Partial Code Rate Reduction in Polar Coding”, filed on May 6, 2023; and
PCT Application No. PCT/CN2023/102653, entitled “Methods, Systems, and Apparatus for Rateless Polar Coding”, filed on Jun. 27, 2023,
and is related to the following United States provisional patent applications as well:
U.S. provisional patent application Ser. No. 63/454,069, entitled “Methods, Systems, and Apparatus for Rateless Polar Coding and Incremental Redundancy”, filed on Mar. 23, 2023; and
U.S. provisional patent application Ser. No. 63/454,070, entitled “Methods, Systems, and Apparatus for Channel-dependent Error Correction Coding”, filed on Mar. 23, 2023.

The disclosures of the aforementioned applications are hereby incorporated by reference in their entireties.

### TECHNICAL FIELD

The present application relates to coding, and in particular to rateless polar coding.

### BACKGROUND

In wireless communications, channel conditions are constantly changing at both fast and slow scale due to, for example, fading effects. Accordingly, channel coding has conventionally always been designed to adapt to channel conditions. Modulation coding scheme (MCS) adaptation, in which the modulation order and code length and code rate can be changed in real time, is a powerful approach to combat varying channel conditions.

Adapting to channel conditions requires channel coding that can flexibly change code length and code rate in a fine-grained way, and at the same time achieve good error correction performance in all possible configurations. This fine-grained flexibility of channel codes remains a challenge.

Probabilistic codes such as low density parity check (LDPC) codes, which are more like random codes, may be naturally suited for flexibility. However, algebraic codes such as Reed-Muller (RM) codes and Bose-Chaudhuri-Hocquenghem (BCH) codes, are not as flexible as probabilistic codes. This is because their inherent coding structures may be compromised when code length or rate changes. Polar codes exhibit features from both probabilistic codes and algebraic codes. As a result, polar codes have a level of flexibility that lies between probabilistic codes and algebraic codes.

Rate matching, including techniques such as puncturing and shortening, are available to design rate-compatible polar codes, such as the polar codes for fifth generation (5G) new radio (NR). However, the degree of flexibility is not enough to support more advanced features such as fine-grained incremental-redundancy hybrid automatic repeat request (IR-HARQ), for example.

Ratelessness can be important for rate compatibility, and refers to a coding approach in which an encoder does not need to determine a code rate before transmission of encoded data. Current polar code constructions need to know code length, which in turn impacts code rate, before transmission. Such code constructions therefore do not qualify as “rateless”. In existing polar coding schemes, code length is required during code construction, because it significantly affects the reliability of polarized subchannels and corresponding information subchannel selection.

A more flexible channel coding approach is needed.

### SUMMARY

The present disclosure encompasses embodiments related to enabling or facilitating what is referred to herein primarily as rateless polar coding. Some embodiments support or provide ratelessness through a unified code construction for various code lengths and a more flexible approach to decoding. In addition to the improved flexibility generally sought by rateless codes, embodiments of the present disclosure may also exhibit reduced complexity, for example by reducing or eliminating a need for many independently constructed polar codes of various rates and lengths.

According to an aspect of the present disclosure, a method involves encoding input bits by a polar code to obtain a number of encoded bits, and the polar code comprises a number of bit indices for placing bit values before encoding. The bit indices comprise: a first set of bit indices for placing values of the input bits and a second set of bit indices for placing a predetermined bit value, and the first set of bit indices comprises a first subset of bit indices and a second subset of bit indices. Such a method may also involve interleaving a subset of the encoded bits corresponding to the second subset of the bit indices, the subset for reducing the number of the encoded bits. The values of the input bits comprise an input bit value placed on both a first bit index in the first subset and a second bit index in the second subset, and the second bit index based on the interleaving. In some embodiments, a method further includes outputting the reduced number of the interleaved encoded bits corresponding to the second subset of bit indices.

According to another embodiment, a method involves obtaining an ordered sequence indicating a plurality of bit indices for a polar code in an order of rank for placing values of input bits for encoding by the polar code to obtain a number of encoded bits. The bit indices comprise: a first set of bit indices of highest rank according to the ordered sequence, for placing the values of the input bits before encoding; and a second set of bit indices of lower rank than the highest rank according to the ordered sequence, for placing a predetermined bit value. The first set of bit indices comprises a first subset of bit indices that includes a first bit index for placement of a first bit value of one of the input bits and a second subset of bit indices that includes a second bit index for placement of the first bit value. The order of rank is for interleaving a subset of the encoded bits corresponding to the second subset of the bit indices and for reducing the number of the encoded bits. Such a method may also involve: encoding input bits by the polar code according to the ordered sequence, to obtain the number of encoded bits; interleaving the subset of the encoded bits corresponding to the second subset of the bit indices; and outputting the reduced number of the interleaved encoded bits corresponding to the second subset of bit indices.

Another method involves receiving a reduced number of interleaved encoded bits encoded by a polar code, and as in other embodiments the polar code comprises a number of bit indices for placing bit values before encoding, with the bit indices comprising: a first set of bit indices for placing values of input bits and a second set of bit indices for placing a predetermined bit value. The first set of bit indices comprises a first subset of bit indices and a second subset of bit indices, the values of the input bits comprise an input bit value placed on both a first bit index in the first subset and a second bit index in the second subset, the second bit index is based on interleaving of a subset of the encoded bits corresponding to the second subset of the bit indices, and the subset is for reducing the number of the encoded bits. Such a method may also involve decoding the reduced number of interleaved encoded bits to obtain decoded input bits.

A method according to another aspect of the present disclosure also involves receiving a reduced number of interleaved encoded bits encoded by a polar code. The polar code comprises a number of bit indices for placing bit values before encoding, and the bit indices comprise: a first set of bit indices of highest rank according to an ordered sequence, for placing values of input bits; and a second set of bit indices of lower rank than the highest rank according to the ordered sequence, for placing a predetermined bit value. The ordered sequence indicating the plurality of bit indices in an order of rank for placing the values of the input bits for encoding by the polar code. The first set of bit indices comprises a first subset of bit indices that includes a first bit index for placement of a first bit value of one of the input bits and a second subset of bit indices that includes a second bit index for placement of the first bit value. The order of rank is for interleaving a subset of the encoded bits corresponding to the second subset of the bit indices and for reducing the number of the encoded bits. A method that involves receiving may also involve decoding the reduced number of interleaved encoded bits to obtain decoded input bits.

An apparatus according to an embodiment includes an encoder, an interleaver, and an interface. The encoder is for encoding input bits by a polar code to obtain a number of encoded bits. The polar code comprises a number of bit indices for placing bit values before encoding, and the bit indices comprise: a first set of bit indices for placing values of the input bits and a second set of bit indices for placing a predetermined bit value. The first set of bit indices comprises a first subset of bit indices and a second subset of bit indices. The interleaver is coupled to the encoder for interleaving a subset of the encoded bits corresponding to the second subset of the bit indices. The subset is for reducing the number of the encoded bits. The values of the input bits comprise an input bit value placed on both a first bit index in the first subset and a second bit index in the second subset. The second bit index is based on the interleaving. The interface is coupled to the interleaver, for outputting the reduced number of the interleaved encoded bits corresponding to the second subset of bit indices.

Another apparatus embodiment also includes an encoder, an interleaver, and an interface. The encoder is for obtaining an ordered sequence and encoding input bits by a polar code according to the ordered sequence. The ordered sequence indicates a plurality of bit indices for the polar code in an order of rank for placing values of input bits for encoding by the polar code, and the bit indices comprise: a first set of bit indices of highest rank according to the ordered sequence, for placing the values of the input bits before encoding; and a second set of bit indices of lower rank than the highest rank according to the ordered sequence, for placing a predetermined bit value. The first set of bit indices comprises a first subset of bit indices that includes a first bit index for placement of a first bit value of one of the input bits and a second subset of bit indices that includes a second bit index for placement of the first bit value. The order of rank is for interleaving a subset of the encoded bits corresponding to the second subset of the bit indices and for reducing the number of the encoded bits. The interleaver is coupled to the encoder for interleaving the subset of the encoded bits corresponding to the second subset of the bit indices. The interface is coupled to the interleaver, for outputting the reduced number of the interleaved encoded bits corresponding to the second subset of bit indices.

According to another embodiment, an apparatus includes an interface and a decoder coupled to the interface. The interface is for receiving a reduced number of interleaved encoded bits encoded by a polar code, the polar code comprising a number of bit indices for placing bit values before encoding, and the bit indices comprising: a first set of bit indices for placing values of input bits and a second set of bit indices for placing a predetermined bit value. The first set of bit indices comprises a first subset of bit indices and a second subset of bit indices, the values of the input bits comprise an input bit value placed on both a first bit index in the first subset and a second bit index in the second subset, the second bit index is based on interleaving of a subset of the encoded bits corresponding to the second subset of the bit indices, and the subset is for reducing the number of the encoded bits. The decoder is for decoding the reduced number of interleaved encoded bits to obtain decoded input bits.

In a further embodiment, an apparatus also includes an interface and a decoder. The interface is for receiving a reduced number of interleaved encoded bits encoded by a polar code, and the polar code comprises a number of bit indices for placing bit values before encoding. The bit indices comprise: a first set of bit indices of highest rank according to an ordered sequence, for placing values of input bits; and a second set of bit indices of lower rank than the highest rank according to the ordered sequence, for placing a predetermined bit value. The ordered sequence indicates the plurality of bit indices in an order of rank for placing the values of the input bits for encoding by the polar code, the first set of bit indices comprises a first subset of bit indices that includes a first bit index for placement of a first bit value of one of the input bits and a second subset of bit indices that includes a second bit index for placement of the first bit value, and the order of rank is for interleaving a subset of the encoded bits corresponding to the second subset of the bit indices and for reducing the number of the encoded bits. The decoder is coupled to the interface, for decoding the reduced number of interleaved encoded bits to obtain decoded input bits.

In other apparatus embodiments, an apparatus may include a processor configured to cause the apparatus to perform any of the methods as disclosed herein.

An apparatus may include a processor and a non-transitory computer readable storage medium that is coupled to the processor and stores programming for execution by the processor.

A storage medium need not necessarily or only be implemented in or in conjunction with such an apparatus. A computer program product, for example, may be or include a non-transitory computer readable medium storing programming for execution by a processor.

Programming stored by a computer readable storage medium may include instructions to, or to cause a processor to, perform, implement, support, or enable any of the methods disclosed herein.

A system is also disclosed, and may include a first communication device and a second communication device. The first communication device is configured to transmit a reduced number of interleaved encoded bits obtained by encoding input bits by a polar code and interleaving a subset of a number of encoded bits obtained by the encoding. The second communication device is configured to receive the reduced number of the interleaved encoded bits from the first communication device, and to decode the reduced number of the interleaved encoded bits to obtain decoded input bits. As in other embodiments, the polar code comprises a number of bit indices for placing bit values before encoding, the bit indices comprise: a first set of bit indices for placing values of the input bits and a second set of bit indices for placing a predetermined bit value, the first set of bit indices comprises a first subset of bit indices and a second subset of bit indices, the subset of the encoded bits corresponds to the second subset of the bit indices, the subset is for reducing the number of the encoded bits, the values of the input bits comprise an input bit value placed on both a first bit index in the first subset and a second bit index in the second subset, and the second bit index is based on the interleaving.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a trellis graph illustrating an example of a polar code.

FIG. 6 is a diagram illustrating puncturing and shortening with a cyclic buffer.

FIG. 7 is a diagram illustrating code construction according to an embodiment.

FIG. 8 is a diagram illustrating code structure according to an embodiment.

FIG. 8A is a diagram illustrating bit value placement on bit indices according to an embodiment.

FIG. 8B is a diagram illustrating example bit index to label mappings.

FIG. 8C is a diagram illustrating bit value placement on bit indices, using bit labeling according to an embodiment.

FIG. 9A is a block diagram illustrating an f-function used in polar code decoding.

FIG. 9B is a block diagram illustrating a g-function used in polar code decoding.

FIG. 9C is a diagram illustrating processing of a “butterfly” in polar code decoding.

FIG. 9D is a diagram illustrating a binary tree representation of successive cancellation decoding.

FIG. 10 is a block diagram illustrating a binary tree representation of SC decoding of a length N=4 polar code.

FIG. 11 is a block diagram illustrating a gᵣ-function used in an embodiment of non-sequential polar code decoding.

FIG. 12 is a block diagram illustrating an fᵣ-function used in an embodiment of non-sequential polar code decoding.

FIG. 13 is a diagram illustrating processing of a “butterfly” in an embodiment of non-sequential polar code decoding.

FIG. 14 is a diagram illustrating a binary tree representation of an example of decoding scheduling.

FIG. 15 is a diagram illustrating a binary tree representation of non-sequential SC decoding of a length N=4 polar code.

FIG. 16 includes a table and a diagram of a trellis, illustrating differences between non-sequential and sequential decoding.

FIG. 17 is a diagram of a trellis, illustrating an example of decoding that involves non-sequential polar code decoding.

FIG. 18 is a diagram of a trellis, illustrating another example of decoding that involves non-sequential polar code decoding.

FIG. 19 is a diagram of a trellis, illustrating a further example of decoding that involves non-sequential polar code decoding.

FIG. 20 is a diagram of a trellis, illustrating yet another example of decoding that involves non-sequential polar code decoding.

FIG. 21 is a diagram of a trellis, illustrating a bidirectional decoding example.

FIG. 22 is a diagram of a trellis, illustrating another bidirectional decoding example.

FIG. 23A is a diagram illustrating partial interleaving and puncturing according to an embodiment.

FIG. 23B is a diagram illustrating partial interleaving and puncturing according to another embodiment.

FIG. 23C is a diagram illustrating partial interleaving and puncturing according to yet another embodiment.

FIG. 23D is a diagram illustrating partial interleaving and puncturing according to an embodiment with multiple different interleavers.

FIG. 24 is a diagram illustrating such row-by-row writing and column-by-column reading to interleave partial code bits according to an embodiment.

FIG. 25 is a diagram illustrating bit value placement on multiple bit indices according to an embodiment.

FIG. 26 is a diagram illustrating an example of transmission order based on partial interleaving according to an embodiment.

FIG. 27 is a diagram illustrating an example of transmission order based on partial interleaving according to another embodiment.

FIG. 28 is a diagram illustrating bit value placement on multiple bit indices according to a further embodiment.

FIG. 29 is a diagram illustrating bit value placement and transmission order based on partial interleaving according to an embodiment.

FIG. 30 is a diagram illustrating bit value placement and transmission order based on partial interleaving according to another embodiment.

FIG. 31 is a diagram illustrating bit value placement on multiple bit indices according to a segment-by-segment reduced code rate embodiment.

FIG. 32 is a diagram illustrating bit value placement and transmission order based on partial interleaving according to segment-by-segment reduced code rate embodiment.

FIG. 33 illustrates decoding options based on starting bit indices, as well as conventional sequential decoding.

FIG. 34 illustrates decoding options based on starting bit indices for four different transmitted code lengths.

FIG. 35 is a flow diagram illustrating more general example methods according to embodiments.

FIG. 36 is a block diagram illustrating an apparatus according to an embodiment.

FIG. 37 is a block diagram illustrating code construction and decoding scheduling consistent with the present disclosure, compared with a conventional approach to code construction.

FIG. 38 includes plots illustrating error correction performance.

### DETAILED DESCRIPTION OF THE ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

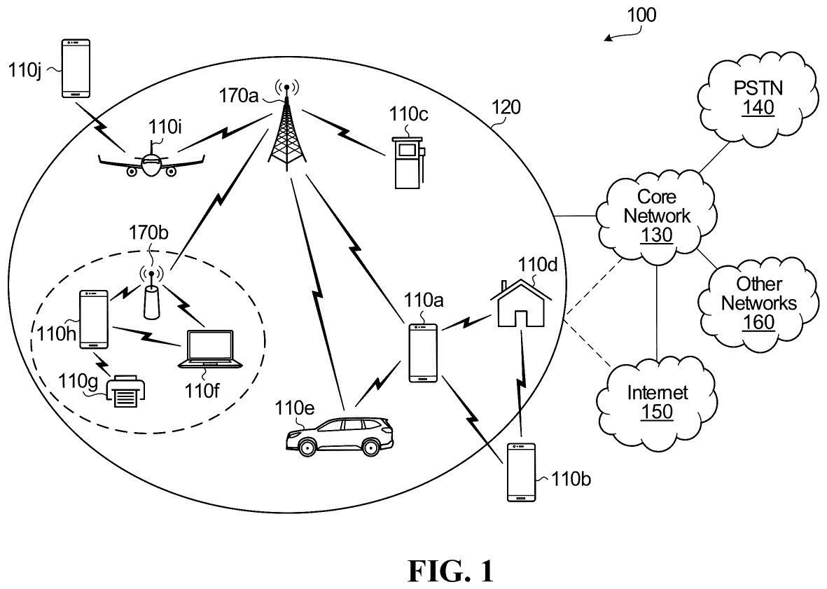

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

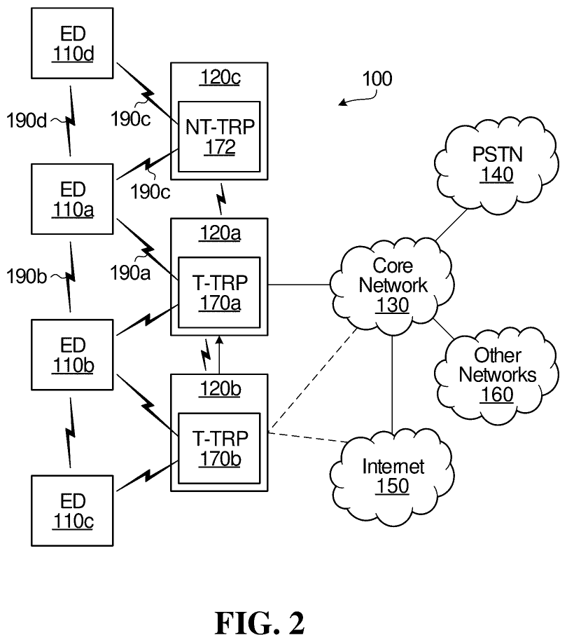

FIG. 2 illustrates an example communication system 100. In general, the communication system 100 enables multiple wireless or wired elements to communicate data and other content. The purpose of the communication system 100 may be to provide content, such as voice, data, video, signaling, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), Direct Fourier Transform spread OFDMA (DFT-OFDMA) or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

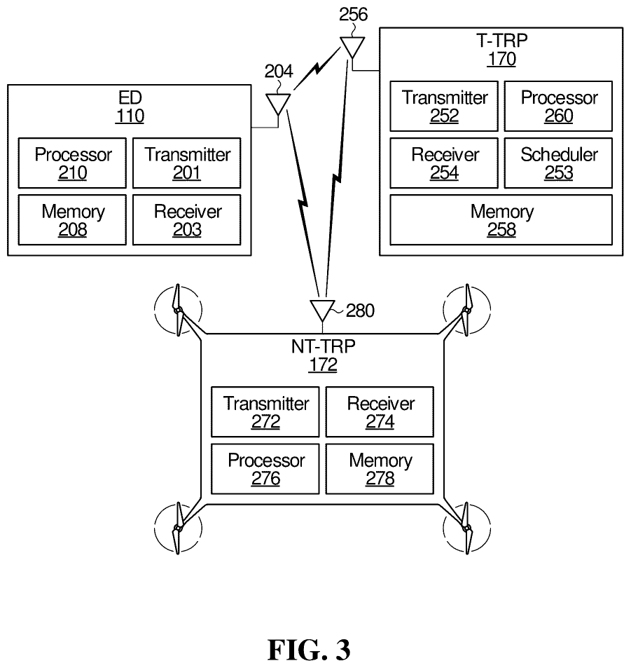

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, wearable devices such as a watch, head mounted equipment, a pair of glasses, an industrial device, or apparatus (e.g., communication module, modem, or chip) in the forgoing devices, among other possibilities. Future generation EDs 110 may be referred to using other terms. Each base station 170a and 170b is a T-TRP and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., in the memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), a Central Processing Unit (CPU) or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses the antennas 256 for the T-TRP 170, and may be coupled to the equipment that houses the antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU, a CPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

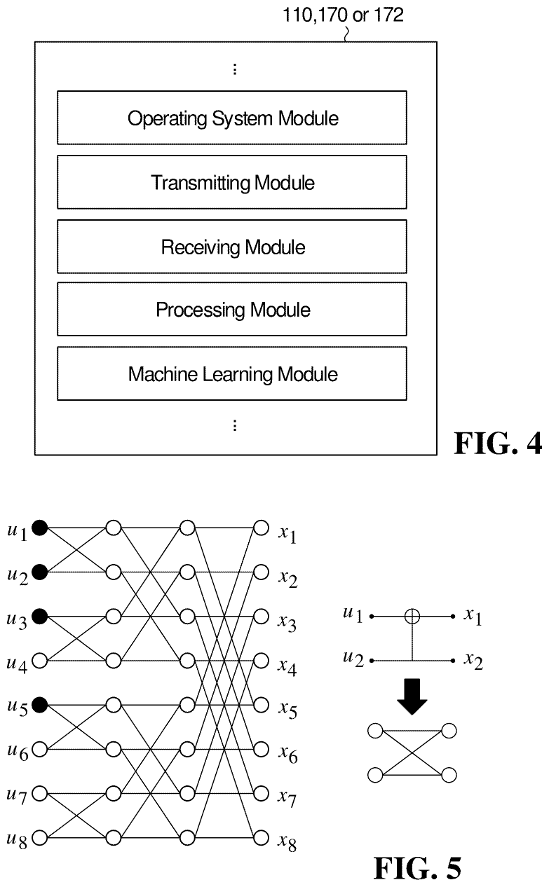

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or by a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, a CPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

Successive cancellation (SC) is the basic decoding algorithm for polar codes, according to which all frozen bits and information bits are decoded sequentially, bit by bit. Preceding bits are always decoded first, before decoding a current bit.

Successive cancellation list (SCL) is an enhanced decoding algorithm for polar codes, where multiple (L) SC decoding instances are executed. Each instance is called a “decoding path”. When decoding each binary bit, both “0” and “1” branches are extended to each path, creating 2L paths. Then, all 2L paths are compared, where the most likely L paths are kept, and the least likely L paths are discarded (or pruned). The path extension and pruning operations are performed during decoding every information bit, until all information bits are decoded. At last, the most likely path is selected as the decoding output.

CRC-aided successive cancellation list (CA-SCL) decoding works almost the same as SCL, except that in the last step, the most likely path that passes CRC check is selected as the decoding output.

Parity-check successive cancellation list (PC-SCL) decoding also works almost the same as SCL, except that when decoding parity-check (PC) bits, the parity check value of associated preceding bits is used as a bit decision result. PC bits are in addition to frozen bits and information bits.

Polar codes are linear block codes. For a polar code of length N, its generator matrix is G_{N}, and its encoding process is

$${x}_{1}^{N} = {u}_{1}^{N} {G}_{N} , where {u}_{1}^{N} = [ {u}_{1} , {u}_{2} , … , {u}_{N} ]$$

is a binary input vector, and

$${x}_{1}^{N} = [ {x}_{1} , {x}_{2} , … , {x}_{N} ]$$

is the binary code vector. The N×N binary generator matrix

$${G}_{N} = {F}_{2}^{⊗ n} , where {F}_{2} = [ \begin{matrix}1 & 0 \\ 1 & 1\end{matrix} ]$$

is the polarization kernel matrix, ⊗ is Kronecker product, and n=log₂ N.

With K information bits to be encoded into N code bits and K<N, a code rate of R=K/N<1 is obtained. This implies only part of

$${u}_{1}^{N}$$

is used to carry information bits, and the remining bits of

$${u}_{1}^{N}$$

are known as frozen bits. The formation bit set (or information set) may be denoted by I, and the frozen bit set (or frozen set) may be denoted by F. Sometimes, there is an additional PC bit set, denoted by P. The frozen bits are known and usually set to all zeros before decoding, so they do not carry any information. The PC bits are parity-check bits of a subset of information bits, and therefore are known once the associated information bits are decoded. Decoding of polar codes attempts to recover all information bits.

Code length M may, but might not always, be a power of 2, in which case M<N. In practice, puncturing and shortening are used to reduce the number of transmitted code bits from N to M. For convenience, N is referred to as mother code length, and M is referred to as code length herein. In particular, punctured bits are untransmitted bits that are unknown to a decoder, but shortened bits are untransmitted bits that are known to the decoder (usually all zeros).

FIG. 5 is a trellis graph illustrating an example of a polar code with N=8 and K=4. Each “butterfly” in the graph is a polarization, and one butterfly is shown by way of example at the right in FIG. 5, for

$${x}_{1}^{2} = {u}_{1}^{N} [ \begin{matrix}1 & 0 \\ 1 & 1\end{matrix} ] .$$

In the example shown, the unshaded circles at the left represent the information set I={u₄, u₆, u₇, u₈}, and the shaded circles represent the frozen set F={u₁, u₂, u₃, u₅}.

The input vector u at the left in FIG. 5 and the code vector x at the right in FIG. 5 each include a number of bit positions. The bit positions in the input vector are indexed by respective bit indices, and bit values are placed on or at those bit indices or bit positions for encoding. These bit indices or bit positions are also sometimes referred to as bit channels or subchannels. Placing bit values on bit indices as disclosed herein may also be referred to in other ways, such as placing bits or bit values on or at bit indices, bit positions, bit channels, or subchannels; or assigning bit values or bits to bit indices, bit positions, bit channels, or subchannels. Other terminology may be used to express how bit values or bits are provided as inputs to encoding. The present disclosure refers primarily to placement of bit values on bit indices, but other terminology may equivalently be used to convey the same concept.

In this way, a polar code may be considered as providing or comprising bit indices, bit positions, bit channels, or subchannels for bit values. Those bit indices, bit positions, bit channels, or subchannels are not necessarily only for bits that are to be encoded. For example, the u vector elements u₁, . . . u_{N} are also referenced in decoding, and therefore bit values that are decoded may similarly be associated with bit indices, bit positions, bit channels, or subchannels.

On the right side in FIG. 5, the code vector x also includes a number of elements that are in or at bit positions or bit indices. A bit value on the i-th bit index in the input vector u has some effect on multiple code bits in the code vector x, but the bit value on the i-th bit index in the input vector u is the primary contributor to the value of the code bit on the corresponding i-th bit index in the code vector x. In this sense, for a polar code, input vector bit indices or bit positions may be considered to correspond to, or be associated with or related to, code vector bit indices or bit positions. This is the case for polar codes, and there may be different input/code bit correspondence, relationships, or associations for other types of codes.

Regarding encoding, the process of encoding may be expressed in any of various ways. For example, encoding may be described as encoding bits to obtain encoded bits or to generate encoded bits. The above-referenced encoding process

$${x}_{1}^{N} = {u}_{1}^{N} {G}_{N} ,$$

for example, may be expressed as generating or otherwise obtaining an encoding input (the input vector u in this example) that includes bits or bit values for encoding, to obtain or generate a number of encoded bits (the code vector x in this example).

The bit values of elements in the input vector u, from an encoding perspective, may be referred to as values or bits to be encoded, or as values or bits for encoding, for example. Blocks of bits or bit values for encoding are also sometimes referred to as code blocks. The bit values of elements in the code vector x may be referred to as encoded bits, coded bits, or code bits, and a block of such bits may be referred to as a codeword, for example.

From a decoding perspective, decoding may be referred to as decoding encoded bits, a codeword, or a code, or as decoding, obtaining, or recovering bits or bit values (that were encoded), from the encoded bits, a codeword, or a code, for example. The bit values of elements in the vector u, in the context of decoding, may be referred to as decoded or recovered bits or bit values.

Rate-compatible polar coding is a key technology for wireless applications. One key characteristic of polar codes is that the actual reliability (or bit correct probability) of polarized subchannels is governed by channel output quality of all code bits. In the case of rate matching, some of the channel outputs are completely unknown (for punctured bits) or completely known (for shortened bits, which are not transmitted but are known). As a result, actual subchannel reliability will change dramatically according to any puncture patterns (which may also or instead be referred to as puncturing patterns) and/or shorten patterns (which may also or instead be referred to as shortening patterns). By definition of polar codes, the K information bits should be placed on the K most reliable polarized subchannels. If not, significant performance degradation will be observed.

In the 5G NR standard (see 3rd Generation Partnership Project (3GPP), “Multiplexing and channel coding,” 3GPP 38.212 V.15.3.0, 2018), a combination of puncturing, shortening, and repetition is used together with a fixed reliability sequence to balance performance and complexity. In particular, a subblock-wise interleaving, which may also be referred to as interlacing, is used for both puncturing and shortening. The puncturing and shortening patterns are complementary and, together, form a symmetric (with respect to a polar code sequence) rate matching scheme.

With mother code length N, and code length M, the specific rate matching scheme used in 5G NR is as follows:
Repetition, when M>N;
Puncturing, when K/M≤ 7/16;
Shortening, when K/M> 7/16.

Subblock-wise interleaving is performed before puncturing and shortening. An interleaver partitions the length-N mother code into 32 subblocks of size N/32 and interleaves them. Puncturing is performed from the first bit of a codeword, also referred to herein as a code bit, a coded bit, or an encoded bit, and shortening is performed from the last code bit. A rate matching module is efficiently implemented through a cyclic buffer. All mother code bits are placed in the cyclic buffer, puncturing is done by selecting the bits in clockwise order, and shortening is done by selecting bits in counter-clockwise order.

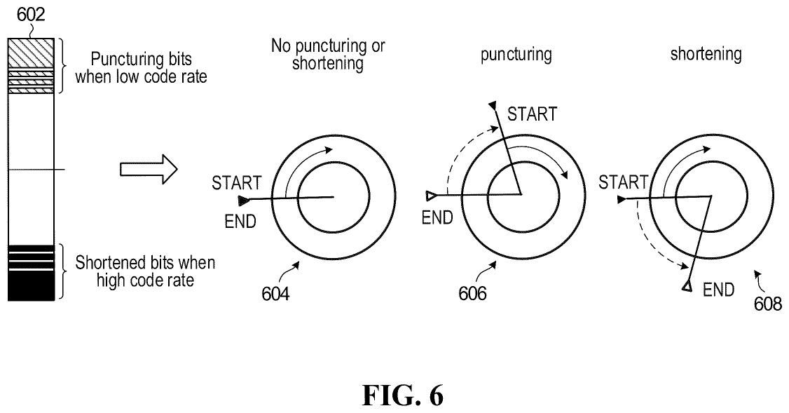

FIG. 6 is a diagram illustrating puncturing and shortening with a cyclic buffer. At 602 in FIG. 6, code bits of a codeword are illustrated in a vertical column, with punctured and shortened bits as shown. At 604, FIG. 6 illustrates a cyclic buffer, represented by a circle shape, and reading of code bits with no puncturing or shortening. The next two circles illustrate, respectively, cyclic buffers with dashed lines representing puncturing from the beginning of the buffer at 606 and shortening from the end of the buffer at 608.

In an incremental freezing HARQ method, transmissions of multiple short code words are supported. See B. Li, D. Tse, K. Chen and H. Shen, “Capacity-achieving rateless polar codes,” 2016 IEEE International Symposium on Information Theory (ISIT), 2016, pp. 46-50, doi: 10.1109/ISIT.2016.7541258. As more short codes are transmitted, the overall code length increases, and the overall code rate decreases.

In the first transmission, an (M₁, K) polar code is constructed, encoded and transmitted. The code rate is R₁=K/M₁, and is usually determined such that R₁<C₁, where C₁ is the channel capacity of the first transmission. In the case of faded channel or inaccurate channel estimation, it may be that R₁>C₁, and decoding will fail and a second transmission is required. In the second transmission, K₂ least reliable information bits are selected from the K information bits in the first transmission. In practice, K₂ is chosen according to the estimated channel capacity of the second transmission. An (M₂, K₂) polar code is constructed accordingly and encoded and transmitted. However, if R₂>C₂, decoding will fail again and a third transmission is required. The third transmission, and possibly further subsequent transmissions, are constructed similarly. For example, code length may be the same for up to four transmissions (M₁=M₂=M₃=M₄=16), with K₁=12, K₂=6, K₃=4, and K₄=2.

At the receiver side, it is expected that a decoder will always decode at least the last received codeword, because it has the lowest code rate and thus the best chance of successful decoding. After the last transmission is correctly decoded, the corresponding information bits in all previous transmissions (e.g., K₁, K₂, K₃, etc.) become known; therefore, these known information bits can be treated as frozen bits (i.e., bits with known values) during subsequent decoding of each previous transmission. This process is repeated as more codewords are decoded, until all K bits in the first transmission are decoded. The term “incremental freezing” refers additionally freezing some information bits in previous transmissions once a later transmitted codeword is decoded.

In the 5G NR standard, PC polar codes were adopted to increase the minimum code distance of the original polar codes. Values of PC bits are determined by their preceding information bits, and specifically, binary linear combinations of a subset of preceding information bits. In one proposal of PC polar codes to support IR-HARQ, PC bits are for coupling multiple retransmissions into a longer polar code with extra coding gain. See M.-M. Zhao, G. Zhang, C. Xu, H. Zhang, R. Li and J. Wang, “An Adaptive IR-HARQ Scheme for Polar Codes by Polarizing Matrix Extension,” in IEEE Communications Letters, vol. 22, no. 7, pp. 1306-139 July 2018, doi: 10.1109/LCOMM.2018.2825370.

PC functions currently used for IR-HARQ are also a special case, where some information bits are copied from an initial transmitted code block to a retransmitted code block. This one-to-one parity checking between the two shorter code blocks effectively couples the two code blocks into a longer code block.

Consider an example, for an initial transmission of an (M₁=8, K=5) polar code, where {u₀, u₁, u₂, u₃, u₄} is the information set, and {u₅, u₆, u₇} is the frozen set. In this example, bit indices are in decreasing order of reliability. In a first retransmission, four additional code bits are transmitted. These four bits are coupled with the initially transmitted 8 bits to form an (M₂=12, K=5) polar code. The coupling is achieved by copying the value of u₄ to u₈ during encoding, thus generating a PC function u₄+u₈=0 (or equivalently u₈=u₄). The largest index in this PC function corresponds to the PC bit (here u₈). During decoding, u₄ is decoded as an information bit, while u₈ is decoded as a PC bit using u₈=u₄. In this example, {u₀, u₁, u₂, u₃, u₈} is the information set, {u₄} is the PC set, and {u₅, u₆, u₇, u₉, u₁₀, u₁₁} is the frozen set. In a second retransmission, four more additional code bits c₁₂, c₁₃, c₁₄, c₁₅ are transmitted to form an (M₃=16, K=5) polar code, but in this second retransmission no new PC bits are generated.

These existing rate matching and PC polar coding schemes can provide some flexibility. However, these schemes do not provide so-called “rateless” coding.

Rateless codes are channel codes that encode K source bits into a potentially very long encoded bit sequence with length Nₘₐₓ. A transmitter may incrementally transmit the bit sequence, until a receiver can successfully decode the source bits, and instructs the transmitter to stop further transmissions. The number of actually transmitted and received code bits may be denoted by M, and M<Nₘₐₓ. Thus, the code rate is R=K/M. In practice, the code rate R depends on code length M. The code length M depends on dynamic channel quality, because generally, a lower quality channel will require more transmissions and lower code rate for successful decoding. The term “rateless” comes from the fact that an encoder does not determine the code rate R before transmission. In other words, the code rate R is not fixed in advance, but adapts to channel state. When channel quality is high, R is higher; and when channel quality is low, R is lower.

In 5G polar code rate matching, for example, the code length M must be known before code construction. First, an encoder will determine whether to puncture or shorten the code according to M, and then the information set I is selected according to the puncturing/shortening pattern(s). This fixing of code length M before code construction violates the definition is ratelessness. Moreover, the 5G polar code rate matching scheme does not support multiple transmissions.

The incremental freezing IF-HARQ scheme referenced above supports multiple transmissions, but both the code length Mᵢ and information length Kᵢ in each retransmission need to be known at the transmitter before constructing retransmitted codewords. Specifically, the values of Mᵢ and Kᵢ for a retransmission are determined by a channel estimation result for that transmission. Correspondingly, an (Mᵢ, Kᵢ) polar code must be constructed for each retransmission. Again, this approach involves predetermination of code rates and violates the above definition of ratelessness. Another drawback is its inferior coding gain compared to that of a long code. For example, the combined performance of the first two codewords (M, K) and (M₂, K₂) is still worse than a long codeword (M+M₂, K).

The above-referenced proposal of PC polar codes to support IR-HARQ also supports multiple transmissions, but the code length Mᵢ in each retransmission needs to be known at the transmitter before constructing codewords, which also violates the definition of ratelessness. Specifically, the value of Mᵢ determines the number of copied bits (or PC bits) in each retransmission. Moreover, the performance after two retransmissions is inferior to a long codeword (M+M₂, K).

Some embodiments disclosed herein are directed to addressing a technical problem related to providing more flexible polar codes. 5G NR, for example, adopts a rate-dependent rate matching scheme. However, its flexibility is undermined by shortening. If a rateless polar code is to be constructed, where the code length and code rate are flexible, then shortened bits under one code length M, cannot be used for transmission under another code length M₂. This is due to the fact that shortened bits are known to the receiver and do not carry any additional information about the source bits. On the other hand, punctured bits are unknown to the receiver, and thus can potentially carry additional information about the source bits. By transmitting more punctured bits, the overall code rate is effectively reduced, leading to higher decoding reliability. Therefore, instead of seeking rate compatibility with hybrid puncturing and shortening, it may be preferable to disable shortening but seek rate compatibility with novel check-type methods that involve input bit values that are placed on multiple bit indices and in this sense are related to each other. This is illustrative of how rate compatibility may be achieved through operations before polar transformation, which may provide more flexibility on how to use code bits, rather than after polar transformation.

Another technical problem that may be addressed by some embodiments herein is how to achieve true ratelessness. In some embodiments, true ratelessness involves the following features:

Construction of an (Nₘₐₓ, K) mother code, which contains all (M, K) codes for all K≤M≤Nₘₐₓ.

Truly rateless codewords are nested. That is, an (M₁, K) codeword is always nested within an (M₂, K) codeword for any M₁<M₂.

Any (M, K) code extracted from the (Nₘₐₓ, K) mother code provides the same coding gain as an individually constructed (M, K) code, which is optimized for length M only.

There is no need to reconstruct codes, either according to code length Mᵢ or channel condition, before each subsequent transmission.

Designing polar codes that provide such features for true ratelessness remains a challenge.

Although embodiments are described herein by way of example with reference primarily to output by transmitting encoded bits. Outputting encoded bits may involve transmitting encoded bits, or encoded bits that are output may be transmitted, but it should be appreciated that not all embodiments necessarily involve transmitting encoded bits. Features that are disclosed herein in the context of transmitting encoded bits may be applied more generally to outputting encoded bits.

Embodiments disclosed herein may integrate aspects of one or more of the related applications referenced above. For example, some embodiments may integrate features related to any of the following: non-sequential decoding for polar codes, placement of input bit values on multiple bit indices, partial code rate reduction, and partially interleaved encoded bit reduction. Consistent with the above-referenced U.S. provisional patent application Ser. No. 63/454,067, entitled “Methods, Systems, and Apparatus for Rateless Polar Coding”, filed on Mar. 23, 2023, rateless polar codes may be provided by placing bit values on multiple bit indices based on bit index sort orders, and may support scheduled decoding. The present disclosure also encompasses embodiments related to rateless polar coding, but with partial interleaving and a goal of helping achieve better performance and lower complexity.

As an example, embodiments disclosed herein may provide true ratelessness for polar codes, and better error correction performance than implementations that do not support partial interleaving. With partially interleaved encoded bit reduction by rate matching, for example, more code bits corresponding to frozen bit positions can be transmitted, resulting in a lower code rate for a block of code bits. The lower code rate may better match actual capacity of the block, which may become insufficient to carry more code bits corresponding to information bit positions, when the block of code bits is heavily punctured for example.

In some embodiments, partial interleaving involves an approach that is referred to herein as “half-interleaving”, according to which interleaving is applied to a first half of encoded bits before encoded bit reduction, by rate matching for example, to provide half-interleaved rate matching or more generally half-interleaved encoded bit reduction. Half-interleaving is illustrative of one type of partial interleaving, but more generally partial interleaving involves interleaving fewer than all encoded bits, or in other words interleaving other than full-interleaving.

Embodiments may further simplify code construction and decoder scheduling for rateless polar codes, and provide related standard-friendly descriptions.

Regarding code construction, some embodiments adopt interleaving and puncturing or output, by transmission or otherwise, of part of a mother code of length N. This may be referred to partially interleaved puncturing or partially interleaved encoded bit reduction. Embodiments disclosed herein may include features similar to those in the above-referenced patent application related to rateless polar codes with placement of bit values on multiple bit indices, and/or features disclosed in others of the patent applications referenced above, but in combination with partially interleaved encoded bit reduction.

An approach that is referred to herein as half-interleaved puncturing (or transmission) of a code of length N is one example of partially interleaved puncturing (or transmission). More generally, half-interleaving is an example of partial interleaving, and partial interleaving is not in any way limited to interleaving specifically one half of mother code encoded bits. Similarly, puncturing is one example of an approach for reducing the number of encoded bits for output, by transmission or otherwise. Other options for reducing the number of encoded bits for output may be provided in other embodiments.

For half-interleaved puncturing as an example, the first P code bits of a half-interleaved length-N codeword are punctured. The last M code bits remain for output, and are transmitted in some embodiments. In this example, P+M=N. The transmitted or otherwise output code length is M and N/2<M<N, which means that more than half of the code bits of the length-N codeword are output.

Half-interleaving refers to the first half of a codeword being interleaved. Interleaving may involve one or more block interleavers for example, with a width and a height of the interleaver blocks both being a power of 2 in some embodiments. Power of 2 block dimensions may be particularly preferred in conjunction with code lengths that are also a power of 2, such as codes derived from a power of 2 length mother code.

In some applications, the range of supported code lengths M may be large, for example from K to Nₘₐₓ. In an iterative or recursive approach, interleaving may be done from the smallest mother code length Nₘᵢₙ to the largest mother code length Nₘₐₓ. As the mother code length is increased or extended, in a half-interleaving embodiment the first half of the increased-length or extended-length mother code is interleaved.

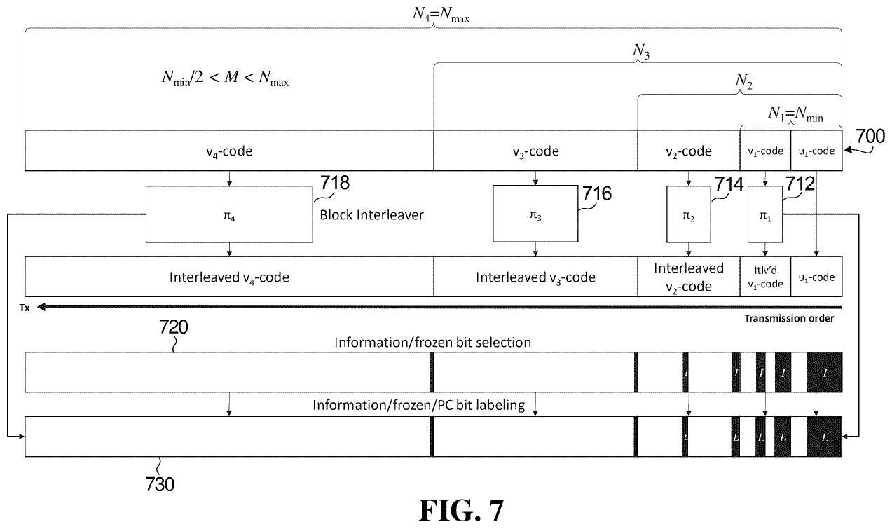

This is illustrated by way of example in FIG. 7, which is a diagram illustrating code construction according to an embodiment. The example in FIG. 7 relates to an iterative or recursive approach in which half-interleaving is applied from a smallest mother code length Nₘᵢₙ in a first iteration or recursion, to the largest mother code length Nₘₐₓ. Transmitted or otherwise output code length M is greater than Nₘᵢₙ/2, and is also less than maximum mother code length Nₘₐₓ due to encoded bit reduction.

At 700, FIG. 7 shows a u-code (labelled u₁-code) and several v-codes (labelled v₁-code, v₂-code, v₃-code, and v₄-code). If a mother code is a polar code of length N, then that polar code provides N bit indices for placement of bit values for encoding. Encoding by that mother code generates N encoded bits on N respective bit indices. Bit indices are not shown individually in FIG. 7 in order to avoid congestion in the drawing, but 700 is intended to generally represent encoded bits on encoded bit indices. The bit indices include an upper set of the highest N/2 bit indices (the (N/2+1)-th to N-th bit indices) that may be referred to as a u-code, and a lower set of the lowest N/2 bit indices (the first to (N/2)-th bit indices) that may be referred to as a v-code. For the length N₁ code in FIG. 7, for example, the u₁-code and the v₁-code each include Nₘᵢₙ/2 bit indices.

Block interleavers are illustrated by way of example at 712, 714, 716, 718 in FIG. 7, to half-interleave bit indices or bit values at each iteration or recursion of code construction. For code length N₁, the block interleaver 712 interleaves the v₁-code by changing order of the v₁-code bits or bit indices. The result of this interleaving is the interleaved v₁-code in FIG. 7. Considering the v₁-code and the u₁-code as a whole, the length N₁ code is half-interleaved, and the half-interleaved code includes the interleaved v₁-code and the u₁-code. The downward arrow below the u₁-code is intended to illustrate that no interleaving is applied to the u₁-code.

Any current code length N may be doubled to 2N to construct longer codes. For example, any length N code may include an upper set and a lower set of bit indices or bits, or one u-code and one v-code. However, there can be multiple upper sets and lower sets as code length is recursively extended or increased. A code of length Nᵢ including a v₁-code and uᵢ-code can be viewed or treated as a u-code and further extended to length 2Nᵢ, and so on, for progressively longer code lengths. In FIG. 7, in a next iteration or recursion, the length N₁ code is extended to length N₂=2N₁ by treating the length N₁ code as a u-code (or u₂-code following the notation in FIG. 7) and interleaving the v₂-code at 714 as shown. Similarly, mother codes of length N₃=2N₂ and N₄=2N₃ may be created by extending and half-interleaving respective shorter codes. In practice, a limit may be placed on this type of iterative or recursive extension. For example, there may be a fixed maximum number of extensions (four in the example shown), after which repetition may be used to further extend to longer code lengths. Another possible option is a non-fixed maximum number of extensions, but a maximum length of mother code, such as N≤1024, or 4096, etc., after which repetition may be used to further extend to longer code lengths.

Half-interleaving as referenced herein refers to interleaving half of the bit indices, or values on those bit indices, that are associated with a code. As will be apparent from the interleaved bit indices below the interleavers 712, 714, 716, 718 in FIG. 7, the overall result of half-interleaving for multiple code lengths may be that more than half of the bit indices or bits are interleaved. As shown by way of example in FIG. 7, “half” in half-interleaving may refer to a current mother code length.

More generally, half-interleaving is one example of partial interleaving, and may be especially useful in conjunction with power-of-2 length codes. Partial interleaving refers to interleaving only part of a set of bits or bit indices, rather than the entire set of bits or bit indices. In the present disclosure, encoding features are considered in detail first, and then decoding features are considered further below. Bits or bit indices may be partitioned or divided into parts, such as an upper set or u-code and a lower set or v-code. Parts may also or instead be referred to as subsets, blocks, or portions, for example, and “subset” is used herein to generally refer to parts, blocks, or portions of the bits or bit indices of a code. Each subset includes fewer than all of the bits or bit indices.

Partial interleaving, in this context of bits or bit indices divided into multiple subsets, means that at least one of those subsets is not interleaved (at least not interleaved for the purpose of encoded bit reduction as discussed in further detail elsewhere herein) and at least one of the others is interleaved. In FIG. 7, considering the length N₁ code, the v₁-code is interleaved but the u₁-code is not interleaved. Regarding the length N₂ code, the v₂-code and the v₁-code are interleaved but the u₁-code is not interleaved, and so on.

Interleaving, as used herein in the context of disclosed embodiments, refers to changing an order of elements of a subset. Interleaving is used primarily herein, but is intended to encompass such changing of order more generally, and may also or instead be referred to as shuffling, reordering, scrambling, interlacing, interweaving, etc. An interleaved subset includes the same elements as a subset before interleaving, but in a different order within the subset.

At 720, FIG. 7 illustrates selection of information bits or bit indices for placement of input bit values, and frozen bit indices for a predetermined frozen bit value such as zero. Placement of bit values on bit indices is shown by way of example at 730, using bit labeling. This is an example only, and bit value placement may or may not use bit labeling. The arrows in FIG. 7 from the block interleavers 712 and 718 to 730 are intended to represent that bit value placement on encoding bit indices is based on the partial interleaving as discussed in detail at least below.

In FIG. 7, encoded bits are reduced from the partially interleaved codeword below the block interleavers 712, 714, 716, 718. Puncturing, for example, reduces encoded bits from the left, and encoded bits that are output after puncturing P encoded bits have bit indices [P+1 . . . N]. In this example, the u-code and the v-code into which the encoded bits that remain after puncturing include the {P+1 . . . N/2}-th v-code bits on bit indices {P+1 . . . N/2}, for a v-code length of N/2−P, and the {N/2+1 . . . N}-th u-code bits on bit indices {N/2+1 . . . N}, for a u-code length of N/2. The v-code may be a punctured polar code or, when N/2−P is a power of 2, the v-code can be a non-punctured polar code. The u-code is a non-punctured polar code.

To determine the information (or non-frozen) set including bit indices for placement of K input bit values, K bit indices {N/2+1 . . . N} may be selected according to a pre-defined ordered sequence of length N/2, at 720 in FIG. 7 for example. An ordered sequence indicates bit indices according to rank, such as reliability, and the K bit indices of highest rank, such as highest reliability, are selected. For ease of reference, this bit index set that includes selected bit indices is denoted by Iᵤ. If K>N/2, then all N/2 bit indices in the ordered sequence are selected for the information set Iᵤ. In this case, there are not enough bit indices in the u-code to accommodate all of the K input bit values. In order to facilitate input bit value mapping and placement as described in further detail herein, an additional K−N/2 bit indices may be selected as “virtual” information bit indices for Iᵤ. These additional bit indices are referred to as virtual information bit indices for Iᵤ because they are not actually in the u-code. Including these virtual information bit indices in Iᵤ, however, may facilitate code construction.

Virtual bit indices may be referred to as dummy bit indices, tracking bit indices, or by some other name. These bit indies are not bit indices on which input bit values are placed for encoding, but may be useful for tracking how many, and which, information bit indices in Iᵤ are available for mapping and placement of input bit values that are also mapped to and placed on bit indices in the v-code, as explained in further detail at least below.

The bit indices and ranking for virtual bit indices may be assigned on condition that virtual bit indices have a lower rank for bit value placement, based on reliability for example, than other bit indices in Iᵤ and are distinguishable from other bit indices in Iᵤ. For example, the additional K−N/2 virtual information bit indices may be assigned negative reliability values or other rank values {−(K−N/2), −(K−N/2−1) . . . 2, −1}, and bit indices {−(K−N/2), −(K−N/2−1) . . . 2, −1}, respectively. Negative reliability values or other rank values in this example illustrate one way in which virtual bit indices may have lower reliability or rank than other bit indices in Iᵤ with positive reliability values or other rank values for placement of input bit values. Similarly, negative bit indices in this example illustrate one way in which in which virtual bit indices may be distinguished from other bit indices in Iᵤ.

The information set for the v-code is selected based on the K highest rank (most reliable, for example) bit indices in {1 . . . N}, according to a pre-defined ordered sequence of bit indices in order of rank, of length N. The set of the K highest rank bit indices in {1 . . . N} is denoted herein by I_{w}. The information (non-frozen) set of bit indices in {1 . . . N/2} is denoted herein by Iᵥ={i: i∈Iᵤᵥ and i≤N/2}.

The set difference between Iᵤ and I_{w} may be denoted

$${I}_{\hat{u}} = {I}_{u} ( {I}_{u υ} = \{ i : i ∈ {I}_{u} and i ∉ {I}_{u υ} \} ,$$

and the full information (or non-frozen) set may be expressed as follows:

$$I = {I}_{u} ⋃ {I}_{u υ} = [ {I}_{υ} , {I}_{u} ] .$$

The N bit indices of a mother code are either frozen bit indices or information bit indices in some embodiments. A predetermined bit value such as 0 is placed on the frozen bit indices in the frozen set, and values of input bits are placed on information bit indices in the information set. A value of an input bit may be placed on one, or on more than one, of the information bit indices. In bit labeling embodiments, for example, bit values are assigned to labels, and labels are associated with one (one-to-one mapping) or multiple (one-to-many mapping) bit indices. A label of 0 may be used as a label for the predetermined bit value and frozen bit indices, and labels of {1, 2 . . . K} may be used as labels for values of input bits and information bit indices, for example. Other labels, and embodiments in which labels are not used to place bit values on bit indices, are also possible.

Selection of bit indices for placing values of input bits, which may involve labeling in some embodiments, determines the code construction.

In the present disclosure, bit labeling or more generally placement of bit values on bit indices depends on partial interleaving for encoded bit reduction.

Interleaving may be pre-defined for all output code lengths M, without knowledge of M beforehand to design the interleaving. With interleaving based on K and Nₘₐₓ, for example, M can be arbitrarily chosen between K and Nₘₐₓ, and in this sense interleaving may be considered “pre-defined” and not dependent upon M. The type of interleaving as a whole may be the same for code lengths up to Nₘₐₓ, but as shown by way of example by the block interleavers 712, 714, 716, 718 and different interleaved v-code lengths in FIG. 7, interleaving length may change as mother code length is increased or extended, but the overall type of interleaving (block interleaving in FIG. 7) may be the same for all code lengths.

As described in further detail elsewhere herein, bit values are placed on encoding bit indices of the u-code and are also placed on encoding bit indices v-code, by labeling or otherwise, based on partial interleaving and an interleaving sequence according to which encoded bits or encoded bit indices are interleaved for encoded bit reduction.

Therefore, bit labeling or more generally bit value placement may, like partial interleaving, also be pre-defined for all output code lengths M. Bit value placement is based on the partial interleaving and does not depend on an output code length M, but may depend on information length K. Code construction and subsequent encoding can be done without knowing an output code length M in advance.

Neither partial interleaving nor bit placement is dependent upon output code length M, and thus embodiments disclosed herein may provide or support rateless codes. To achieve ratelessness, bit index selection, and labeling if used, should not depend on the output code length M, but may depend on the number of input bits, also referred to as information length, K. In this way, code construction and subsequent encoding can be done without knowing the output code length M in advance. Examples of bit value placement, including labeling in some embodiments, are described in further detail herein, at least below.

Encoding can be done once, to obtain a length-N mother codeword. For example, values of the K information bits are placed on the information bit indices, using K labels in some embodiments. The bit value of any input bit may be placed on multiple information bit indices, by assigning the same label to multiple bit indices for example. Therefore, one input bit may in effect be placed on multiple bit indices. In a labeling embodiment, the multiple bit indices are associated with the same label. This may be considered as implicitly establishing a type of check function, where the bit value on a first bit index can be checked by the same bit value that is also placed on one or more other bit indices. Such placement of the same input bit value on two or more bit indices enables the decoded input bit value to be known for all of those bit indices after a bit value is decoded for any one of the bit indices.

Rate matching to obtain an arbitrary (M, K) code for all K≤M≤N may then involve transmitting or otherwise outputting the last M code bits of a partially interleaved mother codeword. The first N-M code bits are not transmitted, and may be punctured for example.

Encoding procedures for a mother code that is extended multiple times from Nₘᵢₙ to Nₘₐₓ are believed to be apparent, for example, from FIG. 7. As shown in FIG. 7 and described above, the first half of each of four mother codes are all interleaved, with the first half for different mother codes being separately interleaved by the block interleavers 712, 714, 716, 718 in the example shown.

Other features may be provided or supported in some embodiments, including partial code rate reduction as described elsewhere herein.

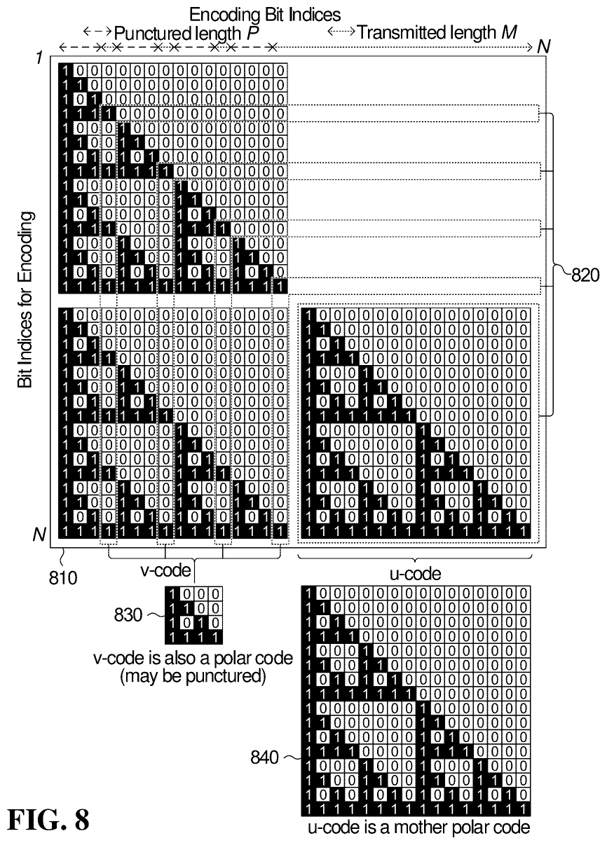

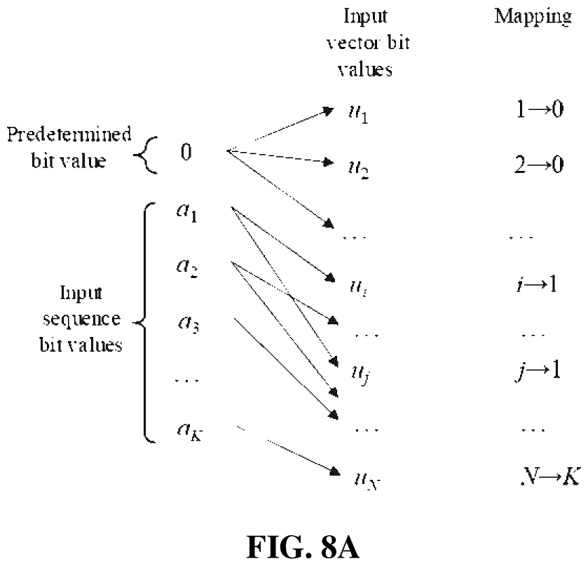

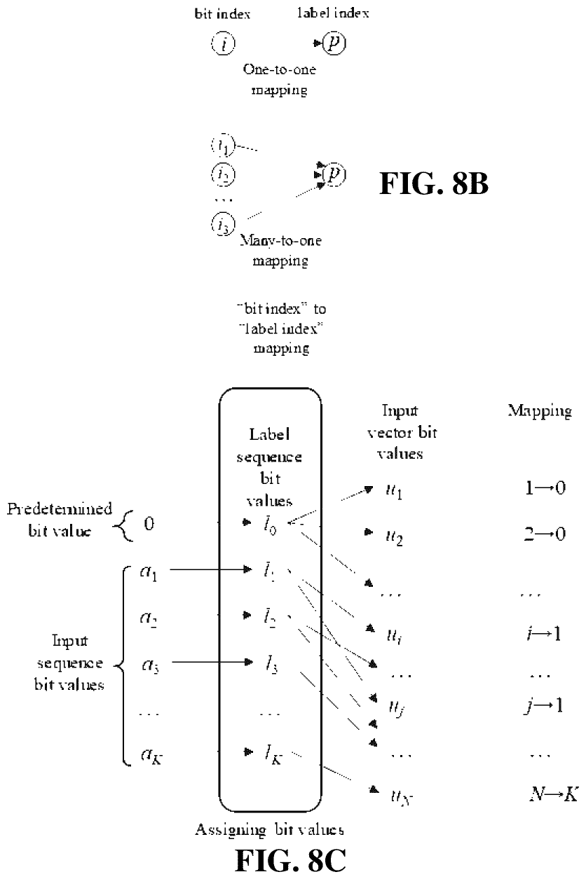

Code structure according to an embodiment is illustrated by way of example in FIG. 8. 810 in FIG. 8 represents a polar transformation matrix (or generator matrix) of a length-N mother polar code. 820 in FIG. 8 represents the generator matrix of the transmitted (or otherwise output) length-M part of the mother polar code, and the generator matrices of the output v-code and u-code are also extracted and shown at 830, 840, respectively, at the bottom of FIG. 8 for illustration.

Due to interleaving (of the v-code), the bit indices of output bits may not be consecutive (in a sequential order of bit index), and similarly the bit indices of punctured or otherwise reduced bits may not be consecutive (in a sequential order of bit index), but instead may be scattered in the mother code. However, interleaving can be designed such that the output bits, although not necessarily continuous, also form a shorter polar code.

The generator matrix corresponding to output v-code bits is a submatrix of the larger v-code generator matrix, with corresponding columns and rows with is, as shown by way of example in the extracted v-code generator matrix 830 in FIG. 8. The v-code generator matrix is a polar generator matrix (if there is no reduction in encoded bits), or a sequentially punctured polar generator matrix (if the number of encoded bits for output is reduced).

Consider the example v-code generator matrix 830 in FIG. 8, with the column denoted by 1, 2, 3, and 4 for ease of reference in Table 1 below:

TABLE 1
Example V-Code Generator Matrix

| 1 | 2 | 3 | 4 |
|---|---|---|---|
| 1 | 0 | 0 | 0 |
| 1 | 1 | 0 | 0 |
| 1 | 0 | 1 | 0 |
| 1 | 1 | 1 | 1 |

Using puncturing as an example for reducing the number of encoded bits for output, if there is no puncturing, or if the encoded v-code bits corresponding to any of the following generator columns are punctured: {1}, or {1, 2}, or {1, 2, 3}, then the v-code generator matrix is a polar generator matrix or a sequentially punctured v-code generator matrix and the partial interleaving is suitable for these puncturing patterns.

However, if the encoded v-code bits corresponding to any of the following generator columns are punctured: {4}, or {2, 3}, then the v-code generator matrix is no longer a polar generator matrix or a sequentially punctured v-code generator matrix and different partial interleaving should be used.

Note that, in this example, if the encoded v-code bits corresponding to generator columns {1, 3} are punctured, then even though the v-code generator matrix not be a sequentially-punctured 4 by 4 v-code generator matrix, it is still consistent with a 2 by 2 unpunctured polar generator matrix, and the partial interleaving is suitable. In particular, in the {1, 3}-punctured example, the submatrix with the {2, 4} columns and the {2, 4} rows is a 2 by 2 polar generator matrix

As can be seen from this rather simple example, there is quite a large interleaving design space or room for interleaver design.

In general, interleaving is designed in some embodiments such that the v-code generator matrix, after puncturing, remains a smaller polar generator matrix, possibly with some sequential puncturing (or any valid polar puncturing) allowed. Potential benefits include preserving polar code structure even with puncturing, reduced v-code rate, and, as fewer code bits of the v-code are punctured, the v-code becomes longer and provides incremental redundancy coding gain.

With reference again to FIG. 8, a mother code length N=32 is shown in the example. Suppose that bit index selection for the information set is based on reliability, the most reliable K=16 bit indices in {N/2+1 . . . N} are Iᵤ={17, 18, 19, 20, 21, 22, 23, 24, 25, 26, 27, 28, 29, 30, 31, 32}, and the most reliable K bit indices in {1 . . . N} are I_{w}={8, 12, 14, 15, 16, 20, 22, 23, 24, 26, 27, 28, 29, 30, 31, 32}. The information set in {1 . . . N/2} is Iᵥ={8, 12, 14, 15, 16}. The full information set is then

$$I = {I}_{u} ⋃ {I}_{u v} = [ {I}_{v} , {I}_{u} ] = \{ 8 , 12 , 14 , 15 , 16 , 17 , 18 , 19 , 20 , 21 , 22 , 23 , 24 , 25 , 26 , 27 , 28 , 29 , 30 , 31 , 32 \} .$$

For bit value placement, in an embodiment the following labels may be used for the 32 bit indices:

$$l = [ 0 , 0 , 0 , 0 , 0 , 0 , 0 , 5 , 0 , 0 , 0 , 4 , 0 , 3 , 2 , 1 , 1 , 2 , 3 , 6 , 4 , 7 , 8 , 12 , 5 , 9 , 10 , 13 , 11 , 14 , 15 , 16 ] .$$

Before encoding, the values of the K=16 input bits [a₁, a₂ . . . a₁₆] are assigned to labels 1, 2 . . . 16, respectively, in this example. In particular, with the labels as indicated above, the values of the bits [a₁, a₂, a₃, a₄, a₅], associated with labels 1, 2, 3, 4, 5, respectively, are each placed on two bit indices. The frozen bit indices (with label 0 in the example above) are assigned a value known to the decoder, such as 0. Bit value placement using labels is just one illustrative example of how bit values may be placed on bit indices. The present disclosure is not in any way limited to bit labeling.

The input vector after information/frozen bit value placement on bit indices is as follows:

$$u = [ 0 , 0 , 0 , 0 , 0 , 0 , 0 , {a}_{5} , 0 , 0 , 0 , {a}_{4} , 0 , {a}_{3} , {a}_{2} , {a}_{1} , {a}_{1} , {a}_{2} , {a}_{3} , {a}_{6} , {a}_{4} , {a}_{7} , {a}_{8} , {a}_{12} , {a}_{5} , {a}_{9} , {a}_{10} , {a}_{13} , {a}_{11} , {a}_{14} , {a}_{15} , {a}_{16} ] .$$

Encoding is performed by multiplying the input vector u by the polarization matrix, G₃₂ in this example, to obtain the code vector x=u·G₃₂.

This is an example of a rateless code with K=16 and arbitrary length 16≤M≤32, because bit value placement and encoding are not dependent upon M. The length-M transmitted code includes encoded bits on encoded bit indices [P+1, P+2, . . . 32] based on [u_{P+1}, u_{P+2} . . . u₃₂], where P=32−M in this example. The v-code in this example includes [u_{P+1}, u_{P+2} . . . u₁₆] on bit indices [P+1, P+2, . . . 16], and the u-code in this example includes [u₁₇, u₁₈, . . . u₃₂] on bit indices [17, 18, . . . 32].

The code construction in the above example is illustrated in Table 2 below. Table entries in the first and third rows, in italic, are bit indices for placement of values for encoding, and table entries in the second and fourth rows, in bold, are labels.

TABLE 2
Example Code Construction

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0 | 0 | 0 | 0 | 0 | 0 | 0 | 5 | 0 | 0 | 0 | 4 | 0 | 3 | 2 | 1 |

| 17 | 18 | 19 | 20 | 21 | 22 | 23 | 24 | 25 | 26 | 27 | 28 | 29 | 30 | 31 | 32 |
|---|---|---|---|---|---|---|---|---|---|---|---|---|---|---|---|
| 1 | 2 | 3 | 6 | 4 | 7 | 8 | 12 | 5 | 9 | 10 | 13 | 11 | 15 | 17 | 26 |

Although Table 2 illustrates code construction in a labeling embodiment, placement of bit values on bit indices need not involve labels, and the labels in Table 2 may be substituted with input bit values to illustrate code construction.

The example above describes construction of a (K≤M≤N, K) rateless polar code, where N=2×2^{┌log}^{₂} ^{K┐}, and ┌*┐ is the ceiling operation. This general example can be extended to arbitrary Nₘₐₓ>∞. The extension is straightforward. For example, a current code length N may be doubled to 2N, and then the (1) information/frozen bit index selection and (2) bit value placement, by labeling for example, can be performed using the same rules or procedures as outlined herein. Very long codes may be obtained by repeating this doubling, selection, and placement process, which may also or instead be referred to as recursively or iteratively extending or increasing code length. For example, some embodiments herein may refer to an upper set and a lower set of bit indices, or one u-code and one v-code. However, there can be multiple upper sets and lower sets as code length is recursively extended or increased. A code of length Nᵢ including a v-code and u-code can be viewed or treated as a u-code and further extended to length 2Nᵢ, and so on, for progressively longer code lengths.

Placement of bit values on bit indices may be implemented or supported in any of various ways, which may or may not involve bit labeling. FIG. 8A is a diagram illustrating bit value placement on bit indices according to one embodiment. Bit value placement may involve or be based on a bit index (or bit position) to bit value mapping, which may also be referred to as a bit value to bit index or bit position mapping, or as a mapping between a bit index or bit position and a bit value. Such a mapping may be either a one-to-one mapping or a many-to-one mapping.

A one-to-one mapping may be defined by or expressed as i→p, where i is a bit index of a bit position, in the input vector shown in FIG. 8A for example, and p is an index of a bit value, in a sequence of bit values such as the input sequence shown in FIG. 8A. For example, an input vector bit uᵢ with a one-to-one mapping to a bit value may be a frozen bit if there is only one frozen bit, or an information bit for an input bit value that is not to be placed on any other bit indices. In this sense the one-to-one mapped information bit is an information bit that is not checked by any other information bit in the input vector. This type of mapping may be referred to as a direct mapping between a bit value and a bit index, in that the mapping does not use a label. The mapping N→K in FIG. 8A is an example of a direct one-to-one mapping.

A many-to-one mapping may be defined by or expressed as {i₁, i₂, i₃ . . . }→p, where i₁, i₂, i₃ . . . are bit indices of bit positions, and p is an index of the bit value to which these bit indices are mapped. For example, the mapping {i, j, k}→p is consistent with a check-type function or relationship uᵢ=uⱼ=uₖ. Among {i, j, k}, if the bit uⱼ is decoded first, then the other bits uᵢ and uₖ take the same decoded value of uⱼ, and in this sense uᵢ and uₖ are information bits but may be considered a form of check bit. A many-to-one bit index to bit value mapping (or one-to-many bit value to bit index mapping) is a direct mapping, between a bit value and multiple bit indices or vice versa. The mappings for input bit values a₁ and a₂ in FIG. 8A are examples of a direct one-to-many or many-to-one mapping.

In FIG. 8A, input sequence bit values include the input bit values (ai). The input bit sequence represents an input block to channel coding, and bit values in that bit sequence are denoted by a₁, a₂, . . . , a_{K}, where K is the number of bits to be encoded. The bit values in the input bit sequence, and a predetermined bit value for frozen bits (0 in the example shown) are placed on bit indices in the binary input vector u₁, u₂, . . . , u_{N}, upon which polar coding is applied, based on the bit index/value index mapping shown at the right in FIG. 8A. The arrows between the input sequence bit values and the input vector bit values are intended to represent bit value placement according to which the input vector bit values are set to the input sequence bit values. Placement of a predetermined bit value of 0 for frozen bits is also shown in FIG. 8A for completeness.

The example shown in FIG. 8A illustrates the predetermined frozen bit value 0 and the input bit values a₁, a₂, . . . , a_{K} being placed on bit indices in the binary input vector u₁, u₂, . . . , u_{N}. Using notation introduced above, uᵢ=aₚ if i→p for a one-to-one mapping or { . . . i . . . }→p for a many-to-one mapping.

Bit value placement of a predetermined value of 0 for all frozen bits and input bit values for a sequence of input bits {1, 2 . . . K}, can be described by a mapping sequence. With i∈{1, 2 . . . N} denoting bit indices of bit positions for encoding, and l∈{0, 1 . . . K} denoting bit value indices for the predetermined value of 0 for frozen bits and input bit values a₁, a₂, . . . , a_{K}, a one-to-one mapping i→p can be denoted by l(uᵢ)=p, a many-to-one mapping {i, j, k}→p can be denoted by l(uᵢ)=l(uⱼ)=l(uₖ)=p, and the mapping sequence can be denoted by l(u₁), l(u₂), . . . , l(u_{N}), where N is mother code length or a total number of bit indices. For the example shown in FIG. 8A, a mapping sequence may be described as {0, 0, 0, . . . , 1, 2, . . . , 1, 2, 3, . . . , K}.

Bit value placement may involve labels in some embodiments. A bit index (or bit position) to label mapping (which may also be referred to as a label to bit index or bit position mapping, or as a mapping between a bit index or bit position and a label) may, like a bit index/bit value mapping, be either a one-to-one mapping or a many-to-one mapping.

A one-to-one mapping using labels may be defined by or expressed as i→p, where i is a bit index of a bit position as above, but p is an index of a label. For example, an input vector bit uᵢ with a one-to-one mapping to a label may be a frozen bit if there is only one frozen bit, or an information bit that does not share a label with, and in a sense is not checked by, any other information bit.

A many-to-one mapping using labels may be defined by or expressed as {i₁, i₂, i₃ . . . }→p, where i₁, i₂, i₃ . . . are bit indices of bit positions as above, and p is an index of the label to which these bit indices are mapped. For example, the mapping {i, j, k}→p is consistent with a check-type function or relationship uᵢ=uⱼ=uₖ. Among {i, j, k}, if the bit uⱼ is decoded first, then the other bits uᵢ and uₖ take the same decoded value of uⱼ, and in this sense uᵢ and uₖ are information bits but may be considered a form of check bit.

FIG. 8B is a block diagram illustrating example bit index to label mappings. In FIG. 8B, bit index to label mapping is represented with bit indices to the left and label indices to the right. The top mapping is a one-to-one mapping and the bottom mapping is a many-to-one mapping. Label mapping is optional, and bit indices may instead be directly mapped to bit values or indices, rather than via labels. Use of label mapping, rather than direct mapping, may be preferable in some embodiments. For example, when described in text in a communication standard or specification, bit values of input bits are not known, and labels may be used to represent the input bit values. As a result, bit mapping and bit value placement may be more conveniently described through the use of labels as a form of reference for the bit values.

FIG. 8C is a block diagram illustrating bit value placement on bit indices, using bit labeling according to an embodiment. In FIG. 8C, input sequence bit values include the input data bit values (aᵢ), and a predetermined bit value of 0 is also illustrated for completeness. Bit values of a label sequence, with individual elements in such a sequence being labels that are placed on bit positions or assigned to bits in an input vector for encoding, are also shown in FIG. 8C. The arrows between the bit values and the label sequence bit values represent both assignment of the labels and setting or assignment of bit values to the labels. The labels include labels that are respectively uniquely assigned to and thereby associated with bit positions in the input sequence, and a frozen bit label as well in the example shown. For encoding a sequence of input bits, the labels are set to the bit values of the input bits. This may equivalently be referred to as the labels being assigned to input bits or input sequence bits (or values), or as the input bits or input sequence bits (or values) being assigned to the labels. The relationship between each one of the K input bits and its assigned label is a unique, in that each input bit has only one uniquely assigned label, and no individual label is assigned to any other input bit. This may be considered another form of one-to-one mapping, between input bit positions (or bits) in an input bit sequence and respective labels.

The input bit sequence in FIG. 8C represents an input block to channel coding, and bit values in that bit sequence are denoted by a₁, a₂, . . . , a_{K}, where K is the number of bits to be encoded. The label sequence is denoted by l₀, l₁, l₂, . . . , l_{K}, where each label l₁, l₂, . . . , l_{K} is associated with an input bit position and input bit that is to be encoded, or with a predefined frozen bit value in the case of label l₀. The predetermined bit value and the bit values in the input bit sequence are placed on bit indices in the binary input vector u₁, u₂, . . . , u_{N}, upon which polar coding is applied, based on the labels and the bit index/label mapping shown at the right in FIG. 8C. The arrows between the label sequence bit values and the input vector bit values are intended to represent both assignment of the labels to input vector bit positions, and bit value placement on bit indices according to which the input vector bit values are set to the predetermined bit value or the input sequence bit values.

In the bit placement examples shown in FIGS. 8A and 8C, (without and with labels, respectively) the predetermined frozen bit value 0 and the input bit values a₁, a₂, . . . , a_{K} are placed on bit indices. With labels, the bit values are assigned as values of the label sequence l₀, l₁, l₂, . . . , l_{K}, where l₀=0 (or any predefined frozen bit value), and lₚ=aₚ for p=1, 2 . . . K. Then, the bit values 0, a₁, a₂, . . . , a_{K}, optionally having been assigned as bit values to the labels, are placed on bit indices in the binary input vector u₁, u₂, . . . , u_{N}. Using notation introduced above, uᵢ=aₚ (or lₚ in a labeling embodiment) if i→p for one-to-one mapping or { . . . i . . . }→p for many-to-one mapping.

A mapping sequence that describes bit value placement may include bit value indices as in preceding examples, or labels in label embodiments. A one-to-one mapping i→p can be denoted by l(uᵢ)=p, a many-to-one mapping {i, j, k}→p can be denoted by l(uᵢ)=l(uⱼ)=l(uₖ)=p, and the mapping sequence can be denoted by l(u₁), l(u₂), . . . , l(u_{N}), where N is mother code length or a total number of bit indices. For the example shown in FIG. 8C, a mapping sequence may be described as {l₀, l₀, l₀, . . . , l₁, l₂, . . . , l₁, l₂, l₃, . . . , l_{K}}.

A mapping sequence, whether expressed or defined using bit value indices or labels, could be defined in a communication standard or specification, or generated according to a procedure specified by such a standard or specification, for example. Online generation of such a mapping sequence is one possible option.

FIGS. 8A, 8B, and 8C and the foregoing descriptions thereof provide examples of how bit values may be placed on one or more bit indices. Embodiments disclosed herein are not dependent upon any particular approach to bit value placement. For example, embodiments may, but need not necessarily, involve bit labeling.

The present disclosure also encompasses embodiments that may support non-sequential decoding.

Polar codes are conventionally decoded by SC and its variants. Conventionally, all SC-based polar decoders follow sequential order of bits while performing successive cancellation. With

$${u}_{1}^{N} = [ {u}_{1} , {u}_{2} , … , {u}_{N} ]$$

denoting an input vector that includes information, frozen, and possibly PC bit indices, respectively, the sequential decoding order is u₁, u₂, . . . , u_{N}.

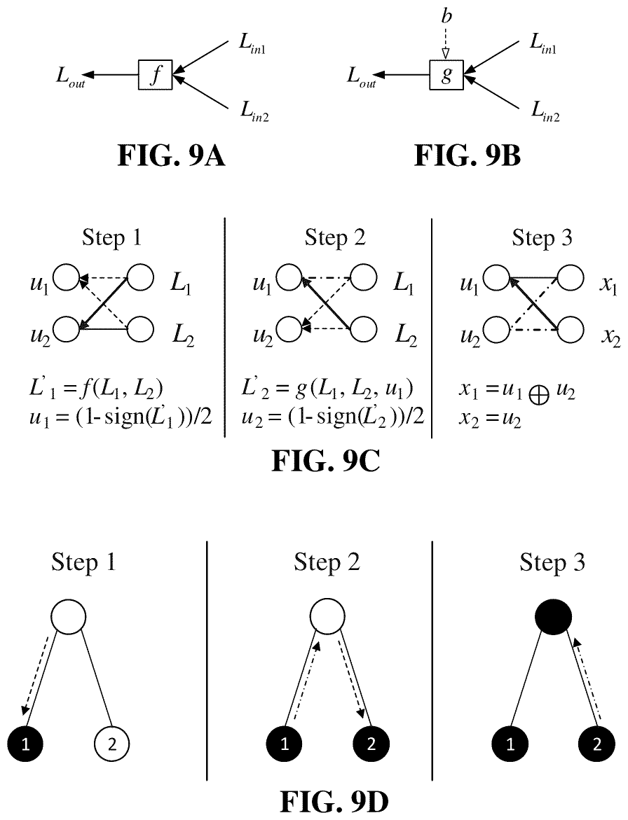

Before a hard decision (i.e., 0 or 1) can be made on a bit value for each information and frozen bit (and PC bit if necessary), received signals corresponding to the code bits are processed in the “butterflies” using the so-called f-function and g-function. The received signals may be known as soft information, which is typically expressed as log-likelihood ratios (LLRs). Soft information is a non-binary value representing the receiver's level of confidence, or probability, of a given bit value being a 0 or a 1. FIG. 9A is a block diagram illustrating the f-function used in polar code decoding and FIG. 9B is a block diagram illustrating the g-function used in polar code decoding.

As shown in FIG. 9A, the f-function receives two LLR inputs Lᵢₙ₁ and Lᵢₙ₂, and outputs an LLR Lout. In a simplified LLR-based algorithm, the f-function is as follows:

$${L}_{o u t} = f ( {L}_{in 1} , {L}_{in 2} ) {=}^{Δ} sign ( {L}_{in 1} , {L}_{in 2} ) \cdot min ( \vert {L}_{in 1} \vert , \vert {L}_{in 2} \vert )$$

As shown in FIG. 9B, the g-function receives three inputs, including two LLRs Lᵢₙ₁, Lᵢₙ₂ and a binary variable b, and outputs an LLR Lₒᵤₜ. In a simplified LLR-based algorithm, the g-function is as follows:

$${L}_{o u t} = g ( {L}_{in 1} , {L}_{in 2} , b ) {=}^{Δ} {L}_{in 1} + ( 1 - 2 b ) {L}_{in 2}$$

In the context of SC decoding, it is useful to consider the processing of one single “butterfly”, and FIG. 9C is a block diagram illustrating such processing.

In a first step represented at the left in FIG. 9C, the f-function is performed to calculate the LLR of u, using the two LLRs on the right side of the butterfly, and this is expressed as L′₁=ƒ(L₁, L₂) in the drawing. If u, is an information bit, then its value will be obtained by hard decision, as a value 0 for positive LLR and value 1 for negative LLR, or equivalently, u₁=(1−sign(L′₁))/2, where sign (L) is the sign function. Otherwise if u₁ is a frozen bit or a PC bit, then its value is pre-known (for a frozen bit) or calculated using preceding information bit values (for a PC bit). This applies to all bits from u₁ to u_{N}.

In a second step represented in the middle in FIG. 9C, the g-function is performed to calculate the LLR of u₂ using the two LLRs on the right side of the butterfly and the hard decision u₁, expressed as L′₂=g(L₁, L₂, u₁) in the drawing, followed by a hard decision to obtain u₂ based on the calculated LLR. The hard decision is expressed as u₂=(1−sign(L′₂))/2 in FIG. 9C. As shown, the first bit u, is always decoded before the second bit u₂, and more generally each bit is decoded sequentially or in order, from u₁ to u_{N}.

In a third step represented at the right in FIG. 9C, with hard decisions on both u₁ and u₂ having been made, it is straightforward to further recover the bits x₁ and x₂ as shown, by x₁=u₁⊕u₂ and x₂=u₂. This step is called the “re-encoding” step.

For convenience, a binary tree is often used to simplify the representation of an SC decoder or SC decoding, and FIG. 9D is a block diagram illustrating such a binary tree representation. In a binary tree, a root node at the top of each view in FIG. 9D represents the nodes on the right side of the butterfly (or a trellis), and the leaf nodes at the bottom represent the nodes on the left side of the butterfly (or a trellis). As can be seen, SC decoding becomes a depth-first binary tree traversal.

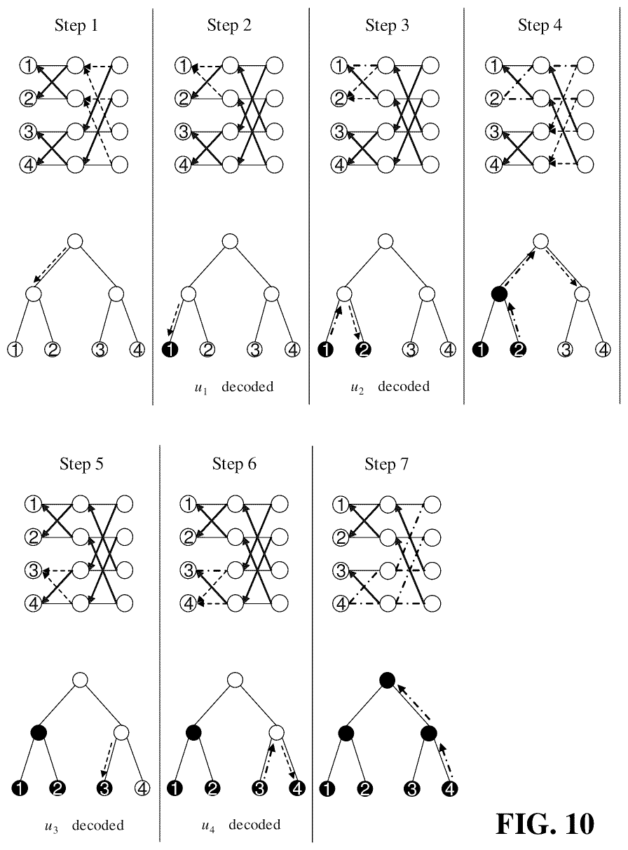

For illustrative purposes, an example of code length N=4 is provided below, and it is believed that decoding of all code lengths can be readily understood based on that example. FIG. 10 is a block diagram illustrating a binary tree representation of SC decoding of a length N=4 polar code.

In FIG. 10, a “butterfly” is represented by a “fork” in the binary tree. Each edge represents either a set of f-functions or a set of g-functions. The order of executing the f/g-function exactly corresponds to the edge traversing order, represented in FIG. 10 by the dashed-line arrows, in the binary tree. After all bits on the left side of a butterfly have been decoded (hard decided), represented by the dot-dash-line arrows in FIG. 10, the bits on the right side of the butterfly will be recovered immediately. Following these rules, the SC decoding of any mother code length N=8, 16, 32, 64 . . . can be derived.

This type of sequential SC decoding order has been used since the introduction of polar codes, and all SC-based decoders such as SCL, CA-SCL and PC-SCL follow the sequential order. Sequential SC-based decoding is believed to be the most common type of decoding for polar codes.

Error propagation can be an issue in SC decoding. When bit decoding order is fixed, a very unreliable information bit can become a bottleneck of an overall code block. For example, if the decision of the i-th bit is incorrect, there is a very high probability that all subsequent information bits with index j>i will be incorrect. In this scenario, if it were possible to avoid decoding the i-th bit first, then there is a much higher probability that the j-th bit will be correctly decoded; however, conventional sequential SC decoding is not capable of avoiding the decoding of the i-th bit to increase the probability of correctly decoding the j-th bit.

SC decoding is also not flexible to channel dynamics. In some polar code implementations such as the NR standard, the probability of successful decoding for each bit (also sometimes referred to as “reliability”) is pre-estimated and specified in the communication standard. In the NR standard, the reliability order is obtained by assuming an Additive White Gaussian Noise (AWGN) channel and is indicated in an ordered sequence in which bit indices are ordered according to their respective reliabilities. The K most reliable bit indices are selected as information bit indices for carrying payload data (also referred to herein as input bits). However, as described herein, channel conditions in wireless communications are constantly changing. As a result, the actual reliability of each bit index may be different from the pre-estimated, fixed reliability specified in the standard. In the case where the actual order of reliabilities (based on actual channel conditions) of given bit indices differs from the specified order of reliabilities, the standardized polar code implementation may not place all information bits into the actual highest reliability bit indices. If the same sequential decoding order is always used as in conventional sequential SC decoding, then the best performance might not be achieved.

Reliability may be considered a measure or indication of how likely it is that a bit value will be correctly decoded or decodable at a decoder. Other related terms or descriptors include capacity, probability or likelihood of error, and probability or likelihood of decoding without error. Reliability is primarily used herein, but features disclosed herein in the context of reliability may also or instead apply in the context of capacity, probability or likelihood of error, probability or likelihood of decoding without error, or other measures or indicators of rank or preference between bit indices for the purpose of placing input bit values for encoding.

Conventional sequential SC decoding also does not support parallel decoding. This is logical because sequential decoding is serial in nature, and all preceding bits have to be decoded before decoding a current bit.

Some embodiments disclosed herein relate to a type of SC decoding, but with arbitrary bit decoding order. For non-sequential decoding, conventional bit decision and LLR updating rules described above no longer apply. New rules and new decoding approaches for non-sequential decoding order are disclosed herein.

Code construction, or polarization, under arbitrary bit decoding order is also considered herein. Decoding order may have a significant impact on the actual reliability of each bit index. Polarization or reliability as currently defined in communications standards, for example, is fixed and is based on and only holds for conventional sequential decoding. Code construction of polar codes that are appropriate for arbitrary bit decoding order may be based on estimates of actual reliability of each bit index under a new decoding order. The K most reliable bit indices, in terms of estimated actual reliability for non-sequential decoding order, may be different from the most reliable bit indices according to pre-estimated, fixed reliabilities for conventional polar codes (including the 5G polar codes) with conventional sequential SC decoding.

Thus, some embodiments herein involve decoding and decoders. Multiple decoding orders are possible, and this is also referenced herein as decoding scheduling. Respective rules and operations for different decoding orders are provided by way of example.

Construction of codes may be based at least in part on decoding-dependent rank metrics such as reliability metrics that are derived for specific decoding orders. Bit indices for encoding may be selected as information bit indices for placement of input bit values or frozen bit indices for placement of a predetermined bit value, for example, based on rank.

These encoding and decoding aspects complement each other. With arbitrary decoding order, decoding scheduling can be determined based on specific channel conditions, and code construction enables bit indices in an information set to be determined based on a specific decoding scheduling.

Non-sequential decoding may be implemented or deployed in conjunction with other features disclosed herein.

Considering the general concept of decoding scheduling, a bit value for any bit, denoted uⱼ for ease of reference, among N bits u₁, u₂, . . . , u_{N} can be decoded without its preceding bit(s), uᵢ|i<j, having been decoded.

For a certain bit uⱼ or a set of consecutive bits, if a hard decision is not to be performed because the capacity of the bit(s) is insufficient for example, then the bit or set of consecutive bits can be skipped. Such skipping of one or more bits, in the context of polar codes, refers to not processing the butterflies associated with that bit or that set of consecutive bits. This means that all associated f-functions, g-functions, LLR updates and re-encoding steps are not performed, or equivalently on a binary tree, if all bits in a subtree are skipped, then that subtree will not be visited for now. Skipped bits may be decoded later when conditions are suitable for decoding, for example when capacity is sufficient.

In theory, N-M punctured code bits, on the right-hand side of a trellis such as the example shown in FIG. 5, will have a more significant impact on N-M bit indices, on the left-hand side of the trellis. For example, puncturing N-M code bits degrades the actual reliability of N-M bit indices, and may degrade those bit indices to zero capacity. If the code bits x₁, x₂, . . . , xᵢ are punctured for example, then bit indices corresponding to u₁, u₂, . . . , uᵢ have zero capacity. In some embodiments these bit indices are skipped for decoding and postponed hard decisions are made for bit values on these bit indices, or bits at these bit indices are not decoded at all according to some embodiments disclosed herein. A decision on a bit with 0 information has 0.5 probability of being correct. In other words, generally a hard decision should not be made unless there is confidence that the decision will be correct.

Another general guideline for determining decoding order is to decode a bit at a bit index corresponding to higher capacity (or lower bit error probability) first. In the above example, the decoding of a bit with zero-capacity may be postponed or cancelled entirely. In practice, there may be many bits or sets of consecutive bits, also referred to herein as blocks of bits, at bit indices with positive but very low capacity. It may be preferable to decode such bits later in a decoding process as well. For example, suppose that there are two blocks b1 and b2 with respective code rates R_{b1} and R_{b2} and respective finite length channel capacities C_{b1} and C_{b2}. If R_{b1}>C_{b1} and R_{b2}<C_{b2}, then it is preferable to decode block b2 before decoding block b1. Here, capacity may be defined differently from existing polar codes, as described in further detail below.

To describe code construction and a corresponding decoding process, a new type of bit is defined and used in some embodiments, in addition to existing frozen bits and information bits. This new type of bit can be given and referenced by any of various names, such as a null bit, an empty bit, a zero-capacity bit, a low-capacity bit, a useless bit, an irrelevant bit, a non-decision bit, an invalid bit, etc. Herein, “null bit” is used simply for ease of reference. It should be appreciated, however, that any of these example names, and/or others, may be used to refer to a bit with such low capacity that it is not to be decoded.

Table 3 below compares existing bit types including information bits and frozen bits to the new bit type, null bit.

TABLE 3
Bit Type Comparisons

| | | | | | Right |
|---|---|---|---|---|---|
| | Reli- | | | | propaga- |
| | ability | | | Bit hard | tion (re- |
| | or sub- | Value | Value | decision | encoding) |
| | channel | before | before | during | during |
| Bit type | capacity | encoding | decoding | decoding | decoding |
| Informa- | High | Input bit | Unknown | Decide | Perform |
| tion bit | | value | | based on | |
| | | | | LLR | |
| Frozen bit | Low | Predetermined | Known | Decide | Perform |
| | | bit value (e.g., | | based on | |
| | | 0) | | known | |
| | | | | value | |
| Null bit | Zero (or | Input bit value | Unknown | Do not | Do not |
| | very | | | decide | perform |
| | low) | | | at all | |

Although null bits may have zero-capacity, in some embodiments bits with very low reliability or capacity can be treated as null bits. In the context of bit indices, a set of bit indices for null bits is in addition to an information set, which is a set of bit indices for values of input bits, and a frozen set, which is a set of bit indices for a predetermined bit value.

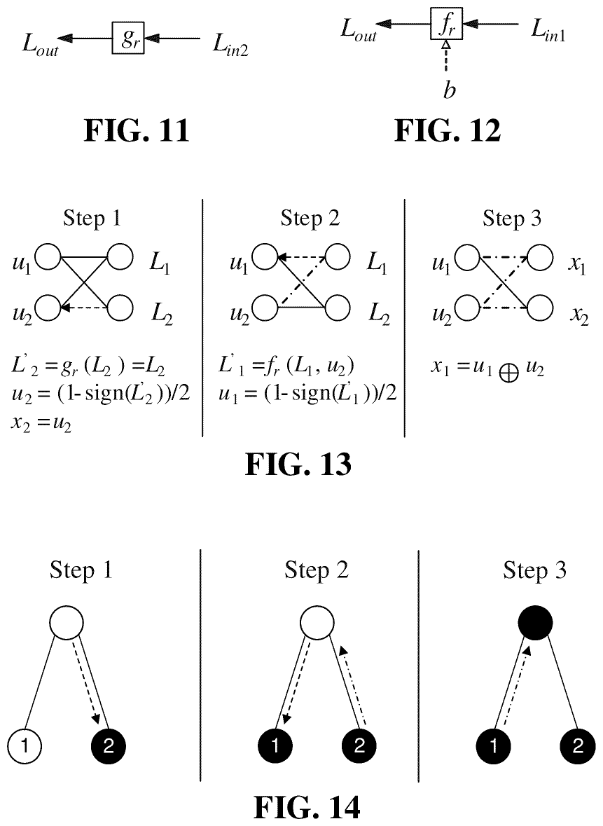

As described above, before a hard decision can be made, received signals corresponding to code bits are processed. Conventional sequential decoding uses two functions, including the f-function and g-function referenced above. Functions or operations in addition to the above-referenced f-function and g-function are disclosed herein and referenced as fᵣ-function and gᵣ-function. These functions are illustrated in block diagram form in FIGS. 11 and 12. FIG. 11 is a block diagram illustrating the gᵣ-function used in an embodiment of non-sequential polar code decoding, and FIG. 12 is a block diagram illustrating the fᵣ-function used in an embodiment of non-sequential polar code decoding.

As shown in FIG. 11, the example gᵣ-function receives an input LLR Lᵢₙ₂, and outputs an LLR Lₒᵤₜ. The gᵣ-function is as follows in some embodiments:

$${L}_{o u t} = {g}_{r} ( {L}_{in 2} ) {=}^{Δ} {L}_{in 2}$$

As shown in FIG. 12, the example fᵣ-function receives two inputs, including an LLR Lᵢₙ₁ and a binary variable b, and outputs an LLR Lₒᵤₜ. The fᵣ-function is as follows in some embodiments:

$${L}_{o u t} = {f}_{r} ( {L}_{in 1} , b ) {=}^{Δ} ( 1 - 2 b ) {L}_{in 1}$$

The examples in FIGS. 11 and 12 are specific to functions in the LLR domain, and are illustrative of functions that may be used in some embodiments. In practice, such functions may be implemented in other domains, such as a probability domain or a likelihood domain. Non-sequential decoding is not in any way limited to the LLR examples for the LLR domain.

More generally, an fᵣ-function has two inputs. A first input is soft information such as a probability value, a likelihood value, or an LLR, and a second input is a binary value. The first input value is associated with the first bit (upper right bit in a butterfly), and the binary value is associated with the second bit (lower right bit in the butterfly). The gᵣ-function has one input, which may be soft information such as a probability value, a likelihood value, or an LLR, associated with the second bit (lower right bit in the butterfly). These functions are different from the conventional functions, in that the conventional f-function has two inputs, and the conventional g-function has three inputs.

The gᵣ-function and the fᵣ-function may be expressed in more general form, in the context of decoding encoded bits in non-sequential decoding order based on the following functions gᵣ and fᵣ:

$${Fn}_{out , g \_ r} = {g}_{r} ( {Fn}_{in 2} )$$

$${Fn}_{out , f \_ r} = {f}_{r} ( {Fn}_{in 1} , b )$$

where
Fn_{out,g_r} and Fn_{out,f_r} respectively denote outputs associated with each of the functions;
Fnᵢₙ₁ and Fnᵢₙ₂ denote function inputs associated with respective positions (upper right and lower right in a butterfly) in a trellis graph for the polar code; and
b denotes a binary variable associated with the second bit (lower right bit in the butterfly).

In these general forms of the gᵣ-function and the fᵣ-function, the “Fn” function inputs and outputs may be probability values, likelihood values, or LLRs, for example, and the preceding examples illustrate the more specific form of each function in the LLR domain.

Whether to perform the f-function and the g-function, or the new fᵣ-function and the new gᵣ-function, depends on decoding order. With reference to FIG. 13, which is a diagram illustrating processing of a “butterfly” in an embodiment of non-sequential polar code decoding, if the lower-left bit (u₂ in the example shown) in the butterfly is to be decoded first, then the new fᵣ-function and the new gᵣ-function are used instead of the f-function and the g-function. In this example and others herein, LLR domain functions are used for illustrative purposes, but in these and other examples and embodiments, functions in other domains may be used.

In the first step, Step 1 in FIG. 13, the new gᵣ-function is performed to calculate the LLR of u₂ using the LLR on the right side of the butterfly, expressed as L′₂=gᵣ (L₂)=L₂ in the drawing. If u₂ is an information bit, then its value will be obtained by hard decision, of value 0 for positive LLR and value 1 for negative LLR. If u₂ is a frozen bit, then its bit value is already known. As shown, x₂ is equal to u₂, and therefore x₂ can be immediately set to x₂=u₂.

Step 2 in FIG. 13 illustrates a second step, in which the new fᵣ-function is performed to calculate the LLR of u₁ using the LLR on the right side of the butterfly and the hard decision on u₂, which is expressed in the drawing as L′₁=fᵣ(L₁, u₂), followed by a hard decision to obtain u₁, which is based on the LLR of u₁ if u₁ is an information bit. Note that the decoding order has been changed, in that the second bit u₂ is decoded before the first bit u₁ instead of conventional decoding in sequential order by decoding u₁ before u₂.

In the third step, Step 3, with both u₁ and u₂ decoded, it is straightforward to further recover the code bit x, by x₁=u₁⊕u₂. Note that here “re-encoding” is done in both Step 1 (x₂=u₂) and Step 3 (x₁=u₁⊕u₂) in this example. This is also different from sequential decoding.

It should be appreciated that LLR-based calculations or procedures (or similar decoding calculations or procedures) may still be performed for frozen bits and not just for information bits. Although LLRs might not be used in making bit decisions for frozen bits, received LLRs for received code bit indices that correspond to frozen bits may still be used in decoding input bits at bit indices in an information set.

FIG. 14 is a diagram illustrating a binary tree representation of an example of decoding scheduling, and is consistent with the above example that refers to FIG. 13.

Although decoding order may be reversed or otherwise be non-sequential for some bits or blocks of bits, remaining bits or blocks of bits may still follow conventional sequential decoding order. This type of combined decoding order, which may be referred to as hybrid sequential and non-sequential decoding order, may exhibit the best decoding performance.

For example, suppose that decoding order for a length-8 polar code is the following: u₅, u₆, u₇, u₃, u₄, u₁, u₂, u₈. Here, the blocks u₅, u₆, u₇ and u₃, u₄ and u₁, u₂ are sequential within themselves, and these may be referred to as sequential decoding blocks. However, decoding order at the beginning and between the blocks is non-sequential, in that u₅ and not u₁ is decoded first, and between the first two blocks u₅, u₆, u₇ are decoded before u₃, u₄, and between the last two blocks u₃, u₄ are decoded before u₁, u₂. In this example, decoding for u₈ is non-sequential in that u₈ is not decoded immediately after u₇, but in terms of f/g and fᵣ/gᵣ functions, the immediately preceding bit u₇ has already been decoded and therefore conventional f-function and g-function decoding can be used for u₈.

Within any block, decoding may be sequential or may include sequential and non-sequential encoding. For example, in the first block u₅ is decoded first, and this is non-sequential decoding because u₄ was not decoded before u₅. The new fᵣ-function and the new gᵣ-function are used for non-sequential decoding of u₅. Within the first block, however, after u₅ is decoded, sequential decoding (using the f-function and the g-function) can be used to decode u₆ and u₇ because u₅ was decoded before u₆. Decoding then transitions or “jumps” from u₇ to a non-consecutive or non-sequential bit u₃, and decoding of u₃ uses non-sequential decoding. Decoding of u₄ after u₃ is sequential, then non-sequential after transitioning to u₁, and then finally sequential decoding can be used to decode u₂ after u₁. In this example there are three non-sequential transitions, including the initial transition to u₅ and two subsequent transitions at the end of each of the first two blocks. In general, if there are multiple decoding scheduling options with different numbers of such transitions or jumps but the same or similar performance, the option that involves fewer transitions may be preferred.

In embodiments that involve PC bits, the values of the PC bits are either copied from another information bit, or determined from an XOR sum of a set of other information bits. With non-sequential decoding, the definition of PC bits and information bits may depend on decoding order. In general, if PC bits are used, it may be preferred that the last bit in a PC function that is to be decoded according to a decoding order is a PC bit. Once other bits in the PC function have been decoded, the last bit becomes known, presuming that all other bits are correctly decoded.

For example, for a PC function uᵢ+uⱼ=0, if uⱼ is decoded, then uᵢ immediately becomes known because uⱼ=uⱼ. Here, uᵢ, instead of uⱼ, is the PC bit. As another example, for a PC function uᵢ+uⱼ+uₖ=0, if uⱼ and uₖ are decoded, then uᵢ immediately becomes known because uᵢ=uⱼ+uₖ. Here, uᵢ, instead of uₖ, is the PC bit. This is an example of one bit value being placed on multiple bit indices.

Also in the context of PC bits, soft combining can be applied to PC bits. If there are only two undecided bits in a PC function, for example, then they can be jointly decided, such as by combining their soft information such as LLRs. For parallel decoding with uᵢ+uⱼ=0 (or uᵢ+uⱼ=1), for example, and the soft information L′ᵢ and L′ⱼ obtained at the same time, the following can be used

$${u}_{i} = {u}_{j} = ( 1 - sign ( {L}_{i}^{′} + {L}_{j}^{′} ) ) / 2$$

$$or$$

$${u}_{i} = ∼ {u}_{j} = ( 1 - sign ( {L}_{i}^{′} - {L}_{j}^{′} ) ) / 2$$

so that the decisions on uᵢ and uⱼ are done simultaneously. This may be referred to as joint decision or parallel decoding.

For serial decoding and using the same PC function example that was used above for parallel decoding, the difference is that the soft information L′ᵢ is obtained first, and L′ⱼ is to be obtained at a later time. In this case, the hard decision of uᵢ can be postponed until L′ⱼ is obtained. However, a soft decision of uᵢ can be made to allow decoding to continue. Once L′ⱼ is obtained, the hard decisions of uᵢ and uⱼ can be made as in the above parallel decoding example.

Decoding order may be determined or obtained based on any of various criteria, such as either or both of code length and channel.

For example, when code length M is a power of 2 (M=N=2ⁿ) sequential decoding may be applied, and sequential decoding may also be applied when code length is (1+a)N/2, where a∈{⅛, ¼, ⅜, ½, ⅝, ¾, ⅞}.

When code length M is over (1+a)N/2, however, where N is power of 2 mother code length and a {0, ⅛, ¼, ⅜, ½, ⅝, ¾, ⅞}, bit indices may be divided into two sets. The two sets include the first (1+a)N/2 bit positions, which may be sequentially decoded, and the other M−(1+a)N/2 bit positions, which may be decoded in non-sequential order.

Other criteria and/or decoding scheduling may be used in other embodiments, and examples are provided elsewhere herein, including at least below.

In some embodiments a scheduling sequence is used to indicate or specify decoding order for all bit indices. Decoding order may be uniquely defined by a scheduling sequence, which may also be referred to s a decoding scheduling sequence or DS. For example, in DS=[i₁, i₂, i₃ . . . i_{M}] the indices i are bit positions to be decoded, and their order in the sequence is the decoding order. As another example, several starting and/or ending points may be used to define a decoding order. Suppose that a scheduling sequence DS=[i₁, . . . , iₜ, iₜ₊₁ . . . i_{M}], includes several sets of consecutive indices represented by “ . . . ”. Such a scheduling sequency can instead be represented as DSₛ=[i₁, iₜ, iₜ₊₁, i_{M}], including only the starting and ending points of each set of consecutive indices.

As described in further detail elsewhere herein, a scheduling sequence may indicate or specify the order in which decoding for bit indices is to be performed. Consider, for example, a scheduling sequence of length M=N−P, and a permutation of indices [P+1 . . . N]. In special cases where P=0 (no puncturing) and P=N/2, decoding sequences may indicate decoding for bit indices in ascending order, for sequential decoding. For these special cases, it is possible to instead use non-sequential decoding, but sequential decoding may offer sufficient coding performance in the absence of puncturing (P=0) or output code length is N/2 (for P=N/2). In other cases, decoding scheduling sequences might not be in ascending order of bit index, for non-sequential decoding.

Partial interleaving as disclosed herein may favor sequential decoding over non-sequential decoding in many cases. Non-sequential decoding may be preferable to enable u-code decoding before v-code decoding when code rate of the v-code is too high while its capacity is too low. With partial interleaving for the v-code before encoded bit reduction, the code rate of the v-code is reduced, which may make sequential decoding (v-code before u-code) feasible and reduce the need for non-sequential decoding.

Although sequential decoding may potentially be feasible in many scenarios where partial interleaving and encoded bit reduction are applied as disclosed herein, non-sequential decoding may be supported. Even with scheduled decoding, the scheduling can be described in a very concise way, such as using only one number for example.

Scheduling sequences may be determined or designed according to any of various conditions or rules.

For example, an information bit and its preceding consecutive frozen bits may be bundled as an information bit block or cluster. Consecutive bit indices [i, i+1 . . . k−1, k], for example, may be bundled as an information bit cluster if and only if the k-th bit index is an information bit index, and all preceding bit indices [i, i+1 . . . k−1] are frozen bit indices. An information bit cluster with bit indices [i, i+1 . . . k−1, k] may be denoted by {k} for simplicity.

Decoding for bit indices in an information bit cluster is sequential in some embodiments. In other words, the decoding order within an information bit cluster is ascending order according to sequential order of the bit indices, and therefore not need be further specified in a scheduling sequence. For convenience, a reference to decoding an information bit cluster {k} is equivalent to decoding for the bit indices [i, i+1 . . . k−1, k] sequentially or in sequential order. With such a description simplification, a decoding sequence can be reduced to include or otherwise indicate only information bit indices.

Non-sequential decoding enables an information bit cluster to be decoded only after the corresponding information bit position at the information bit index of the cluster becomes sufficiently reliable. During the course of decoding, as more information bits are decoded, decoding of bit values for remaining bit indices will become more reliable in general. This phenomenon can be observed for both sequential and non-sequential decoding. Sequential decoding is well known. In non-sequential decoding, decoding for a bit index j, which may involve making a hard decision for an information bit value, can also enhance the decoding reliability for a preceding or smaller information bit index i (i<j). For example, consider an information bit cluster in which the bit value for the last bit index in the cluster has already been decoded from another bit index. In this example, the bit value for the last bit index is known, which makes the preceding bit indices in the cluster more reliable.

If an input bit value is placed on multiple bit indices, with the same label for example, then decoding of a bit value on any one of those bit indices will immediately reveal the bit value on the other bit indices. Therefore, information bit clusters corresponding to the other bit indices may be decoded immediately after the information bit cluster that corresponds to the first decoded bit index. Consider information bit clusters {k₁}, {k₂} and {k₃}, with corresponding information bit indices k₁<k₂<k₃ for illustrative purposes and the same input bit value placed on k₁, k₂, and k₃ using the same label for example. If the information bit cluster {k₃} is decoded first, then {k₁} and {k₂} can be decoded immediately after {k₃}.

An example of a rateless (16≤M≤32, K=16) code is provided above, with reference to FIG. 7 and Table 2. Scheduling sequences for such a code may be as follows, in an embodiment, with sequential decoding shown for the special cases of M=32 (P=0, no puncturing) and M=N/2 (P=N/2):

$$M = 16 : 17 , 18 , 19 , 20 , 21 , 22 , 23 , 24 , 25 , 26 , 27 , 28 , 29 , 30 , 31 , 32 ( Sequential decoding )$$

$$M = 17 : 17 , 16 , 18 , 19 , 20 , 21 , 22 , 23 , 24 , 25 , 26 , 27 , 28 , 29 , 30 , 31 , 32$$

$$M = 18 : 17 , 16 , 18 , 15 , 19 , 20 , 21 , 22 , 23 , 24 , 25 , 26 , 27 , 28 , 29 , 30 , 31 , 32$$

$$M = 19 : 17 , 16 , 18 , 15 , 19 , 14 , 20 , 21 , 22 , 23 , 24 , 25 , 26 , 27 , 28 , 29 , 30 , 31 , 32$$

$$M = 20 : 17 , 16 , 18 , 15 , 13 , 14 , 19 , 20 , 21 , 22 , 23 , 24 , 25 , 26 , 27 , 28 , 29 , 30 , 31 , 32$$

$$M = 21 : 17 , 16 , 18 , 15 , 13 , 14 , 19 , 20 , 21 , 12 , 22 , 23 , 24 , 25 , 26 , 27 , 28 , 29 , 30 , 31 , 32$$

$$M = 22 : 17 , 16 , 18 , 15 , 11 , 12 , 13 , 14 , 19 , 20 , 21 , 22 , 23 , 24 , 25 , 26 , 27 , 28 , 29 , 30 , 31 , 32$$

$$M = 23 : 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 24 : 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 25 : 9 , 10 , 11 , 12 , 13 , 14 , 15 , 16 , 17 , 18 , 19 , 20 , 21 , 22 , 23 , 24 , 25 , 8 , 26 , 27 , 28 , 29 , 30 , 31 , 32$$

$$M = 26 : 9 , 10 , 11 , 12 , 13 , 14 , 15 , 16 , 7 , 8 , 17 , 18 , 19 , 20 , 21 , 22 , 23 , 24 , 25 , 26 , 27 , 28 , 29 , 30 , 31 , 32$$

$$M = 27 : 6 , 7 , 8 , 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 28 : 5 , 6 , 7 , 8 , 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 29 : 4 , 5 , 6 , 7 , 8 , 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 30 : 3 , 4 , 5 , 6 , 7 , 8 , 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 31 : 2 , 3 , 4 , 5 , 6 , 7 , 8 , 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32$$

$$M = 32 : 1 , 2 , 3 , 4 , 5 , 6 , 7 , 8 , 9 , 10 , 11 , 12 , 13 , 14 , 15 , 16 , 17 , 18 , 19 , 20 , 21 , 22 , 23 , 24 , 25 , 26 , 27 , 28 , 29 , 30 , 31 , 32 ( Sequential decoding ) .$$

Using a simplified description in which only an information bit index is used to indicate represent each corresponding information bit cluster, simplified scheduling sequences for the above example are as follows:

$$M = 16 : 17 , 18 , 19 , 20 , 21 , 22 , 23 , 24 , 25 , 26 , 27 , 28 , 29 , 30 , 31 , 32 ( Sequential decoding )$$

$$M = 17 : 17 , 16 , 18 , 19 , 20 , 21 , 22 , 23 , 24 , 25 , 26 , 27 , 28 , 29 , 30 , 31 , 32$$

$$M = 18 : 17 , 16 , 18 , 15 , 19 , 20 , 21 , 22 , 23 , 24 , 25 , 26 , 27 , 28 , 29 , 30 , 31 , 32$$

$$M = 19 : 17 , 16 , 18 , 15 , 19 , 14 , 20 , 21 , 22 , 23 , 24 , 25 , 26 , 27 , 28 , 29 , 30 , 31 , 32$$

$$M = 20 : 17 , 16 , 18 , 15 , 14 , 19 , 20 , 21 , 22 , 23 , 24 , 25 , 26 , 27 , 28 , 29 , 30 , 31 , 32$$

$$M = 21 : 17 , 16 , 18 , 15 , 14 , 19 , 20 , 21 , 12 , 22 , 23 , 24 , 25 , 26 , 27 , 28 , 29 , 30 , 31 , 32$$

$$M = 22 : 17 , 16 , 18 , 15 , 12 , 14 , 19 , 20 , 21 , 22 , 23 , 24 , 25 , 26 , 27 , 28 , 29 , 30 , 31 , 32$$

$$M = 23 : 12 , 14 , 15 , 16 , 17 , 18 , 19 , 20 , 21 , 22 , 23 , 24 , 25 , 26 , 27 , 28 , 29 , 30 , 31 , 32$$

$$M = 24 : 12 , 14 , 15 , 16 , 17 , 18 , 19 , 20 , 21 , 22 , 23 , 24 , 25 , 26 , 27 , 28 , 29 , 30 , 31 , 32$$

$$M = 25 : 12 , 14 , 15 , 16 , 17 , 18 , 19 , 20 , 21 , 22 , 23 , 24 , 25 , 26 , 27 , 28 , 29 , 30 , 31 , 32$$

$$M = 26 : 12 , 14 , 15 , 16 , 8 , 17 , 18 , 19 , 20 , 21 , 22 , 23 , 24 , 25 , 26 , 27 , 28 , 29 , 30 , 31 , 32$$

$$M = 27 : 8 , 12 , 14 , 15 , 16 , 17 , 18 , 19 , 20 , 21 , 22 , 23 , 24 , 25 , 26 , 27 , 28 , 29 , 30 , 31 , 32$$

$$M = 28 : 8 , 12 , 14 , 15 , 16 , 17 , 18 , 19 , 20 , 21 , 22 , 23 , 24 , 25 , 26 , 27 , 28 , 29 , 30 , 31 , 32$$

$$M = 29 : 8 , 12 , 14 , 15 , 16 , 17 , 18 , 19 , 20 , 21 , 22 , 23 , 24 , 25 , 26 , 27 , 28 , 29 , 30 , 31 , 32$$

$$M = 30 : 8 , 12 , 14 , 15 , 16 , 17 , 18 , 19 , 20 , 21 , 22 , 23 , 24 , 25 , 26 , 27 , 28 , 29 , 30 , 31 , 32$$

$$M = 31 : 8 , 12 , 14 , 15 , 16 , 17 , 18 , 19 , 20 , 21 , 22 , 23 , 24 , 25 , 26 , 27 , 28 , 29 , 30 , 31 , 32$$

$$M = 32 : 8 , 12 , 14 , 15 , 16 , 17 , 18 , 19 , 20 , 21 , 22 , 23 , 24 , 25 , 26 , 27 , 28 , 29 , 30 , 31 , 32 ( Sequential decoding ) .$$

For example, in the M=32 simplified scheduling sequence, “8” indicates the information bit cluster {1, 2, 3, 4, 5, 6, 7, 8} in the corresponding non-simplified scheduling sequences for M=32. The frozen bit indices 1, 2, 3, 4, 5, 6, 7 are omitted from the simplified scheduling sequence. This is one example illustrating how simplified scheduling sequences that include or otherwise indicate only information bit indices for each information bit cluster may be shorter than non-simplified sequences that include or indicate each bit index.

In another embodiment, only one single number is used to specify a decoding starting bit index, also referred to herein as a starting point, and can describe the entirety of decoding scheduling. This means there is no need to store a scheduling sequence for each K≤M≤Nₘₐₓ. For sequential decoding, the starting point is a lowest bit index, such as P+1.

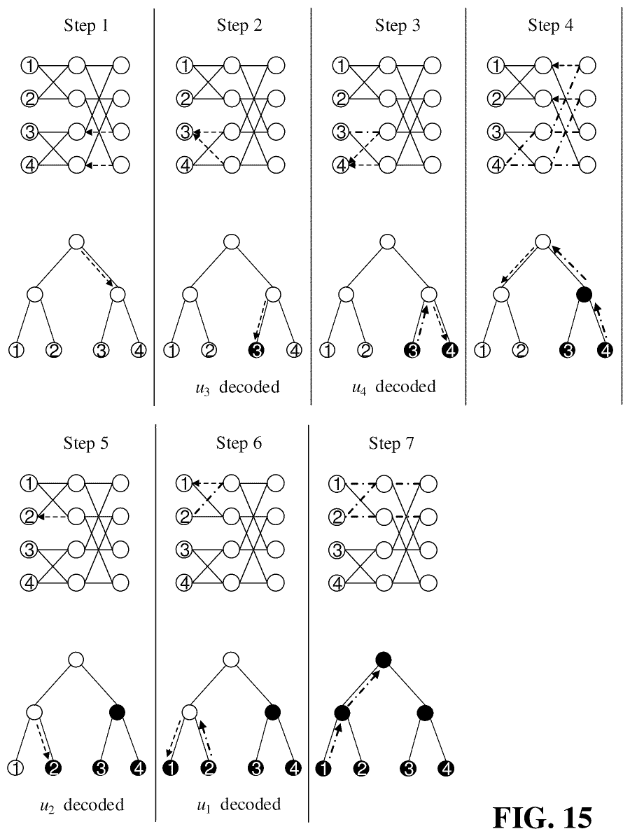

An illustrative and non-limiting example of non-sequential SC decoding is provided below, with reference to FIG. 15, which is a diagram illustrating a binary tree representation of non-sequential SC decoding of a length-4 polar code. The decoding order for the length-4 polar code in this example is u₃, u₄, u₂, u₁.

In FIG. 15, each edge represents either a set of f-functions or a set of g-functions, or a set of fᵣ-functions or a set of gᵣ-functions. The order of executing f/g/fᵣ/gᵣ-function is defined by the decoding order (or scheduling) u₃, u₄, u₂, u₁. Note that the left-to-right hard bit propagation, for u₃ at Step 3, for u₄ at Step 4, for u₂ at Step 6, and for u₁ at Step 7, is done once the lower-left bit in a butterfly has been decoded. In other words, there is no need to wait until both bits on the left side of a butterfly have been decoded (hard decided) to recover the bits on the right side of the butterfly. Following these rules, SC decoding of any mother code length N=8, 16, 32, 64 . . . can be derived given specific decoding scheduling.

### Generalizing to SCL Decoding, Including CA-SCL and PC-SCL:

each path [uᵢ₁, uᵢ₂, . . . , u_{iN}]∈{0, 1}^{N} represents non-sequential SC decoding results, where i₁, i₂, . . . , i_{N}∈{1, 2, . . . , N} are the bit indices;
a path metric is the likelihood (or probability) of the path, given the channel output, which may be expressed as Pr(uᵢ₁, uᵢ₂, . . . , uᵢ|L₁, L₂, . . . , L_{N})—in practice, this may be implemented in the logarithm domain, and approximated as the selected sum of LLRs:

$$PM = {\sum }_{j = i 1}^{i} {e}_{j} \vert {L}_{i}^{′} \vert , where {e}_{j} = \{ \begin{matrix}0 , if ( 1 - 2 {u}_{j} ) = sign ( {L}_{i}^{′} ) \\ 1 , if ( 2 {u}_{j} ) \neq sign ( {L}_{i}^{′} )\end{matrix}$$

is a binary indicator, and L′ⱼ is the LLR of uⱼ.

Decoding may otherwise be the same as sequential SCL decoding.

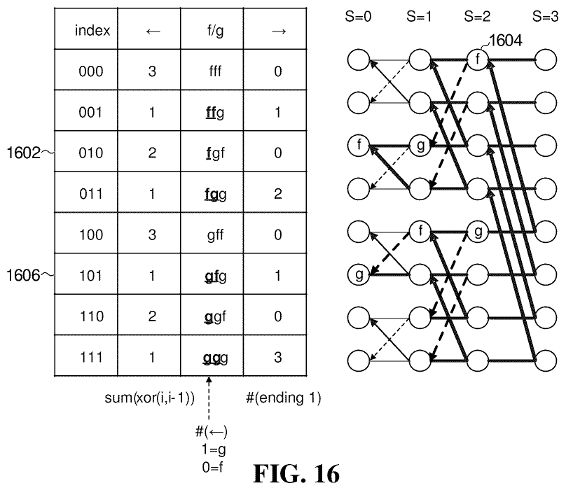

FIG. 16 includes a table and a diagram of a trellis, illustrating differences between non-sequential and sequential decoding. One feature of non-sequential decoding is that decoding may start from any point of the trellis at the right. New left/right propagation features are proposed to support arbitrary starting and finishing bit positions.

Given a bit index i with 0≤i≤N−1 (note here that the index starts from 0 rather than 1), several auxiliary parameters referenced in the example below include the following, all of which are shown at the table on the left in FIG. 16:
Binary expansion of index i: denoted by column label “index” in the table and expressed as bin(i)
Left propagation depth: denoted by column label←in the table and calculated by sum(xor(bin(i), bin(i−1)))
f/g function sequence: denoted by column label “f/g” in the table and expressed as {f, g}ⁿ, where n=log₂ (N), and the sequence is obtained by replacing each 0 in bin (i) by an f-function and replacing each 1 in bin(i) by a g-function—note that f/g here is intended to generally denote an f-function or a g function that, depending on decoding order and the bit being decoded, may be the conventional f-function, the fᵣ-function disclosed herein, the conventional g-function, or the gᵣ-function disclosed herein
Right propagation depth: denoted by column label→in the table and calculated by #(ending 1), i.e., the number of ending is in the bin(i).

To decode a bit indexed by i, there are two cases or scenarios.

If the previous bit indexed by i−1 has already been decoded, then the bit indexed by i can be decoded as in sequential decoding because the immediately preceding bit has been decoded. The left propagation depth (the number of stages to perform f/g function) is the second auxiliary parameter above, and the right propagation depth (the number of stages to perform re-encoding) is the fourth auxiliary parameter above.

If the previous bit indexed by i−1 has not yet been decoded, then decoding is non-sequential decoding. The left propagation starts from the rightmost stage, that is, the left propagation depth is n, and the full f/g function sequence is executed. The right propagation depth depends on the decoding status of its subsequent bits. A greedy right propagation of re-encoding is performed as long as there are no XOR operations with a lower bit (in the “butterfly”), or the lower bit is already decoded or re-encoded. As an example, consider starting decoding at index 2 (010), labeled 1602 in FIG. 16. In sequential decoding, an f-function at 1604 in the row of the trellis at S=2 would have been previously executed in decoding the index 0 bit, but for non-sequential decoding in this example this f-function has not been executed because decoding in this example starts with decoding the index 2 bit. Therefore, the f/g function sequence for starting non-sequential decoding at index 2 is shown in the table at the left in FIG. 16 as fgf, with the first fin the f/g function sequence in bold and underline formatting to indicate that non-sequential decoding starting at the index 2 bit involves an f-function that would already have been executed and would need not be repeated in sequential decoding of the index 2 bit after the index 0 and index 1 bits. The trellis at the right in FIG. 16 also includes f/g labeling for another example of non-sequential decoding starting at index 5 (101), labeled 1606 in FIG. 16.

In summary, jumping into decoding a bit in non-sequential order, using LLR domain as an example, may involve propagating LLR (right to left) from a deeper stage (right hand side of the trellis in FIG. 16; propagating hard decisions (left to right) to a deeper stage; and executing the fᵣ-function and the gᵣ-function as needed.

In some embodiments, information/frozen/PC bits are still decoded one by one, but decoding of such bits does not follow a sequential order according to the bit index [1, 2, 3 . . . N]. Instead, the decoding order is specified by a decoding scheduling sequence DS=[i₁, i₂, i₃ . . . i_{M}], where the indices are the information/frozen/PC bit indices to be decoded. Note that M can be an integer smaller than N, because some zero-capacity or near zero-capacity bit indices can be skipped. This is an example of what may be referred to as “scheduled-serial” decoding.

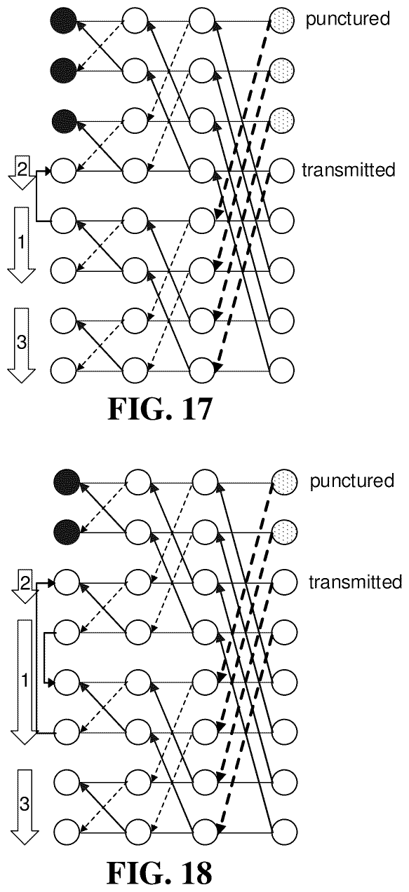

FIG. 17 is a diagram of a trellis, illustrating an example of decoding that involves non-sequential polar code decoding. The example in FIG. 17 is for a length-8 code where the first 3 code bits are punctured, and the decoding scheduling sequence is DS=[5, 6, 4, 7, 8]. In the example shown in FIG. 17, bit values for the bit indices 4 and 5 are the same, and the return arrow from position 5 to position 4 at the left in FIG. 17 is intended to represent the fact that the bit value for bit index 4 is known after the bit value for bit index 5 has been decoded.

To reduce description complexity, the decoding scheduling sequence may be shortened to indicate only non-sequential parts. If there is a consecutive sequential subsequence [i, i+1 . . . j], for example, this can be represented as [i, j] for simplicity. A full decoding scheduling sequence DS=[i₁, i₂, i₃ . . . i_{M}] which can be represented as DS=[i₁, . . . , iₜ, iₜ₊₁ . . . i_{M}], where “ . . . ” are consecutive indices, can be reduced to DSₛ=[i₁, iₜ, iₜ₊₁, i_{M}]. For example, DS=[5, 6, 7, 2, 3, 4, 8] can be reduced to DSₛ=[5, 7, 2, 4, 8].

FIG. 18 is a diagram of a trellis, illustrating another example of decoding that involves non-sequential polar code decoding. In this example of a length-8 code, the first 2 code bits are punctured, and the decoding scheduling sequence is DS=[4, 5, 6, 3, 7, 8], or shortened as DSₛ=[4, 6, 3, 7, 8]. In the example shown in FIG. 18, bit values for the bit indices 4 and 5 are the same, and bit values for the bit indices 3 and 6 are the same. The arrows from position 4 to position 5 and from position 6 to position 3 at the left in FIG. 18 are intended to represent this. Regarding indices 4 and 5, FIG. 18 is different from FIG. 17 in that the bit value for bit index 5 is decoded first in FIG. 17, but the bit value for bit index 4 is decoded first in FIG. 18.

Decoding orders in which information/frozen/PC bits are no longer decoded in serial order, but in parallel, are also possible. In cases in which there are multiple bits that have the same value, according to a PC function for example, they can be hard decided in parallel after combining their soft information such as LLRs. The decoding order in each parallel decoding block can be sequential, or non-sequential.

A parallel decoding order can be represented by a set of decoding scheduling sequences, instead of only one sequence. If there are p blocks that are to be decoded in parallel, then there may be p decoding scheduling sequences, including a respective decoding scheduling sequence for each block. This may be expressed as follows, as an example:

$$D {S}_{1} = [ {i}_{1} , {i}_{2} … ] , D {S}_{2} = [ {j}_{1} , {j}_{2} … ] , … , {DS}_{p} = [ {k}_{1} , {k}_{2} … ] .$$

Any bits that are to be simultaneously hard decided can be represented by index tuples, which are pairs in the case of two bits to be hard decided at the same time, triples as in the following examples in the case of three bits to be hard decided at the same time, and so on:

$$( {i}_{r} = {j}_{s} = {k}_{t} ) , ( {i}_{r + 4} = {j}_{s + 2} = {k}_{t + 1} ) , …$$

The above examples illustrate that bits that are to be simultaneously hard decided need not have corresponding positions in the decoding scheduling orders of parallel decode blocks. Such bits also need not be in the same position within their respective blocks. In the first example above, the r-th index in DS₁, the s-th index in DS₂, and the t-th index in DS₃ are to be simultaneously hard decided. All of r, s, and t in this example, or any two of them, may be the same, or they may all be different.

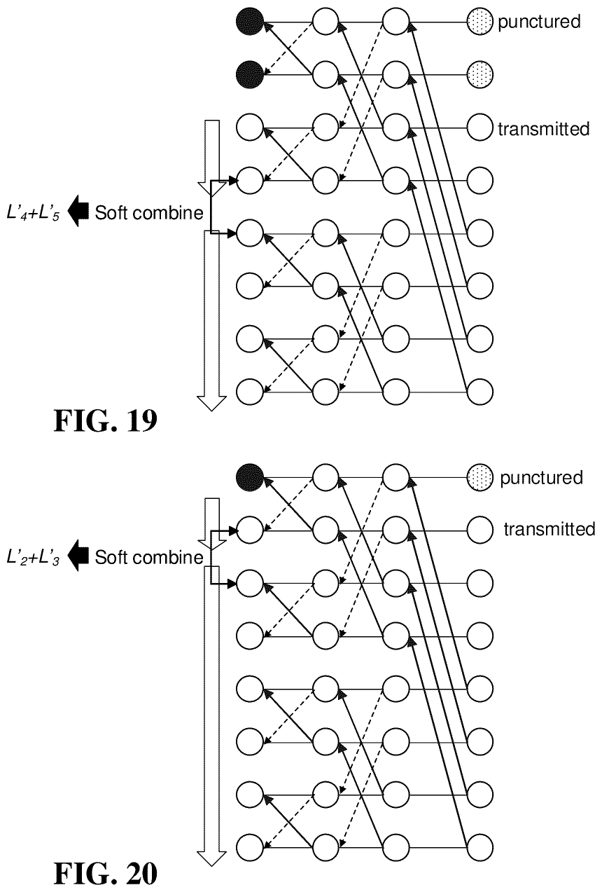

FIG. 19 is a diagram of a trellis, illustrating a further example of decoding that involves non-sequential polar code decoding. In the example shown, the upper half and lower half of the trellis are decoded in parallel. The decoding scheduling sequences are DS₁=[3, 4], DS₂=[5, 6, 7, 8], and (4=5). As seen, for the 4^{th} and 5^{th} indices, their bit values are the same, and therefore their soft information such as LLRs L′₄ and L′₅ are combined first in this example, and then a joint hard decision is made: u₄=u₅=(1−sign(L′₄+L′₅))/2.

FIG. 20 is a diagram of a trellis, illustrating yet another example of decoding that involves non-sequential polar code decoding. In the example shown, as in the above example that refers to FIG. 19, the two parallel-decoded blocks have different sizes. More generally, blocks that are to be parallel-decoded may be of the same size or different sizes.

The decoding scheduling sequences in the example shown in FIG. 20 are DS₁=[2], DS₂=[3, 4, 5, 6, 7, 8], and (2=3). As seen, for the 2^{nd} and 3^{rd} indices, their bit values are the same, and therefore their soft information such as LLRs L′₂ and L′₃ are combined first in the example shown, and then a joint hard decision is made: u₂=u₃=(1−sign(L′₂+L′₃))/2.

In these two examples, the splitting point between two blocks, denoted o for ease of reference, are different. They are 4 and 2, respectively. In practice, a splitting point can be set as mother code length N divided by a power of 2 integer, such as o=N/2, N/4, N/8, N/16, etc., and their combination sums, such as o=N/2+N/4, o=N/2+N/8, o=N/2+N/4+N/16, etc.

In embodiments that may be referred to herein as bidirectional decoding, directions of decoding different blocks can be different. For example, one block may be decoded in sequential order, while another block is decoded in reverse sequential order.

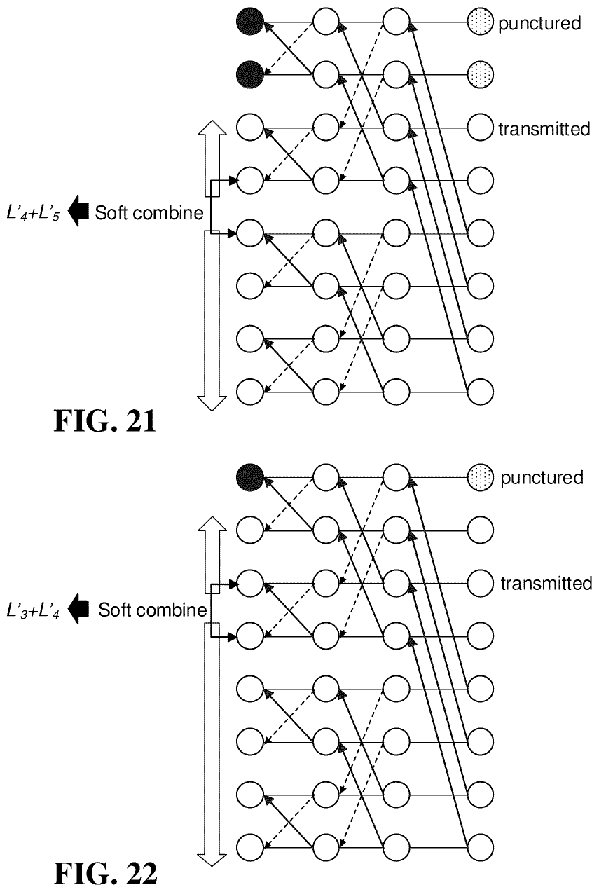

FIG. 21 is a diagram of a trellis, illustrating a bidirectional decoding example according to an embodiment. In the example shown, the upper and lower half of the trellis are decoded in parallel, but in different directions. Although the example in FIG. 21 is for parallel-decoded blocks, bidirectional decoding may be applied to serially decoded blocks.

The decoding scheduling sequences in FIG. 21 are DS₁=[4, 3], DS₂=[5, 6, 7, 8], and (4=5). As seen, the bit values for the 4^{th} and 5^{th} indices are the first decoded bit in each block and are the same, and therefore their soft information such as LLRs L′₄ and L′₅ are combined in the example shown and then a joint hard decision is made: u₄=u₅=(1−sign(L′₄+L′₅))/2.

FIG. 22 is a diagram of a trellis, illustrating another bidirectional decoding example. In this example, the two parallel-decoded blocks have different sizes. The decoding scheduling sequences are DS₁=[3, 2], DS₂=[4, 5, 6, 7, 8], and (3=4). As seen, the bit values for the 2^{nd} and 3^{rd} indices are the first decoded in each block and are the same, and therefore their soft information such as LLRs L′₃ and L′₄ can be combined and then a joint hard decision can be made: u₃=u₄=(1−sign(L′₃+L′₄))/2.

Bit labeling and non-sequential decoding are illustrative of features that may be implemented in conjunction with partial interleaving and encoded bit reduction as disclosed herein.

One potential benefit of reducing a number of encoded bits, by rate matching such as puncturing, is to allocate capacity to a whole codeword. Bit indices that correspond to encoded bits that are punctured have zero capacity, and bit indices that correspond to encoded bits that are transmitted, for example, have a capacity that depends on signal to noise ratio (SNR).

Partial interleaving, combined with reducing the number of encoded bits, can provide for more accurate allocation of capacity to where it is needed the most. For subsets of encoded bits of a codeword in which the number of encoded bits is not reduced, there is no need for interleaving. Full interleaving (e.g., as implemented in the 5G NR) will change the order of all encoded bits, and therefore puncturing will, in effect, apply to an entire codeword because an encoded bit that was originally at any position in a codeword may appear at a puncture position after interleaving. More targeted reduction in the number of encoded bits, by puncturing or otherwise, is preferable such that encoded bits are removed from only certain parts of a codeword, and accordingly only certain bit indices or parts of a code block have reduced capacity. Other codeword and code block parts are not adversely impacted, or at least are not adversely impacted as significantly. Put another way, only certain parts of a code or codeword are punctured, and it is preferable to restrict interleaving to those parts.

To summarize, a potential advantage of partial interleaving compared to interleaving all encoded bits is enabling more targeted and fine-tuned encoded bit reduction, such as via puncturing for example. Disclosed embodiments may also provide for lower description and implementation complexity as well.

For the length(s) of interleaved subset(s) of a codeword, there are several options. For example, with a proportion of the interleaved subset(s) with respect to the current mother code length denoted by ε, ε can be a parameter that is configured by a communication standard or specification (for example, a quantized value of ε, or an index in a pre-specified table corresponding to the parameter E), or through control signaling such as downlink control information (DCI) and/or uplink control information (UCI) signaling.

In some embodiments, ε is 1/X, where X is a power of 2. This type of reciprocal power of 2 value of the parameter ε may be preferred where mother code length is a power of 2, so that the resulting proportional length of a subset of encoded bits and the reduced number of encoded bits after encoded bit reduction will more easily form a shorter polar code.

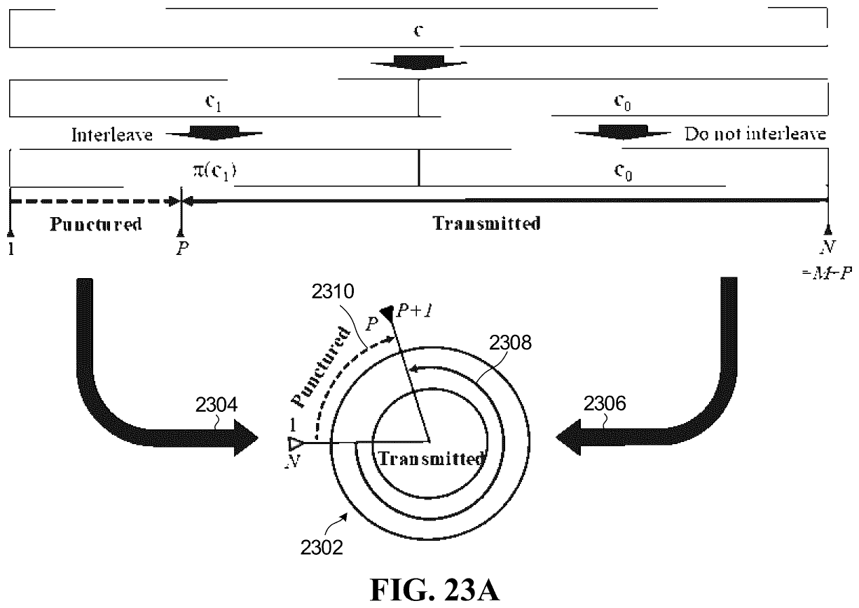

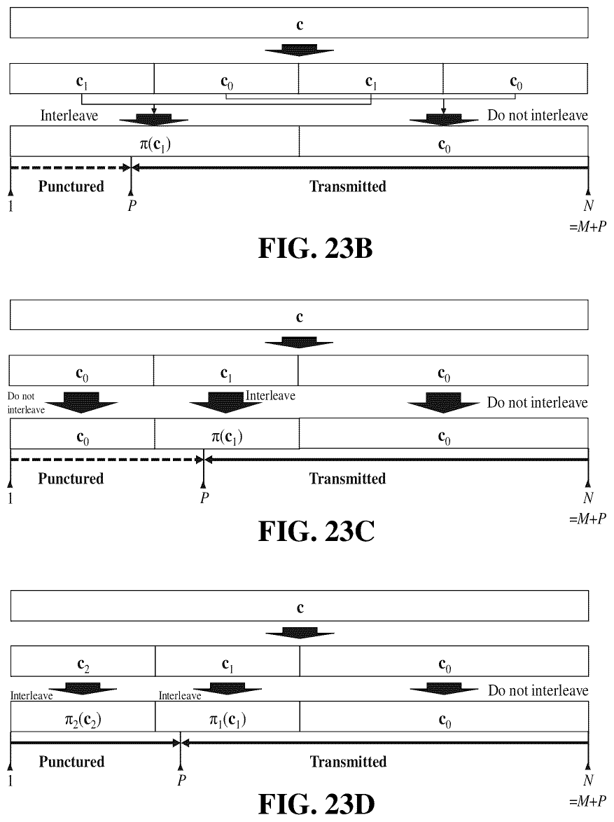

Regarding the position(s) of the interleaved subset(s) within a codeword, in an embodiment the subsets are evenly distributed within the codeword. FIG. 23A is a diagram illustrating partial interleaving and puncturing according to such an embodiment.

With reference to FIG. 23A, a codeword of length N is denoted by c, and the illustrated example is two equal-length subsets of the encoded bits in the codeword. The two subsets c₁ and c₀ may be the first and second halves of the codeword c (a v-code and a u-code, for example) as shown. With codeword c of length N, c₁=c[1, 2 . . . N/2] and c₀=c[N/2+1, N/2+2 . . . N]. The interleaved subset is denoted by π(c₁), and is concatenated with the non-interleaved subset, c₀ in this example, to generate a partially interleaved codeword c′=[π(c₁), c₀].

In practice, the bits in c′ can be sequentially written into a cyclic buffer. In FIG. 23A, a cyclic buffer is shown at 2302, and the arrows 2304, 2306 are intended to represent sequentially writing π(c₁) and c₀ into the cyclic buffer. Transmission starts at the N-th bit, and proceeds counter-clockwise in the sense of the circular buffer to the (P+1)-th bit, and is illustrated by the arrow 2308 in the example shown. Equivalently, transmission may start at the (P+1)-th bit, and proceed clockwise in the sense of the circular buffer 2308 to the N-th bit. As a result, the 1^{st} to the P-th bits of the interleaved codeword part a π(c₁) are not transmitted, which means that those bits are punctured. Puncturing is illustrated in FIG. 23A by the dashed arrow 2310.

In FIG. 23A, c₁ is an example of a subset of encoded bits, in codeword c. The subset includes fewer than all of the encoded bits in c. The encoded bits in the subset c₁ are interleaved, and the number of encoded bits in the interleaved subset: π(c₁) is reduced, by puncturing in the example shown. Thus, the subset c is, in at least this sense, for reducing the number of encoded bits. The reduced number of encoded bits may be output, for transmission for example.

FIG. 23B is a diagram illustrating partial interleaving and puncturing according to another embodiment, in which subset c₁, which is to be interleaved, is partially “sandwiched” between encoded bits in non-interleaved subset c₀. This illustrates that codeword subsets such as c₀ and c₁ need not necessarily be consecutive or serial, and may instead be interspersed with each other within a codeword c.

The example shown in FIG. 23B is illustrative of an embodiment in which a codeword c is divided or partitioned into S shorter blocks. In some embodiments, the number of shorter blocks S is a power of 2, which may be preferred where mother code length is a power of 2 so that the length of an interleaved codeword subset and the reduced number of encoded bits remaining after puncturing will more easily form a shorter polar code. Equal-length shorter blocks may also be preferred for the same reasons.

One or more of the shorter blocks, including two shorter blocks in the example shown, are selected for interleaving, and the other shorter blocks will not be interleaved. In the case of one shorter block being selected for interleaving, the shorter block is a subset of encoded bits for interleaving. Multiple shorter blocks selected for interleaving may be aggregated into a subset and interleaved, and the interleaved subset may be moved to the front of a partially interleaved codeword, or the shorter blocks may remain in their original positions in a codeword but with their encoded bits in interleaved order. In the example shown in FIG. 23B, S=4, and the 1^{st} and 3^{rd} shorter blocks are selected and aggregated into a subset for interleaving, and moved to the front of the partially interleaved codeword c′=[T(c₁), c₀]. The example in FIG. 23B is illustrative of a subset that includes encoded bits that are non-consecutive in the order of encoded bits in a codeword.

FIG. 23B illustrates what may be considered a form of subblock-wise full interleaving before performing bit-wise partial interleaving. The subblock-wise full interleaving refers to aggregation of the non-consecutive 1^{st} and 3^{rd} shorter c₁ blocks into one subset, for bit-wise partial interleaving within that aggregated subset to generate π(c₁). Such aggregation is one example of subblock-wise full interleaving, but other subblock-wise interleaving, such as the 5G NR subblock-wise interleaver, may be used in other embodiments. The bit-wise partial interleaving of the aggregated subset may be, for example, block interleaving by a block interleaver. Potential benefits of using the 5G NR interleaver include backward compatibility with 5G and good performance.

FIG. 23C is a diagram illustrating partial interleaving and puncturing according to yet another embodiment, in which the encoded bits to be interleaved (in a codeword subset c₁) are selected, inserted, or otherwise positioned or “sandwiched” between encoded bits in c₀. Here c₁ is interleaved, but stays in its original position. The example in FIG. 23C is illustrative of a subset that is preceded by and followed by other encoded bits in the order of encoded bits in a codeword.

In FIG. 23C, the first subblock c₀ is not interleaved. This may be useful, for example, when the first subblock already has a very low partial code rate, and interleaving becomes unnecessary. Potential benefits of not interleaving a subblock that has a low code rate include low complexity and good performance.

Interleaving is not in any way restricted to a single interleaver or type of interleaving. For example, multiple interleavers may be used to separately interleave multiple subsets of encoded bits of a codeword. This feature enables design of finer-grained puncturing patterns, which may help better adapt to different code rates and lengths.

Consider a code vector c being divided into multiple subsets c₀, c₁, c₂ . . . c_{B}, where B is the number of subsets. Partial interleaving means that only one or more of the subsets, but not all of the subsets, are separately interleaved, with other subset(s) and encoded bits of the codeword remaining non-interleaved.

FIG. 23D is a diagram illustrating partial interleaving and puncturing according to such an embodiment, with multiple different interleavers. In FIG. 23D, the codeword c is divided into B=3 subsets, denoted by c₀, c₁, c₂, and subsets c₁, c₂ are interleaved in two different interleavers: π₁ and π₂. The interleaved subsets are π₁(c₁) and π₂(c₂), respectively, and c₀ is not interleaved, and the partially interleaved codeword is a concatenation of: π₁(c₂), π₂(c₁), and c₀. This is illustrative of an embodiment in which there are multiple unique subsets, which include fewer than all of the encoded bits, to be interleaved. In such an embodiment, the subsets to be interleaved together also include fewer than all of the encoded bits, so that the interleaving remains partial interleaving even though multiple subsets of encoded bits are interleaved.

FIG. 23D illustrates an example in which code bits in more than one subblock are interleaved separately within each subblock. This type of interleaving can provide more flexibility in design space, and stable performance under different operating conditions.

Different types of interleaving are possible. Multiple types of interleavers or interleaving can be supported for partial interleaving, and several illustrative examples are described herein.

In block interleaving, original code bits are written into and read from a block interleaver with RI rows (referring to the number of rows of the interleaver, RI) and CI columns (referring to the number of columns of the interleaver, CI). Either or both row-in write/column-out read and column-in write/row-out read may be supported.

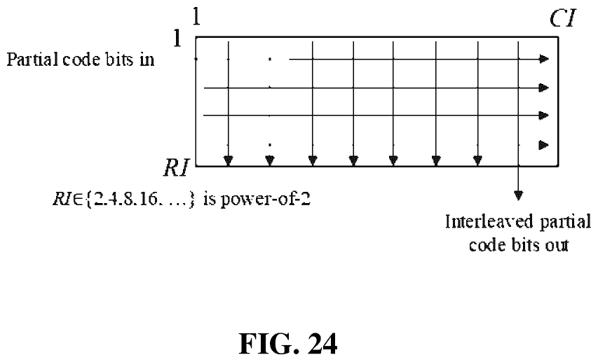

Without loss of generality, partial code bits, which are encoded bits that are to be interleaved, may be written row-by-row and read column-by-column to obtain interleaved partial code bits. FIG. 24 is a diagram illustrating such row-by-row writing and column-by-column reading to interleave partial code bits according to an embodiment. The horizontal arrows in FIG. 24 represent row-by-row writing and the vertical arrows represent column-by-column reading of partial code bits.

A number of rows RI, or a number of columns CI, or both, may be a power of 2. A power of 2 size for block interleaver rows and/or columns may be preferred for mother code lengths that are a power of 2, but other block interleaver sizes are possible. In the example shown in FIG. 24, RI is a power of 2, such as 2, 4, 8, 16, . . . .

With the partial code bits denoted c₁[1], c₁[2], . . . c₁[W], where W is the size of subset of code bits (also referred to herein as a partial block or partial code bits) to which interleaving is to be applied, the interleaved partial code bits c_{π1}[1], c_{π1}[2], . . . c_{π1}[W] may be generated according to the following example pseudocode:

```
For j=1 to W/RI
  For i=1 to RI
    c_{π1}[i+(j−1)*RI] = c_{π1}[j+(i−1)*(W/RI)]
  End for
End for
```

Each row and/or column may also or instead be permuted (or written/read in different orders). A permutation sequence for row and/or column permutation, in combination with block interleaving, can be generated or otherwise obtained according to, for example, a bit-reversal order or a pseudo-random order. The pseudo-random order may be specified, for example, by a polynomial, by a table, or by a transform such as a Fourier transform, a Hadamard transform, a discrete cosine transform, or a wavelet transform.

Another block interleaving example is based on the following 5G NR subblock interleaving, reproduced from 3rd Generation Partnership Project (3GPP), “Multiplexing and channel coding,” 3GPP 38.212 V.15.3.0, 2018:

TABLE 5.4.1.1-1
Sub-block interleaver pattern P(i)

| i | P(i) |
|---|---|
| 0 | 0 |
| 1 | 1 |
| 2 | 2 |
| 3 | 4 |
| 4 | 3 |
| 5 | 5 |
| 6 | 6 |
| 7 | 7 |
| 8 | 8 |
| 9 | 16 |
| 10 | 9 |
| 11 | 17 |
| 12 | 10 |
| 13 | 18 |
| 14 | 11 |
| 15 | 19 |
| 16 | 12 |
| 17 | 20 |
| 18 | 13 |
| 19 | 21 |
| 20 | 14 |
| 21 | 22 |
| 22 | 15 |
| 23 | 23 |
| 24 | 24 |
| 25 | 25 |
| 26 | 26 |
| 27 | 28 |
| 28 | 27 |
| 29 | 29 |
| 30 | 30 |
| 31 | 31 |

In 5G, the above 32-subblock interleaver is applied to an entire codeword of length N code. According to an embodiment, the 32-subblock interleaver may be reused, but applied only to a partial block, such as a length-N/2 v-code. As code length is increased, the 32-subblock interleaver can be applied to the v-code at each stage or iteration.

For example, consider an initial output code length of M₀=128, with K=96 (code rate 3/4). The code length may be extended in multiple stages or transmissions, as follows for example:
1. M₁=256 (extending from length 128 to length 256), apply the 32-subblock interleaver to the length-128 v-code—each subblock has length 4;
2. M₂=512 (extending from length 256 to length 512), apply the 32-subblock interleaver to the length-256 v-code—each subblock has length 8;
3. M₃=1024 (extending from length 512 to length 1024), apply the 32-subblock interleaver to the length-512 v-code—each subblock has length 16;
. . . and so on—the final output code length can be very large, up to maximum mother code length Nₘₐₓ.

This example also illustrates that even with half-interleaving, a codeword or set of output code bits as a whole may be mostly interleaved and not just half-interleaved. In this example, a transmitted or otherwise output codeword may be mostly interleaved, or a “mostly-partially-interleaved” codeword. At 2 above, the length-M₂ codeword includes an interleaved part of length 384, including the length-256 v-code plus the length-128 v-code of the length-M₁ codeword. Similarly, in the length-M₃ codeword, the interleaved part length is 128+256+512=896 bits and the non-interleaved part length is only 128.

Bit-reversed interleaving may be implemented with block interleaving as described above, but may instead be implemented without block interleaving in some embodiments.

Suppose that W partial code bits are to be interleaved and bit indices of those code bits in a mother polar code are denoted by i₁, i₂ . . . i_{W}. Without loss of generality, further suppose that i₁, i₂ . . . i_{W} are in ascending order. This is just an example, and partial code bits to be interleaved need not be consecutive.

In an embodiment, bit-reversed interleaving may involve writing the partial code bits into an interleaver, with bit indices i₁, i₂ . . . i_{W} in ascending order. The numbers 0, 1 . . . W−1 are associated to the partial code bits with indices i₁, i₂ . . . i_{W}, respectively. Bit-reversed values of 0, 1 . . . W−1 are then calculated or otherwise determined, as BitRev(0), BitRev(1) . . . BitRev(W−1). Interleaved partial code bits are then read out from the bit indices associated to the numbers BitRev(0), BitRev(1) . . . BitRev(W−1), in that order.

The bit-reversed value of an integer x is obtained as follows. First, the integer x is converted into binary expansion form [b₀, b₁ . . . bₙ]. Then the binary expansion is reversed to [bₙ . . . b₁, b₀], and is converted into an integer y. Bit-reversal in this example may be denoted y=BitRev(x).

Embodiments are not in any way restricted to these specific types of interleavers or interleaving, or even to one single type of interleaving. For example, different types of interleavers or interleaving may be applied to different subsets of a codeword, in an approach that may be referred to as hybrid interleaving or using a hybrid interleaver. Partial code bits that are to be interleaved may be further partitioned or divided into multiple subsets of code bits. The subsets may be separately interleaved, such as by using block interleaver(s) or interleaving for one or more subsets, and also using bit-reversed interleaver(s) or interleaving for one or more other subsets. The interleaved subsets are then concatenated together to obtain a hybrid interleaved block. Hybrid interleaving is not necessarily restricted to subdivided partial code bits, and may also or instead be applied to different subsets such as c₂ and c₁ in FIG. 23D.

Thus, interleaving of a subset of encoded bits may involve block interleaving, bit-reversed interleaving, or another type of interleaving. Where there are multiple subsets of encoded bits to be interleaved, each subset may be interleaved separately, and the separate interleaving may involve the same or different types of interleaving for different subsets. The interleaving is designed, however, to better contribute to ratelessness according to embodiments herein. Example interleaving design criteria disclosed herein include interleaving in such a way that a v-code generator matrix remains a polar generator matrix or a sequentially punctured v-code generator matrix. More generally, interleaving is designed to provide for ratelessness, and may be based on a generator matrix for a subset of encoded bits remaining as a polar generator matrix or a sequentially punctured polar code generator matrix after encoded bit reduction. In at least this sense, interleaving may be considered as being for reducing the number of encoded bits, and also based at least in part on a puncturing pattern or more generally pattern according to which encoded bits are to be reduced.

A simple and unified description method can be important for describing a code ensemble that may include thousands of (N, K) codes. In communication standards or specifications, for example, such description efficiency may be a primary concern.

Another aspect of the present disclosure relates to parameterized configuration and/or parameter-based description, which may be particularly convenient and efficient for fine-grained partial interleaving. Fine-grained partial interleaving as disclosed herein involves separately interleaved subsets of a codeword, potentially using different types of interleavers and interleaving.

For example, for parameterized configuration and/or parameter-based description of fine-grained interleaving, two parameter vectors may be sufficient to describe a wide range of partial interleaving patterns.

A subset size vector [W₁, W₂, W₃ . . . ], where each element specifies the size W of a subset to be separately interleaved, may be used to configure and/or describe subset size for separate interleaving. Subset size may be indicated or represented in any of various ways, as an absolute number of encoded bits per subset or as a relative number or measure for example. A relative number with respect to mother code length N, for example, may indicate subset size as a portion of mother code length, such as ¼ to indicate that subset size is N/4. An equivalent relative measure is the number of equal-size subset per mother codeword, in which case a value of 4, for example, also indicates a subset size of N/4.

An interleaver type or interleaving type vector [RI₁, RI₂, RI₃ . . . ], wherein each element specifies the number of rows RI of a block interleaver may also be employed in some embodiments. Special cases may be indicated by particular values of RI. For example, two special cases may be as follows: RI=1, or another special value or symbol, to indicate no interleaver or interleaving is to be applied (because a block interleaver with only one row is equivalent to not interleaving); and RI=0, or another special value or symbol, to indicate a bit-reversed interleaver or interleaving is to be applied. In the case of block interleaving, the number of columns of a block interleaver for a subset can be determined from the subset size and the number of interleaver rows.

Table 4 below provides an example of a two-vector parameter-based configuration or description format for fine-grained partial interleaving.

TABLE 4
Example Two-Vector Partial Interleaving Parameter Table

| | | | | |
|---|---|---|---|---|
| Subset size | W₁ | W₂ | W₃ | . . . |
| Interleaver type | RI₁ | RI₂ | RI₃ | . . . |

Table 5 below is populated with parameter values for an example in which a codeword is to be divided into three subsets, with lengths N/4, N/4 and N/2, respectively, and the first subset is to be interleaved by a block interleaver with 2 rows and (N/4)/2=N/8 columns, the second subset is to be interleaved by another block interleaver with 4 rows and (N/4)/4=N/16 columns, and the third subset is not to be interleaved.

TABLE 5
Example Parameters for Three-Subset Partial Interleaving

| ¼ | ¼ | ½ |
|---|---|---|
| 2 | 4 | 1 |

Table 6 below is populated with parameter values for an example in which a codeword is to be divided into four subsets, with lengths N/8, N/8, N/4 and N/2, respectively, and the first subset is not to be interleaved, the second subset is to be interleaved by a block interleaver with 8 rows, the third subset is to be interleaved by another bit-reversed interleaver, and the fourth subset is not to be interleaved.

TABLE 6
Example Parameters for Four-Subset Partial Interleaving

| ⅛ | ⅛ | ¼ | ½ |
|---|---|---|---|
| 1 | 8 | 0 | 1 |

Tables 4 to 6 are examples only. The present disclosure is not in any way limited to these particular examples.

Bit labeling, non-sequential decoding, or both, may be applied in conjunction with partial interleaving for encoded bit reduction, and/or other features disclosed herein, such as those disclosed by way of example below with reference to various illustrative embodiments.

### Illustrative Embodiment 1

An illustrative embodiment that is also referenced herein as Embodiment 1 is disclosed in the context of an example encoding chain for a (K≤M≤Nₘₐₓ, K) rateless polar code. Half-interleaving is applied as an example, and the first half of the mother codeword, indexed by [1, 2 . . . N/2], is interleaved. The second half, indexed by [N/2+1, N/2+2 . . . N], is not interleaved. The input of the interleaver is denoted [x₁, x₂ . . . x_{N/2}], where [x₁, x₂ . . . x_{N/2}] are encoded bits. The interleaving sequence is [π(1), π(2) . . . π(N/2)], and the output of the interleaver is [x_{π(1)}, x_{π(2)} . . . x_{π(N/2)}]. The interleaver is a block interleaver with S rows and N/2/S columns.

Consider an initial mother code length N=2×2^{┌log} ^{₂} ^{K┐}. Bit indices for information (or non-frozen) sets Iᵤ, I_{w}, Iᵥ and I are determined according to ordered sequences in which the bit indices are ordered based on a rank for placement of input bits, such as reliability. Such ordered sequences may be pre-defined in a communication specification or standard for example. Nested reliability ordered sequences are used in some embodiments.

In an iterative approach, the information bit set in Iᵤ may have already been determined, in which case that information bit set may be directly reused.

Placement of bit values on the N bit indices may involve bit labeling, in which bit values are assigned to labels, and the labels are each associated with one or more of the N bit indices. Each bit index may be labeled by either 0 for frozen bit indices, or {1, 2 . . . K} for information bit indices for example. Here, and elsewhere herein, bit labeling and labels represent one possible way, but not the only way, to map each bit value to one or more bit indices and place each bit value on one or more bit indices.

The K bit indices in Iᵤ may be labeled using labels {1, 2 . . . K}, or may be otherwise mapped to the bit values of the K input bits, such that the bit values of the K input bits are respectively placed on one of the K bit indices in Iᵤ.

The input bit values or labels may be placed on the bit indices in Iᵤ in ascending bit index order, for example. If K>N/2, then the first {1, 2 . . . K−N/2} bit values or labels are placed on the K−N/2 virtual information bit indices, and then the remaining {K−N/2+1, K−N/2+2 . . . K} input bit values or labels are placed on the N/2 information bit indices in Iᵤ by ascending bit index order. Ascending bit index order refers to a sequential order of bit indices in Iᵤ. In this example, negative values of virtual information bit indices as described above may be useful to ensure that the virtual information bit indices appear first in ascending bit index order, so that the first {1, 2 . . . K−N/2} bit values or labels are placed on the virtual information bit indices.

Another possible placement order according to which bit values are placed on bit indices in Iᵤ is by ascending or of rank, such as reliability order. If K>N/2, then the first {1, 2 . . . K−N/2} bit values or labels are placed on the K−N/2 virtual information bit indices, and then the remaining {K−N/2+1, K−N/2+2 . . . K} input bit values or labels are placed on the N/2 information bit indices in Iᵤ by ascending reliability order or other order of rank of bit indices in Iᵤ. In this example, negative reliability values for virtual information bit indices as described above may be useful to ensure that the virtual information bit indices appear first in ascending reliability order, so that the first {1, 2 . . . K−N/2} bit values or labels are placed on the virtual information bit indices. If a rank other than reliability is used, then rank values for the virtual information bit indices may similarly be set or determined to achieve the same relative order of virtual information bit indices, preceding other information bit indices in an ordered sequence.

These example orders illustrate how virtual information bit indices impact placement of bit values on bit indices. In these examples, if K>N/2, then the first K−N/2 bit values or labels are placed on bit indices that are not actually part of the u-code and will not be encoded. Virtual information bit indices may provide a convenient way to manage placement of bit values when a bit index segment does not include enough bit indices to accommodate all input bit values or all labels, but other options are possible. For example, the number of elements or bit indices by which K exceeds N/2 may be tracked in some other way, and the first K−N/2 bit values or labels may be skipped for placement on bit indices in Iᵤ. It should therefore be understood that virtual information bit indices may be used in some embodiments, but are not required in all embodiments.

As an example, for a length N=8, K=5 code, K>N/2 and one of the five input bit values cannot be accommodated in the u-code. Denoting the input bit values by a₁ to a₅, a₁ may be placed on a virtual information bit index (or otherwise be tracked for placed on a bit index in the v-code), and a₂ to a₅ are placed on bit indices in the u-code. If bit values are placed on bit indices in the u-code according to an order of rank that increases with increasing bit index, and bit values are placed on bit indices according to decreasing bit index order, then the final bit value placement in this example is [0, 0, 0, a₁, a₂, a₃, a₄, a₅].

In an iterative approach, bit values or labels may already have been placed on the information bit indices in Iᵤ, in which case the bit value or label placements may be directly reused.

For ease of reference, denote by I_{û} the information bit index set in the u-code that will share the same set of input bit values, and labels in some embodiments, with those in Iᵥ. I_{û} is the least reliable |Iᵥ| bit indices in Iᵤ where bit placement is based on reliability. If K>N/2, then Iᵤ also includes K−N/2 virtual information bit indices that are actually not in the u-code, if virtual bit indices are used.

I_{û}=Iᵤ\Iᵤᵥ={i: i∈Iᵤ and i≠Iᵤᵥ} is the set difference between Iᵤ and Iᵤᵥ. If K>N/2, because Iᵤ includes the virtual information bit indices and Iᵤᵥ does not include these virtual information bit indices, the K−N/2 virtual information bit indices are included in I_{û}, again if virtual information bit indices are used.

By definition |Iᵥ|=|I_{û}|=Kᵥ.

The bit indices in I_{û} and Iᵥ may be sorted in different ways. In the present Embodiment 1, the bit indices in I_{û} are sorted by ascending order of rank, such as reliability order. For ease of reference, the sorted bit indices are denoted by Í_{û}. The bit indices in Iᵥ are sorted differently, by ascending transmission order, which is based on partial interleaving. Ascending transmission order may be reverse interleaved bit index order. For ease of reference the sorted bit indices are denoted by Íᵥ, and π(Íᵥ) denotes a sequence in interleaved bit index order. In other words, π(Íᵥ) permutes or interleaves Iᵥ into Íᵥ. The bit indices in Iᵥ and Íᵥ are bit indices in the v-code, within the range {1, 2, . . . , N/2}, and π(Íᵥ) is a sequence that includes Kᵥ values. As an example, π(Íᵥ)=[3, 2, 1] permutes Iᵥ=[4, 7, 8] into Ív=[8, 7, 4].

Partial interleaving as disclosed herein refers primarily to interleaving of code bits. However, placement of bit values on bit indices also takes into account the partial interleaving that is to be applied prior to encoded bit reduction. As described at least above, in general terms, there is a relationship between bit indices of encoded bits that are punctured or otherwise reduced, in rate matching for example, and bit indices (also referred to as null bit indices) in an input vector that are most significantly impacted or affected by reducing the number of encoded bits. Similarly, a bit value on the i-th bit index in an input vector u has some effect on multiple code bits in the code vector x, but the bit value on the i-th bit index in the input vector u is the primary contributor to the value of the code bit on the corresponding i-th bit index in a code vector x. In this sense, for a polar code, input vector bit indices or bit positions may be considered to correspond to, or be associated with or related to, code vector bit indices or bit positions. This is the case for polar codes, and there may be different input/code bit correspondence, relationships, or associations for other types of codes.

This type of correspondence between encoding bit indices in an input vector and encoded bit indices in a code vector can be exploited for placement of bit values on bit indices for encoding. In Embodiment 1, the first half (v-code) of the mother codeword is interleaved, and this impacts the order in which non-punctured code bits are transmitted. Sorting the bit indices in Iᵥ in ascending transmission order as described for Embodiment 1 is dependent upon the partial interleaving, and π(Íᵥ) is used to denote a sequence that indicates interleaved bit index order.

Input bit values or labels are then placed on the bit indices in I_{w}. In a labeling embodiment, and denoting the labels in Í_{û} by L_{û}=[l₁, l₂ . . . l_{Kv}], the labels in L_{û} may be placed on the bit indices in Íᵥ. More generally, the input bit values that are placed on the bit indices in Í_{û} are also placed on the bit indices in Íᵥ, and this may involve labels in some embodiments.

The foregoing description of Embodiment 1 refers to an iterative approach, and a doubling, selection, and placement process is also referenced at least above. If N<Nₘₐₓ, then N can be set to N=2×N, and bit selection and placement as outlined above can be repeated.

After one or more iterations, when target code length Nₘₐₓ has been reached, polar encoding is performed. The last M code bits, indexed by [N−M+1, N−M+2 . . . N], are transmitted or otherwise output as a rateless codeword. Multiple transmissions or outputs of increasing code length may be made up to a maximum number of transmissions or receipt of feedback indicating correct decoding, in an IR-HARQ approach for example.

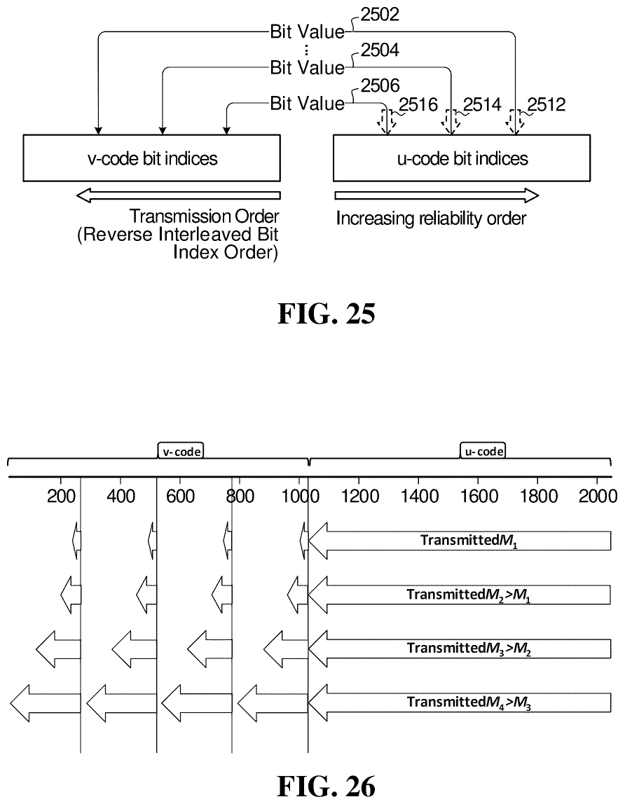

FIG. 25 is a diagram illustrating bit value placement, by using the same labels for example, on multiple bit indices including one or more of the least reliable u-code bit indices (at least three in the example shown) and one or more (at least three in the example shown) of the first bit indices in a transmission order (bit indices in reverse interleaved order) of the v-code bit indices.

Placement of bit values on multiple bit indices may be accomplished in any of various ways. For example, a bit value may be separately placed on each of multiple bit indices that are identified for placement of that bit value. Some embodiments may involve placing a bit value on one bit index and then copying the bit value to one or more other bit indices, to thereby also place that same bit value on the one or more other bit indices. For example, a bit value may be placed on a bit index in the u-code and then copied to, and thereby placed on, another bit index in the v-code. Copying in the opposite direction (from a v-code bit index to a u-code bit index) is another option.

The arrows at the top in FIG. 25 represent bit values in the u-code also being placed on bit indices in the v-code. The arrows at the top in FIG. 25 represent bit values in the u-code also being placed on bit indices in the v-code. Bit value placement is illustrated by way of example by the solid arrows 2502, 2504, 2506 as copying bit values, from u-code bit indices on which those bit values have been placed, to v-code bit indices in the v-code. The dashed arrows 2512, 2514, 2516 in combination with the solid arrows 2502, 2504, 2506 illustrate another example of bit value placement, by separately placing bit values on each of multiple bit indices, including respective bit indices in the u-code and the v-code, that are identified for placement of that bit value.

It should therefore be appreciated that the present disclosure is not limited to any particular way of placing bit values on multiple bit indices. This applies not only to Embodiment 1, but also to other embodiments herein.

To perhaps better illustrate partial interleaving according to Embodiment 1, refer again to FIG. 24 and consider an example block interleaver with S=4 rows and N/2/S=N/8 columns. The partial code bits of the interleaved subset [x₁, x₂ . . . x_{N/2}] are written row-by-row, and read out column-by-column, as [x_{π(1)}, x_{π(2)} . . . x_{(N/2)}].

The input of the interleaver is denoted, where [x₁, x₂ . . . x_{N/2}] are encoded bits. The interleaving sequence is [π(1), π(2) . . . π(N/2)], and the output of the interleaver is [x_{π(1)}, x_{π(2)} . . . x_{π(N/2)}]. The interleaver is a block interleaver with S rows and N/2/S columns.

FIG. 26 is a diagram illustrating an example of transmission order based on partial interleaving according to an embodiment that involves half-interleaving with a block interleaver that has S=4 rows. Transmitted bit positions in the original codeword (before interleaving) would be consecutive according to bit index order, and u-code and v-code bit indices in bit index order are shown at the top in FIG. 26. The four rows of arrows at the bottom of FIG. 26 indicate transmission order, and show the impact of partial interleaving on transmission (or output) order relative to the order of transmission (or output) without interleaving.

Block interleaving with a block interleaver that has S rows (4 in this example), results in the v-code in effect being divided into S segments or parts. Instead of transmitting the v-code from the last bit in the v-code to the first bit in the v-code in reverse interleaved order, transmissions start from the last bits in all S segments in the v-code, until the code bits in all S segments are transmitted. This is illustrated at the bottom in FIG. 26. As transmitted code length increases, from the length of the u-code to M₁, . . . M₄, transmission of code bits cycles sequentially through the segments, transmitting one code bit of one segment, followed by a code bit from the next segment. Each segment or part of the v-code corresponds to encoded bits in a block interleaver row, and column-by-column reading of encoded bits from the block interleaver provides this order of transmission in the present example.

In FIG. 26, K=896, M₁=1216, and Nₘₐₓ=2048. This is an illustrative and non-limiting example, which is used not only in FIG. 26 but also in other similar drawings herein.

### Illustrative Embodiment 2

Another illustrative embodiment, also referenced herein as Embodiment 2, may be substantially the same as Embodiment 1, with the exception that different partial interleaving is applied to different parts or segments. This may be referred to as, for example, segment-by-segment or segment-wise partial interleaving.

Embodiment 2 relates to cases in which several segments in a v-code are to be separately interleaved. In such cases, multiple interleavers may be used. Thus, Embodiment 2 is substantially the same as Embodiment 1 apart from the manner of partial interleaving.

Consider again the above example of a (K≤M≤Nₘₐₓ, K) rateless polar code, with half-interleaving applied to the first half of the mother codeword, indexed by [1, 2 . . . N/2] and the second half, indexed by [N/2+1, N/2+2 . . . N], not being interleaved. The interleaving input, to multiple interleavers in Embodiment 2, includes encoded bits denoted [x₁, x₂ . . . x_{N/2}].

In Embodiment 2, the interleaver input (i.e., the encoded bits to be interleaved) is divided or partitioned into D parts, each of equal size in some embodiments. The first part is [x₁, x₂ . . . x_{N/2/D}], the second part is [x_{N/2/D+1}, x_{NX/2/D+2} . . . X_{N/D}], . . . , and the last part is [x_{N/2-N/2/D+1}, x_{N/2-N/2/D+2} . . . x_{N/2}] in the case of equal-sized parts as an example. A number of equal-sized parts D that is a power of 2 may be preferred, for example, for mother code lengths that are also a power of 2.

The interleaving sequences of the D interleavers in this example may be denoted [π₁(1), π₁(2) . . . π₁(N/2/D)], [π₂(N/2/D+1), π₂(N/2/D+2) . . . λ₂(N/D)], . . . , and [π_{D}(N/2−N/2/D+1), π_{D}(N/2−N/2/D+2) . . . π_{D}(N/2)], and the output of each interleaver is, respectively, [x_{π1(1)}, x_{π(2)} . . . x_{π1(N/2/D)}], [x_{π2(N/2/D+1)}, x_{π2(N/2/D+2)} . . . x_{π2(N/D)}], . . . , and [x_{πD(N/2-N/2/D+1)}, x_{πD(N/2-N/2/D+2)} . . . x_{D(N/2)}]. Each interleaver πᵢ is a block interleaver with Sᵢ rows and N/2/Sᵢ columns, for all i∈{1, 2, . . . , D}, and Sᵢ may be different for different i in this example.

To better illustrate multi-interleaver half-interleaving, which is also illustrative of more general multi-interleaver partial interleaving, consider an example in which two different block interleavers are applied. The first block interleaver has S₁=4 rows and N/2/S₁=N/8 columns, and is applied to the first half of the v-code (code bits indexed by [1, 2 . . . N/4]). The second block interleaver has S₂=8 rows and N/2/S₂=N/16 columns, and is applied to the second half of the v-code (code bits indexed by [N/4+1, N/4+2 . . . N/2]).

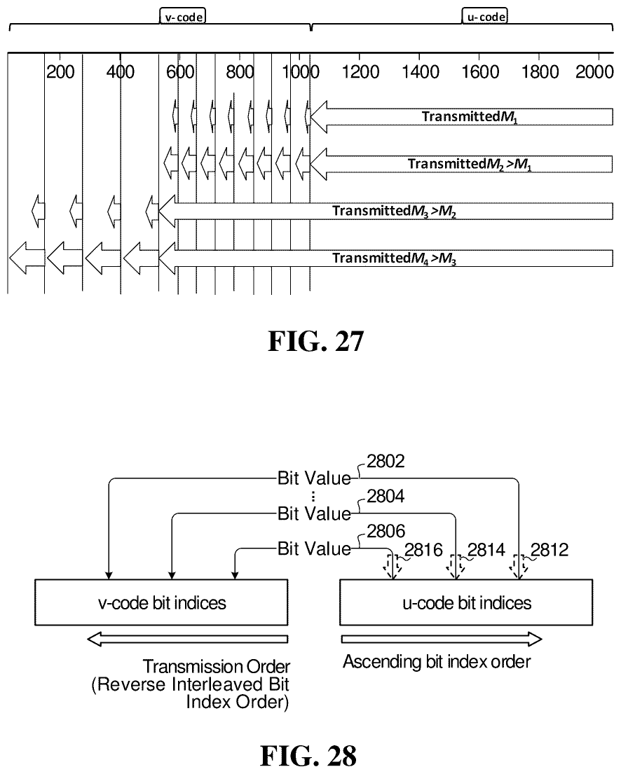

FIG. 27 is a diagram illustrating an example of transmission order based on partial interleaving according to an embodiment that involves half-interleaving with block interleaver that have S₁=4 and S₂=8 rows for two different parts of a v-code. As in FIG. 26, transmitted bit positions in the original codeword (before interleaving) would be consecutive according to bit index order, and u-code and v-code bit indices in bit index order are shown at the top in FIG. 27. The four rows of arrows at the bottom of FIG. 27 indicate transmission order, and show the impact of partial interleaving on transmission (or output) order relative to the order of transmission (or output) without interleaving.

For segment-wise block interleaving, the v-code is divided or partitioned into two parts, which are equal-sized parts in the example shown. Block interleaving of the first part of the v-code with the block interleaver that has S₁ rows (4 in this example), results in the first part of the v-code in effect being further divided into S₁ segments or parts. Similarly, block interleaving of the second part of the v-code with the block interleaver that has S₂ rows (8 in this example), results in the second part of the v-code in effect being further divided into S₂ segments or parts.

Instead of transmitting the v-code from the last bit in the v-code to the first bit in the v-code in reverse interleaved order, transmissions start from the last bits in all S₂ segments in the second part of the v-code, until the code bits in all of the S₂ segments are transmitted, and then start from the last bits in all S₁ segments in the first part of the v-code, until the code bits in all of the S₁ segments are transmitted. This is illustrated at the bottom in FIG. 27. As transmitted code length increases, from the length of the u-code to M₁ and then to M₂, transmission of code bits cycles sequentially through the S₂ segments, transmitting one code bit of one part of the second segment, followed by a code bit from the next part of the second segment, and so on until all code bits of the second segment are transmitted. Transmission of further code bits then cycles sequentially through the S₁ segments, transmitting one code bit of one part of the first segment, followed by a code bit from the next part of the first segment, and so on until all code bits of the first segment are transmitted.

For bit value placement, the example shown in FIG. 25 for Embodiment 1 also applies to Embodiment 2. The segment-by-segment interleaving according to Embodiment 2 is captured in the sorting of v-code bit indices in ascending transmission order as shown in FIG. 25.

Such segment-by-segment interleaving may enable finer granularity in interleaving, and thus finer granularity in control of encoded bit reduction and in particular the bit indices or locations from which encoded bits are reduced.

### Illustrative Embodiment 3

According to another illustrative embodiment, referenced herein as Embodiment 3, bit value placement is further developed. Examples that involve using one or multiple interleavers are provided. Embodiment 3 may otherwise be substantially the same as Embodiment 1 (for one interleaver) or Embodiment 2 (for multiple interleavers).

Placement of bit values on the N bit indices may involve bit labeling, in which bit values are assigned to labels, and the labels are each associated with one or more of the N bit indices. Each bit index may be labeled by either 0 for frozen bit indices, or {1, 2 . . . K} for information bit indices for example. Some embodiments, including Embodiment 3 and others herein, may involve check-type bit indices such as PC bit indices. Also, as described elsewhere herein, bit labeling is one illustrative example of how bit values may be placed on bit indices but not all embodiments necessarily involve bit labeling.

In Embodiment 3, the information bit index or position subset I_{û} in the u-code is sorted. Two sorting examples, denoted by LB1 and LB1g for ease of reference, are provided below.

As in Embodiment 1, I_{û} may be the least reliable |Iᵥ| bit positions in Iᵤ and if K>N/2, then I_{û} also includes K−N/2 virtual information bit indices that are actually not in the u-code, if virtual bit indices are used.

For Embodiment 3, the bit indices in I_{û} are sorted by ascending order of rank, such as reliability order. This is the above-referenced sorting example LB1. According to the above-referenced sorting example LB1g, the bit indices in I_{û} are sorted by ascending bit index order. Í_{û}, as in Embodiment 1, denotes the sorted bit indices.

The bit indices in Iᵥ are also sorted, but by ascending transmission order as in Embodiment 1.

Input bit values or labels are then placed on the bit indices in Iᵥ. In a labeling embodiment, and denoting the labels in Í_{û} by L_{û}=[l₁, l₂ . . . l_{Kv}], the labels in Lu may be placed on the bit indices in Íᵥ. More generally, the input bit values that are placed on the bit indices in Í_{û} are also placed on the bit indices in Íᵥ, and this may involve labels in some embodiments. The placement of bit values on multiple bit indices may be as in Embodiment 1 for the u-code information set sorting according to sorting example LB1, but is based on different u-code information set sorting for sorting example LB1g.

For bit value placement, the example shown in FIG. 25 for Embodiment 1 also applies to Embodiment 3 with u-code sorting according to sorting example LB1.

FIG. 28 is a diagram illustrating bit value placement, by using the same labels for example, on multiple bit indices including one or more of the lowest u-code bit indices (at least three in the example shown) and one or more (at least three in the example shown) of the first bit indices in a transmission order (bit indices in reverse interleaved order) of the v-code bit indices. As in FIG. 25, the arrows at the top in FIG. 28 represent bit values in the u-code also being placed on bit indices in the v-code, by copying bit values from u-code bit indices to v-code bit indices (the solid arrows 2802, 2804, 2806) or separately placing bit values on u-code bit indices and v-code bit indices (the dashed arrows 2812, 2814, 2816 in combination with the solid arrows 2802, 2804, 2806).

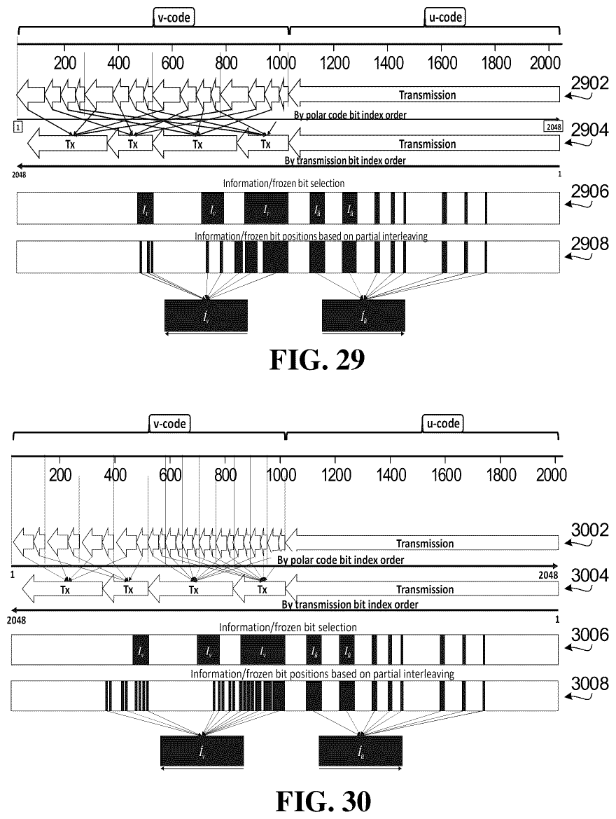

FIG. 29 is a diagram illustrating bit value placement and transmission order based on partial interleaving according to an embodiment, in which a single block interleaver with S=4 rows and N/2/S=N/8 columns is applied. Bit labeling is illustrated at the bottom in FIG. 29, and assigning the same labels for u-code information bit values to v-code bit indices is one way to place the same bit values on multiple bit indices. Copying of labels is also one example of how labels may be assigned to multiple bit indices, and labels may be copied or otherwise assigned to or placed on multiple bit indices. More generally, in FIG. 29 and other embodiments herein, one or more bit values may be placed on multiple bit indices, by using labels or not using labels, and may be copied between bit indices or otherwise placed on both bit indices.

Selection of bit indices for placement of bit values is shown at 2906, with blank parts of the row 2906 indicating frozen bit indices, and other parts indicating information bit indices. The last row 2908 indicates placement of bit values on bit indices, with the bit index order or positions in the v-code, and thus placement of bit values on v-code bit indices, being based on partial interleaving.

The upper rows 2902, 2904 in FIG. 29 illustrate output of encoded bits, by transmitting the encoded bits in the example shown. Transmitted bit positions in the original codeword (before interleaving) would be consecutive according to bit index order, and u-code and v-code bit indices in bit index order are shown at the top in FIG. 29, and also below the row 2902 with an indication of direction of ascending polar code bit index order. The rows 2902, 2904 in FIG. 29 provide different views of transmission of encoded bits. With reference to FIGS. 26 and 27, the four rows of arrows at the bottom of each of these drawings indicate transmission order, and show the impact of partial interleaving on transmission (or output) order relative to the order of transmission (or output) without interleaving. In FIG. 29, row 2902 consolidates such multiple-length outputs into a single row, to illustrate the impact of partial interleaving with a block interleaver that has S rows (4 in this example), which results in the v-code in effect being divided into S segments or parts. As in FIG. 26, instead of transmitting the v-code from the last bit in the v-code to the first bit in the v-code in reverse interleaved order (below row 2902), transmissions start from the last bits in all S segments in the v-code, until the code bits in all S segments are transmitted. As transmitted code length increases past the u-code, four times in the example shown (as illustrated by the four arrows per segment in row 2902), transmission of code bits cycles sequentially through the segments, transmitting one code bit of one segment, followed by a code bit from the next segment.

Another view of encoded bit output, by transmission in this example, is provided by row 2904 in FIG. 29. The four arrows to the left in row 2904 represent four increases in transmitted code length past the u-code, and transmission of code bits cycling through the segments as transmitted code length increases.

Below row 2904, FIG. 29 illustrates transmission bit index order, to further indicate how transmission proceeds from the u-code through parts of each segment of the v-code as transmitted code length increases.

FIG. 30 is a diagram illustrating bit value placement and transmission order based on partial interleaving according to another embodiment, in which partial interleaving uses two block interleavers. The first interleaver has S₁=4 rows and N/2/S₁=N/8 columns and is applied to the first half of the v-code, and the second block interleaver has S₂=8 rows and N/2/S₂=N/16 columns and is applied to the second half of the v-code. As in FIG. 29, bit labeling is illustrated at the bottom in FIG. 30, and assigning the same labels for u-code information bit values to v-code bit indices is shown as an example of how the same bit values may be placed on multiple bit indices.

Selection of bit indices for placement of bit values is shown at 3006, with blank parts of the row 3006 indicating frozen bit indices, and other parts indicating information bit indices. The last row 3008 indicates placement of bit values on bit indices, with the bit index order or positions in the v-code, and thus placement of bit values on v-code bit indices, being based on partial interleaving.

The upper rows 3002, 3004 in FIG. 30 illustrate output of encoded bits, by transmitting the encoded bits in the example shown. Transmitted bit positions in the original codeword (before interleaving) would be consecutive according to bit index order, and u-code and v-code bit indices in bit index order are shown at the top in FIG. 30, and also below the row 3002 with an indication of direction of ascending polar code bit index order. The rows 3002, 3004 in FIG. 30 provide different views of transmission of encoded bits, similar to those in FIG. 29. In FIG. 30, row 3002 illustrates the impact of partial interleaving with two block interleavers that have S₁=4 and S₂=8 rows. In effect, the result of interleaving is that the v-code is divided or partitioned into two parts, which are equal-sized parts in the example shown. Block interleaving of the first part of the v-code with the block interleaver that has S₁ rows (4 in this example), results in the first part of the v-code in effect being further divided into S₁ segments or parts. Similarly, block interleaving of the second part of the v-code with the block interleaver that has S₂ rows (8 in this example), results in the second part of the v-code in effect being further divided into S₂ segments or parts.

As in FIG. 27, instead of transmitting the v-code from the last bit in the v-code to the first bit in the v-code in reverse interleaved order (below row 3002), transmissions start from the last bits in all S₂ segments in the second part of the v-code, until the code bits in all of the S₂ segments are transmitted, and then start from the last bits in all S₁ segments in the first part of the v-code, until the code bits in all of the S₁ segments are transmitted. As transmitted code length increases past the u-code, transmission of code bits cycles sequentially through the S₂ segments, transmitting one code bit of one part of the second segment, followed by a code bit from the next part of the second segment, and so on until all code bits of the second segment are transmitted. Transmission of further code bits then cycles sequentially through the S₁ segments, transmitting one code bit of one part of the first segment, followed by a code bit from the next part of the first segment, and so on until all code bits of the first segment are transmitted.

Another view of encoded bit output, by transmission in this example, is provided by row 3004 in FIG. 30. The four arrows to the left in row 3004 represent four increases in transmitted code length past the u-code, and transmission of code bits cycling through the segments of the first part of the v-code and then through the segments of the second part of the v-code as transmitted code length increases.

Below row 3004, FIG. 30 illustrates transmission bit index order, to further indicate how transmission proceeds from the u-code through parts of each segment of the v-code as transmitted code length increases.

### Illustrative Embodiment 4

Another illustrative embodiment is referenced herein as Embodiment 4, and involves additionally freezing one or more information bit indices in the v-code into frozen bit indices. In this way, the code rate of the v-code can be reduced.

Such code rate reduction may be referred to herein as partial code rate reduction and can be provided, for example, by reducing the code rate of the v-code in a segment-by-segment manner, similar to Embodiment 2 but with fewer u-code bit values also placed on bit indices for the v-code.

Reducing partial code rate as disclosed herein can help provide smoother coding gain as the code length M of the rateless code increases, in the sense that reducing the code rate of the v-code results in smaller changes in code rate as M increases. This type of smoother coding gain can be helpful in avoiding significant performance loss for at least some M.

For segment-by-segment or segment-wise code rate reduction, I_{û} again denotes the information bit index set in the u-code that will share the same set of input bit values, and labels in some embodiments, with a reduced information set in Iᵥ.

Placement of bit values on the N bit indices may involve bit labeling, in which bit values are assigned to labels, and the labels are each associated with one or more of the N bit indices. Each bit index may be labeled by either 0 for frozen bit indices, or {1, 2 . . . K} for information bit indices for example. Here, and elsewhere herein, bit labeling and labels represent one possible way, but not the only way, to map each bit value to one or more bit indices and place each bit value on one or more bit indices.

The information bit position set Iᵥ in the v-code is sorted by ascending transmission order, as in Embodiment 3 for example. As above, π(Iᵥ) denotes a sequence according to which the information bit indices in Iᵥ are permuted for interleaving, and sorted bit indices in Íᵥ may be obtained, for example, by reversing π(Iᵥ), to read out from the last to the first to obtain transmission order.

To reduce the size of the sorted information set Íᵥ in the v-code, the bit indices in Iᵥ are split into S segments, subblocks, or parts (e.g., S=4) according to their bit positions in the interleaved v-code. The S segments may be but need not necessarily be equal-sized, with bit position sets Jᵥ₁, Jᵥ₂, . . . J_{vB}. These segments can have power of 2 sizes, which may be particularly preferred for embodiments with mother code lengths that are power of 2.

The same number S of segments of Íᵥ are obtained as intersections with the S segments of Iᵥ, in a reverse or opposite order from the S-th segment to the first segment and similarly between other segments. The S segments of Íᵥ and the set intersections upon which they are based may be expressed as follows: Íᵥ₁=Íᵥ∩J_{vS}, Íᵥ₂=Íᵥ∩J_{v(S-1)}, . . . , Í_{vSB-1})=Íᵥ∩Jᵥ₂, Í_{vS}=Íᵥ∩Jᵥ₁. The order in each segment in Íᵥ remains the same as in Íᵥ (they are interleaved).

Segment-by-segment code rate reduction may involve respective code rate reduction ratios for the S segments of Íᵥ, denoted α₁, α₂, . . . , α_{S} for ease of reference. The number of information bit indices in Íᵥ₁, Íᵥ₂, . . . , Í_{vS} are Kᵥ₁, Kᵥ₂, . . . , K_{vS}, respectively, and the α₁·Kᵥ₁, α₂·Kᵥ₂, . . . , α_{S}·K_{vS} highest rank (most reliable, for example) bit indices in Íᵥ₁, Íᵥ₂, . . . , Í_{vS}, respectively, are the reduced information subsets in Íᵥ₁, Íᵥ₂, . . . , Í_{vS}. The reduced information subsets are denoted by Íᵥ₁, Íᵥ₂, . . . , Í_{vS}, respectively. Rounding, flooring, or ceiling, for example, may be applied to α₁·Kᵥ₁, α₂·Kᵥ₂, . . . , α_{S}·K_{vS} to obtain an integer number of bit indices for each reduced information subset.

The respective code rate reduction ratios for the segments may be the same or different. The code rate reduction ratio for one segment may be the same as the code rate reduction ratio for one or more other segments, or different from those for all other segments. All code rate reduction ratios for all segments could potentially be the same, in which case partial code rate reduction could be considered as being based on a code rate reduction ratio in the sense that the same code rate reduction ratio is applied to all segments.

The union set I′ᵥ≙I′ᵥ₁∪I′ᵥ₂∪ . . . ∪I′_{vS}, where the order remains the same as in Íᵥ.

Regarding the u-code, an information bit index or position subset I′_{û} in the u-code is also sorted. Two sorting examples, denoted by LB2 and LB2g for ease of reference, are provided below.

I′_{û} may be the lowest rank (least reliable, for example) |I′ᵥ| bit indices in Iᵤ for example. If K>N/2, then I′_{û} also includes K−N/2 virtual information bit indices that are actually not in the u-code, if virtual bit indices are used.

For Embodiment 4, the bit indices in I′_{û} may be sorted by ascending order of rank, such as reliability order. This is the above-referenced sorting example LB2. According to the above-referenced sorting example LB2g, the bit indices in I′_{û} are sorted by ascending bit index order. Í′_{û} denotes the sorted bit indices.

By definition |I′ᵥ|=|Í′_{û}|=α₁·Kᵥ₁+α₂·Kᵥ₂+ . . . +α_{S}·K_{vS}=K′ᵥ.

Input bit values or labels are then placed on the bit indices in I′ᵥ. In a labeling embodiment, and denoting the labels in Í′_{û} by L_{û}=[l₁, l₂ . . . l_{Kv}], the labels in Lu may be placed on the bit indices in I′ᵥ. More generally, the input bit values that are placed on the bit indices in Í′_{û} are also placed on the bit indices in I′ᵥ, and this may involve labels in some embodiments.

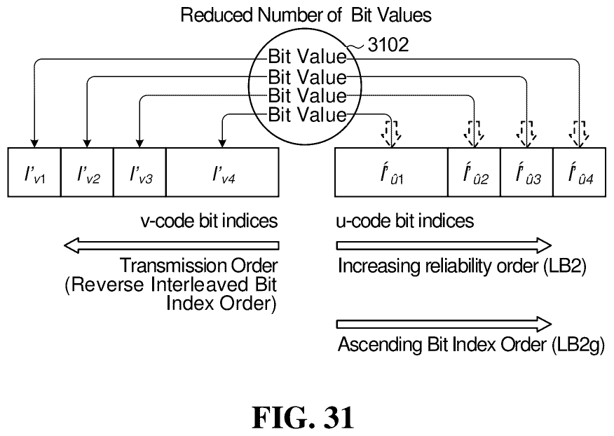

The overall result of segment-by-segment code rate reduction is the same as that of code rate reduction for the v-code as a whole, in respect of fewer u-code bit indices sharing the same bit values with v-code bit indices. FIG. 31 is a diagram illustrating bit value placement on multiple bit indices according to a segment-by-segment reduced code rate embodiment. The solid and dashed arrows at the top of FIG. 31 illustrate bit value placement on multiple bit indices, by copying bit values from u-code bit indices to v-code bit indices (the solid arrows) or separately placing bit values on u-code bit indices and v-code bit indices (the dashed arrows in combination with the solid arrows). Reference numbers for the arrows are not shown in FIG. 31 in order to help avoid further congestion in the drawing. The top label and circle 3102 in FIG. 31 indicate a reduced number of input bit values, relative to other embodiments, shared between u-code and v-code bit indices, or in other words a reduced number of input bit values placed on bit indices in both the u-code and the v-code. The v-code may include additionally frozen bits resulting from fewer information bit indices in the v-code to provide code rate reduction.

As shown, the u-code sort order in FIG. 31 may be ascending order of rank shown by way of example as reliability, which is the above-referenced sorting example LB2, or ascending bit index order, which is the above-referenced sorting example LB2g.

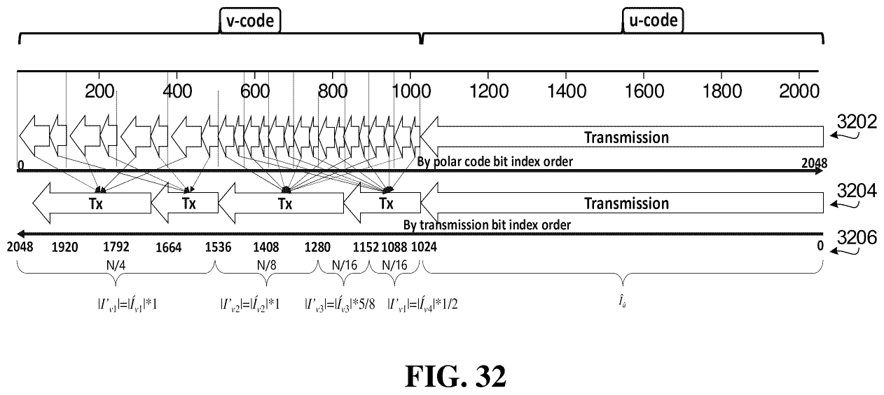

FIG. 32 is a diagram illustrating bit value placement and transmission order based on partial interleaving according to segment-by-segment reduced code rate embodiment, in which partial interleaving uses two block interleavers. The first interleaver has S₁=4 rows and N/2/S₁=N/8 columns and is applied to the first half of the v-code, and the second block interleaver has S₂=8 rows and N/2/S₂=N/16 columns and is applied to the second half of the v-code. The interleaved v-code is divided into 4 segments, of sizes N/4, N/8, N/16, N/16, respectively, and their code rate reduction ratios are 1, 1, ⅝, ½, respectively. This is shown at 3206.

Partitioning for the v-code is performed on the interleaved v-code, rather than the original v-code. Segments may be of the same size, different sizes, or a combination as shown. Similarly, code rate reduction ratios may be the same for all segments, different for each segment, or the same for some segments and different for one or more other segments.

The upper rows 3202, 3204 in FIG. 32 illustrate output of encoded bits, by transmitting the encoded bits in the example shown. Transmitted bit positions in the original codeword (before interleaving) would be consecutive according to bit index order, and u-code and v-code bit indices in bit index order are shown at the top in FIG. 32, and also below the row 3202 with an indication of direction of ascending polar code bit index order. The rows 3202, 3204 in FIG. 32 provide different views of transmission of encoded bits, similar to those in FIG. 30. In FIG. 32, row 3202 illustrates the impact of partial interleaving with two block interleavers that have S₁=4 and S₂=8 rows, in particular that the v-code is in effect divided or partitioned into two parts, which are equal-sized parts in the example shown. Block interleaving of the first part of the v-code with the block interleaver that has S₁ rows (4 in this example), results in the first part of the v-code in effect being further divided into S₁ segments or parts. Similarly, block interleaving of the second part of the v-code with the block interleaver that has S₂ rows (8 in this example), results in the second part of the v-code in effect being further divided into S₂ segments or parts.

Transmission in the example shown in FIG. 32 is substantially the same as in FIG. 30, with the difference being transmission of fewer encoded bits corresponding to information bits as a result of code rate reduction in FIG. 32.

### Illustrative Embodiment 5

Embodiment 3 and Embodiment 4 encompass four approaches to bit value placement, which may be applied to bit labeling or more generally to placing bit values on bit indices. The first two involve sorting options referenced above as LB1 and LB1g, and may be considered examples of “single segment mapping”, whereas the next two involve sorting options referenced above as LB2 and LB2g, and may be considered examples of “multiple segment mapping”. These approaches are further explored and developed in yet another illustrative embodiment that is referenced herein as Embodiment 5.

As described at least above, the single segment mapping sort options LB1 and LB1g are as follows:
(LB1) sort I_{û} by ascending reliability order, and Iᵥ is sorted by ascending transmission order;
(LB1g) sort I_{û} by ascending bit index order, and I, is sorted by ascending transmission order,
and the multiple segment mapping sort options LB2 and LB2g are as follows:
(LB2) sort I′_{û} by ascending reliability order, and I, is sorted by ascending transmission order, segmented, and used in obtaining the reduced v-code information set I′ᵥ, which includes I′ᵥ₁, I′ᵥ₂, . . . , I′_{vS};
(LB2) sort I′_{û} by ascending bit index order, and Iᵥ is sorted by ascending transmission order, segmented, and used in obtaining the reduced v-code information set I′ᵥ, which includes I′ᵥ₁, I′ᵥ₂, . . . , I′_{vS}.

Single segment mapping or multiple segment mapping may be preferred in different embodiments, depending on one or more criteria such as either or both of code length and code rate of a current mother code.

The following examples illustrate possible criteria for selection between single segment mapping or multiple segment mapping. Other criteria may also or instead be used.

If the mother code length N≥512, then adopt multiple segment mapping, because for higher mother code lengths or longer codes, finer segmentation with different mapping may help better match segment-wise code rate with capacity. This can lead to better performance when transmitted or otherwise output code length is close to but greater than N/2, such as N/2 plus 20% for example.

If the mother code rate K/N>⅜, then adopt multiple segment mapping, because when mother code rate is high, the gap between segment-wise code rate and capacity is larger, and bit value placement based on multiple segments may be useful to narrow this gap and thereby lead to better performance for at least certain code lengths. Performance may be improved for transmitted or otherwise output code lengths close to but greater than N/2, such as N/2 plus 20% in an example above.

If the mother code length N≤128, and mother code rate K/N≤⅜, then adopt single segment mapping, because for shorter mother code lengths and mother code rate is low, single segment mapping may be sufficient in closing the gap between segment-wise code rate and capacity, again potentially leading to better performance for at least certain code lengths such as for transmitted or otherwise output code length of N/2 plus 20% in an example above, or more generally close to but greater than N/2.

If the mother code length N≥256, and the mother code rate K/N≤⅜, then adopt multiple segment mapping with subblock-wise rate reduced bit labeling, because for higher mother code lengths, finer segmentation with different mapping may be useful when the mother code rate is low. Moreover, subblock-wise reduced code rate bit labeling may be useful in closing the gap between segment-wise code rate and capacity in certain subblocks. This can lead to better performance at least for certain code lengths, such as when transmitted or otherwise output code length is close to but greater than N/2, which is N/2 plus 20% in an example above.

FIGS. 25 and 28 illustrate single segment mapping, which relates to placement of bit values on both u-code and v-code bit indices without partitioning of the u-code and v-code into segments. FIG. 32 illustrates multiple segment mapping, which relates to placement of bit values on both u-code and v-code bit indices based on segments.

### Illustrative Embodiment 6

In general, there may be a preference for rateless polar (RP) codes that can be described by very simple parameterized descriptions in a communication standard or specification may standard. This is the focus of an illustrative embodiment that is referenced herein as Embodiment 6.

Block interleaver parameters, for example, may be represented by SX, where X is the number of rows in the block interleaver. When there are multiple block interleavers, the parameters may be concatenated as SX-SY-SZ . . . , where Y and Z are also number of rows in the block interleavers. For example, in this type of representation, S4-S8 means there are two block interleavers, the first having 4 rows and the second having 8 rows. Other options for parameterized configuration and/or parameter-based description of interleaving are also provided elsewhere herein, such as in Tables 4 to 6 above.

Bit value placement, by bit labeling or otherwise, may be simply represented by name, such as LB1, LB1g, LB2, LB2g related to four sort option examples above.

Segment-wise rate reduction parameters can be represented by two vectors in some embodiments, with the first indicating segment size as an absolute number or as a relative number with respect to the v-code length for example, and the second indicating the rate reduction ratio of a corresponding segment. For example, [½, ¼, ⅛, ⅛; 1, 1, ⅝, ½] may be used to specify that four subblocks in interleaved v-code have length ½×N/2, ¼×N/2, ⅛×N/2, ⅛×N/2, and their corresponding code rate reduction ratios are 1, 1, ⅝, ½, respectively.

The following is an example rateless polar code description, which includes the above parameters concatenated to become: RP-S4-S8-LB2-[½, ¼, ⅛, ⅛; 1, 1, ⅝, ½]. This is consistent with the example shown in FIG. 32, which relates to rateless polar (RP) coding, two block interleavers including a first interleaver with 4 rows and a second interleaver with 8 rows (S4-S8), LB2 multiple segment mapping may be applied because mother code length N ≥512 in accordance with an example selection criterion provided above, segment sizes are as indicated (½×N/2 (=N/4), ¼×N/2 (=N/8), ⅛×N/2 (=N/16), ⅛×N/2 (=N/16)), and code rate reduction ratios are also as indicated (1, 1, ⅝, ½).

Table 7 below is an example parameter table to specify code construction, including code type, interleaving, bit value placement, segmentation, and rate reduction. The notation ½˜¼ for code rate means that the u-code rate is ½ and the mother code rate is ¼, and the notation 256˜512 for code length means the u-code length is 256 and the mother code length is 512.

TABLE 7
Example Code Construction Parameter Table

| Code | Code Rate | | | | |
|---|---|---|---|---|---|
| Length | ¼~⅛ | ½~¼ | ¾~⅜ | ⅚~ 5/12 | ⅞~ 7/16 |
| 128~256 | S8-LB1 | S8-LB1 | S4-LB1 | S8-S8- | S8-S8- |
| | | | | LB1 | LB1 |
| 256~512 | S8-LB1 | S4-S16-LB2g- | S4-S16-LB2- | S16-S16- | S16-S16- |
| | | [½, ½; 1, ⅘] | [½, ½; 1, ⅞] | LB1 | LB1 |
| 512~1024 | S16-S16-LB2g- | S4-S16-LB2g- | S4-S16-LB2- | S16-S16- | S16-S16- |
| | [½, ¼, ⅛, ⅛; | [½, ½; 1, ⅘] | [½, ½; 1, ⅞] | LB1 | LB1 |
| | 1, 1, ⅝, ⅔] | | | | |
| 1024~2048 | S16-S16-LB2g- | S16-S16-LB1g- | S4-S16-LB2- | S16-S32- | S16-S32- |
| | [½, ¼, ⅛, ⅛; | [1; ⅘] | [½, ½; 1, ⅞] | LB1 | LB1 |
| | 1, 1, ⅝, ½] | | | | |

Table 7 and other parameter examples herein are illustrative, and the present disclosure is not in any way limited to such parameters or the particular example representations or descriptions herein. More generally, any one or more of interleaving, bit value placement, segmentation, and rate reduction may be based on or dependent upon, for example, code length, code rate, or both code length and code rate.

### Illustrative Embodiment 7

A primary focus of another illustrative embodiment that is referenced herein as Embodiment 7 is simplified decoding scheduling and representation.

A length-M scheduling sequence (or simplified sequence) may be used to specify scheduled decoding of each (M, K) code. In the case of wireless communications, there are thousands of (M, K) codes, making it impractical to store a scheduling sequence for each code (thousands of scheduling sequences in total).

Embodiment 6 proposes to use only one single number to specify a decoding starting point as a way to describe the entirety of decoding scheduling. This means that there is no need to store a scheduling sequence for each (K≤M≤Nₘₐₓ, K) code.

Consider simplified scheduled decoding based on starting point. Encoded bit indices may be sorted by ascending transmission order (the bit index order after partial interleaving). For ease of reference, o₀=N/2 denotes the first bit index of a u-code and oᵢ denotes the first bit index of the v₁-code, which is the i-th subcode of the v-code and has a length of a power of 2. The number of subcodes in a v-code may be pre-defined, for example.

Starting from any bit position (starting point) o=o₀, o₁, o₂, o₃ . . . , options for scheduled decoding include the two options described below. Other options may also or instead be assessed, but in some embodiments the following options are assessed in order to reduce search space and complexity of determining decoding scheduling.

A first option, referenced herein as Option a and denoted by o-a, involves the following:
1. Start sequential decoding from the o-th bit;
2. Upon decoding a j-th bit (as an information bit) in the u-code, if there is an i-th bit in the v-code that has the same bit value, or the same label (i.e., lᵢ=lⱼ) in some embodiments, then decode (as a PC-frozen bit) the i-th bit immediately after the j-th bit. After having decoded the i-th bit, continue to decode the subsequent information bits in the u-code.
3. The i↔j bit pair may be referred to as an information-PC bit pair. Decoding switches between sequential decoding in u-code and decoding in v-code when decoding information-PC bit pairs.
4. Decoding returns to sequential decoding of the u-code until all PC bits have been decoded in the v-code, and finally any remaining information bits in the u-code are sequentially decoded.

Option a may be summarized as decoding information bits in a u-code, in the hope that the corresponding PC bits in a v-code will be decodable as PC-frozen bits. Therefore, the v-code rate is, in effect, reduced and can be decoded at some point.

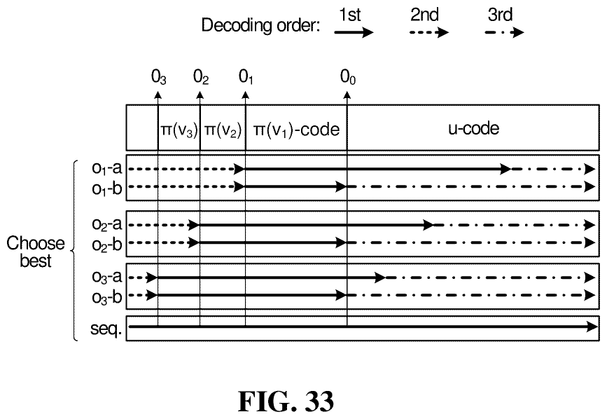

FIG. 33 illustrates decoding options based on three different starting points, and Option a is shown at the top of each of the first three rows. The decoding orders as shown for Option a and the three starting points in FIG. 33 are consistent with the description of Option a above. Decoding starts from the starting point (indicated by “1st” in the drawing), switches to PC-frozen decoding of PC bits in the v-code as u-code information bits are decoded (indicated by “2nd” in the drawing), and finally decoding switches to completion of u-code decoding after v-code information bits have been decoded (indicated by “3rd” in the drawing).

A second option, referenced herein as Option b and denoted by o-b, involves the following:
1. Start sequential decoding from the o-th bit;
2. Until all bits with bit index 0≤i<o₀ in the interleaved v-code have been sequentially decoded, the remaining bits with index s<i<0 in the interleaved v-code, where s is the first non-punctured bit position, are sequentially decoded.
3. After all bits in the v-code have been decoded, decoding switches to sequential decoding of the u-code.

Option b may be summarized as a more aggressive decoding approach than Option 1. Option b does not decode u-code first, and thus v-code decoding is not assisted by PC-frozen decoding based on u-code decoding. However, decoding the latter part of the v-code may help decoding of the front part of the v-code, which may be sufficient for decoding the entire v-code without first decoding any u-code information bits.

In FIG. 33, Option b is shown at the bottom of each of the first three rows, for three different starting points. The decoding orders as shown for Option b are consistent with the description of Option b above. Decoding starts from the starting point in the v-code and continues to decode all bits with bit index 0≤i<o₀ (indicated by “1st” in the drawing), then switches to decoding of remaining bits with index s<i<0 in the interleaved v-code (indicated by “2nd” in the drawing, where s is at the left end of each row), and then finally switches to u-code decoding after v-code information bits have been decoded (indicated by “3rd” in the drawing).

In addition to Option a and Option b above, FIG. 33 also illustrates conventional sequential decoding.

Selection between decoding options may be based on one or more criteria conditions such as block error rate (BLER). BLER is one example of a criterion or condition for opportunistically determining which of several decoding options to use in decoding encoded bits. In an embodiment, the decoding options include Option a and Option b above, and potentially sequential decoding. BLER is one example, and other decoding performance criteria or conditions may be used, instead of or in addition to BLER, as basis for selecting or determining a best decoding option.

In some embodiments, the starting points can be chosen from 0∈[N/2, N· 17/32, N· 9/16, N·⅝, N· 11/16, N·¾, N· 13/16, N·⅞, N· 15/16, N]. Selection of a starting point may be simplified, for example, by searching only a number of nearest starting points, such as the three nearest starting points with 0≤M, trying the two options (a, b), and choosing the best scheduling. To specify a decoding scheduling in Embodiment 7, only the starting point and the option, such as o-a or o-b, are needed and may be stored.

In the context of the RP-S4-S8-LB2-[½, ¼, ⅛, ⅛; 1, 1, ⅝, ½] code of mother code length N=2048, described in Embodiment 6, the starting points are chosen from 0∈[1024, 1088, 1152, 1280, 1408, 1536, 1664, 1792, 1920, 2048].

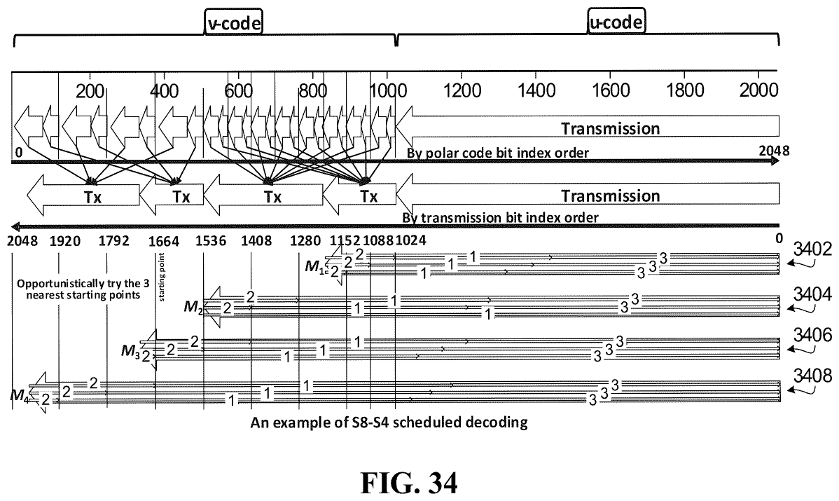

FIG. 34 illustrates decoding options based on starting points for four different transmitted code lengths. Transmissions are shown at the top in FIG. 34 in the same way as in FIG. 32 and other similar drawings. At 3402, 3404, 3406, 3408, FIG. 34 illustrates that, for each of the four code lengths, M₁, M₂, M₃, M₄, three nearest starting points are tried to find the best decoding scheduling. Taking M₁ as an example, each of 1024, 1088, and 1152 is used as a starting point, and sequential decoding proceeds to the right from each of these starting points (indicated by “1”), with PC-frozen v-code decoding based on u-code decoding (indicated by “2”), and finally remaining u-code decoding (indicated by “3”). The three nearest starting points and Option a decoding are also shown for each of the other example transmitted code lengths at 3404, 3406, 3408.

### Overview

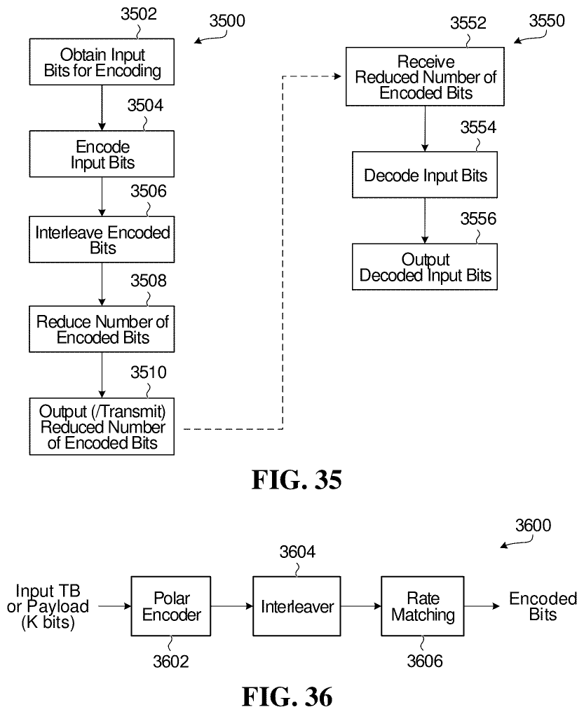

Various aspects of the present disclosure are described herein and shown in the drawings by way of example. FIG. 35 is a flow diagram illustrating more general example methods according to embodiments. At the left, 3500 in FIG. 35 illustrates operations or features that may be provided or supported at an encoder or transmitter-side device, and at the right, 3550 illustrates operations or features that may be provided or supported at a decoder or receiver-side device. For ease of reference, in the following description of FIG. 35, a device at which encoding and/or transmitting features may be implemented or supported is called a first communication device, and a device at which decoding and/or receiving features may be implemented or supported is called a second communication device. Embodiments may involve either or both of such devices.

With reference first to 3500, from a transmitting device perspective the outputting of encoded bits at 3510 may involve transmitting the encoded bits. Encoded bits may be output through or via any of various types of interface, including a communication interface in the case of transmitting the encoded bits. Embodiments are not in any way restricted to any particular type of interface. The encoded bits may be transmitted at 3510 by a first communication device to a second communication device in a wireless communication network, for example.

The encoded bits are obtained by encoding input bits by a polar code at 3504, and may be referred to as encoded bits encoded by the polar code. Encoding at 3504 may be implemented or performed by an encoder or a processor, for example, and outputting the encoded bits at 3510 need not necessarily involve transmission of the encoded bits. The encoded bits may be output at 3510 for storage to memory for example, and/or transmission.

A polar code comprises or provides bit indices for placing bit values before encoding. The bit indices include a first set of bit indices for placing values of input bits, and a second set of bit indices for placing a predetermined bit value. The first set of bit indices includes a first subset of bit indices and a second subset of bit indices.

Regarding the first set and the second set of bit indices, an information set including bit indices for placement of input bit values is an example of the first set, and a frozen set including bit indices for placement of a predetermined frozen bit value is an example of the second set. A subset including information bit indices in the u-code, denoted Iᵤ herein (but not including any virtual information bits that may be used in some embodiments), is an example of the first subset, and a subset including information bit indices in the v-code, denoted I, herein, is an example of the second subset. In one u-code and v-code embodiment, with a total number of the bit indices denoted N, the first subset of bit indices may be in an upper set of N/2 bit indices that includes (N/2+1)-th to N-th bit indices of the N bit indices, and the second subset of bit indices may be in a lower set of N/2 bit indices that includes first to (N/2)-th bit indices of the N bit indices. This is an example only, and embodiments are not limited to an upper set and a lower set of half the bit indices. For example, there can be multiple upper sets and lower sets as code length is recursively extended or increased as described by way of example at least above.

Embodiments herein involve partial interleaving. The interleaving at 3506 in FIG. 35 involves interleaving a subset of the encoded bits obtained at 3504. The subset of encoded bits that is interleaved ang 3506 corresponds to the second subset of bit indices, which is for reducing the number of the encoded bits at 3508 in FIG. 35. Encoded bits corresponding to the second subset of bit indices may be reduced at 3508, and as disclosed herein interleaving is applied to those encoded bits and not to all encoded bits. The outputting at 3510 involves outputting a reduced number of the interleaved encoded bits corresponding to the second subset of bit indices.

Values of the input bits include an input bit value that is placed on both a first bit index in the first subset and a second bit index in the second subset. The second bit index is based, at least in part, on the interleaving. Placement of bit values on bit indices is not separately shown in FIG. 35, and may be part of the encoding at 3506 in some embodiments. Although reference is made here to an input bit value that is placed on both a first bit index in the first subset (e.g., a u-code information bit index) and a second bit index in the second subject (e.g., a v-code information bit index), embodiments may involve placing one, or more than one, bit value on multiple bit indices.

Another operation that may be involved in a method according to some embodiments is illustrated at 3502. Obtaining input bits for encoding may involve, for example, collecting or otherwise receiving data outputs from one or more devices and/or services, or accessing data in a memory.

Embodiments may include any or all of the operations illustrated at 3500. For example, in some embodiments, a method may involve encoding as shown at 3504, interleaving as shown at 3506, reducing the number of encoded bits as shown at 3508, and transmitting or otherwise outputting encoded bits at 3510. Other embodiments may involve transmitting or otherwise outputting, at 3510, encoded bits that have already been obtained by encoding input bits by a polar code. Such embodiments are not mutually exclusive, and methods may involve the obtaining at 3502, the encoding at 3504, the interleaving at 3506, and the reducing at 3508, and also the outputting at 3510.

Features may be implemented in any of various ways, and/or other features may also or instead be provided or supported.

For example, there may be more than one output of encoded at 3510. In some embodiments, the outputting at 3510 may involve outputting different numbers of encoded bits in multiple outputs. A first output may include a first number of encoded bits, and additional encoded bits may subsequently be output.

Consider an embodiment that involves transmitting the reduced number of interleaved encoded bits from a first communication device to a second communication device in a wireless communication network, for example. The reduced number of interleaved encoded bits may include a first reduced number of the interleaved encoded bits. In another transmission, or more generally in another output, one or more additional encoded bits may be transmitted or otherwise output. According to an IR-HARQ approach, if the transmitted bits are not successfully decoded, then one or more additional encoded bits may be transmitted, in each of one or more incremental transmissions. Some embodiments may involve further transmitting (or otherwise outputting) in an incremental transmission from the first communication device to the second communication device in the example above (or in an incremental output), a second reduced number of the interleaved encoded bits corresponding to the second subset of bit indices. This second reduced number of the interleaved encoded bits includes one or more one or more of the interleaved encoded bits not included in the first number of the interleaved encoded bits. There may be more than one incremental transmission (or output) of the same number or different numbers of additional encoded bits. An incremental transmission or output includes one or more encoded bits that were not previously transmitted or output, but may also include previously transmitted or output bits as well.

In some embodiments, bit number reduction at 3508 may be repeated to reduce fewer encoded bits for transmission or output at 3510. For each incremental transmission or output, for example, one or more previously punctured or otherwise reduced encoded bits are no longer punctured or otherwise reduced. In other embodiments, no such repetition is necessary, and additional transmissions or outputs involve transmitting or outputting more and more encoded bits that were not previously transmitted or output.

Outputting at 3510 may involve transmitting in some embodiments, or outputting and transmitting features may be implemented separately, by an encoder and a transmitter for example.

As disclosed herein, one or more bit values may be placed on multiple bit indices. In the context of a bit value being placed on both a first bit index and a second bit index consistent with an example above, as noted above the second bit index is based on the interleaving. The first bit index, in the above-referenced first subset of bit indices, may be based on a sort order such as an ascending order of rank, consistent with Embodiment 1 for example. In such an embodiment, the first bit index is based on an ascending order of rank associated with the first set of bit indices, and the second bit index is based on an interleaved order of the encoded bits. With reference to FIG. 25, for example, the ascending order of rank is associated with the u-code bit indices and the rank is shown by way of example as reliability.

The sort order may or may not be applied only to bit indices in the first subset. For example, some embodiments may involve virtual information bits to track input bit values that cannot be placed on bit indices in the first subset, where K>N/2 as described by way of example at least above. The sort order may also be applied to bit indices and ranks that are assigned to any virtual information bits, for example. If input bit values that cannot be placed on bit indices in the first subset are tracked in some other way, then the sort order, or more generally placement of bit values on the bit indices in the second subset in encoding at 3504, for example, may take those non-placed input bit values into account. These are examples of how input bit values that cannot be placed on bit indices in the first subset may be given preference or priority for placement on bit indices in the second subset.

The sort order may be applied to all bit indices in a set or subset, or only to some of those bit indices. For example, the sort order may be applied to the bit indices in the first subset on which bit values that are also to be placed on bit indices in the second subset are to be placed, denoted I_{û} herein. For placement of bit values on multiple bit indices, it is possible that only these bit indices in the first subset are sorted according to the sort order.

References to sort orders associated with or applied to bit indices in sets, subsets, or segments of bit indices should be interpreted accordingly. Such sort orders may include other bit indices (for virtual information bits for example), and/or need not necessarily be applied to entire sets, subsets, or segments.

Another example of a sort order upon which the first bit index may be based is an ascending bit index order associated with the first set of bit indices, as shown by way of example in FIG. 28, with the second bit index being based on an interleaved order of the encoded bits.

In some embodiments, the subset of the encoded bits to which interleaving is applied is one of multiple unique subsets of the encoded bits. Each unique subset includes fewer than all of the encoded bits corresponding to the second subset of the bit indices. The interleaving, at 3506 for example, may then involve separate interleaving of the encoded bits in each subset. FIG. 23D shows an example of two subsets being separately interleaved, and FIGS. 27, 30, 32, and 34 also illustrate embodiments in which separate interleaving involves block interleaving using two block interleavers of two different sizes.

One or more bit values may each be placed on multiple bit indices. For example, the values of the input bits may include multiple input bit values that are each placed on a respective first bit index in the first subset, and placed on a respective second bit index in the second subset based on the interleaving. A number of the bit indices in the second subset is based on a reduced code rate in some embodiments. As described at least above in the context of Embodiment 4, and as indicated by way of example in FIG. 31, the number of bit values that are placed on multiple bit indices between the u-code and the v-code may be reduced in FIG. 31 relative to preceding embodiments.

Capacity of a v-code may be impacted, for example, by reducing the number of encoded bits that are to be transmitted or otherwise output. This is one example of a reason why it may be desirable to place fewer bit values on v-code bit indices. More generally, placing fewer information bits on bit indices in the second subset reduces a code rate of encoded bits corresponding to the second subset, and this may be expressed as the number of bit indices in the second subset on which input bit values are placed being based on a reduced code rate or a target code rate.

A segmented approach may be applied to embodiments that involve a reduced code rate or target code rate, as shown by way of example in FIGS. 31 and 32. The values of the input bits may include multiple input bit values that are each placed on respective first bit indices in unique segments of the bit indices in the first subset (u-code in FIG. 31) and also placed on respective second bit indices in the second subset (v-code in FIG. 31) based on the interleaving and unique segments of the bit indices in the second subset that respectively correspond to the unique segments of the bit indices in the first subset. The solid arrows at the top of FIG. 31 are between corresponding unique segments of bit indices.

Interleaving of the subset of the encoded bits corresponding to the bit indices in the second subset may be applied across the encoded bit subset as a whole, or may involve separate interleaving unique subsets of the encoded bits. In the case of separate interleaving, the values of the input bits may include multiple input bit values that are each placed on respective first bit indices in the unique segments of the bit indices in the first subset (u-code in FIG. 31) and also placed on respective second bit indices in the second subset (v-code in FIG. 31) based on the separate interleaving and the unique segments of the bit indices in the second subset that respectively correspond to the unique segments of the bit indices in the first subset.

The number of bit indices in each of the unique segments of the bit indices in the second subset (v-code in FIG. 31) may be based on a reduced code rate, or respective reduced code rates of encoded bits that correspond to each segment. These examples illustrate what may be referred to as partial code rate reduction, or reduced or target partial code rate(s), related to each segment.

Embodiment 4 introduces per-segment code rate reduction ratios (see FIG. 32, for example), but a common code rate reduction ratio may be applied to a v-code, lower set, or second subset in conjunction with a segmented approach. A code rate reduction ratio, or per-segment code rate reduction ratios that have the same value, may be applied to each segment of the second subset of bit indices, and the number of bit indices in the second subset (and each segment) is based on a reduced code rate in these examples, even though multiple segments are involved. Different code rate reduction ratios may be applied to different segments. In general, the number of the bit indices in the second subset, or in each of the unique segments of the bit indices in the second subset, may be based on a reduced code rate or based on a respective reduced code rate for each segment. Code rate reduction ratios provide an example of how reduced code rates may be supported in some embodiments.

More generally, code rate reduction, whether on a per-segment or bit index set or subset basis, may be provided, enabled, or supported in any of various ways. For example, a code rate for a v-code, lower set, or second subset may first be set or determined, and then reduced by placing bit values on fewer bit indices. A reduced code rate may instead be determined and implemented by selection of bit indices for frozen bits and information bits according to the reduced code rate. Per-segment reduced partial code rates may similarly be provided, enabled, or supported in any of various ways, including these examples.

Placement of a bit value on multiple bit indices may be based on or dependent upon any of various criteria or conditions. For example, as disclosed at least above for Embodiment 5 and Embodiment 6, any one or more of interleaving, bit value placement, segmentation, and rate reduction may be based on or dependent upon, for example, code length, code rate, or both code length and code rate. Therefore, considering bit value placement in v-code as an example, the above-referenced second bit index on which a bit value is also placed may be dependent upon one or both of: a code length of the number of the encoded bits (also referred to herein as a code length of a mother code or a mother code length) and a code rate of the number of the encoded bits (also referred to herein as a code rate of a mother code or a mother code rate).

Single segment and multiple segment examples are provided elsewhere herein, including at least above in the context of Embodiment 5 and Embodiment 6. In some embodiments, both single segment and multiple segment features are supported and a determination as to whether single segment or multiple segment features are used.

As an example, consider an embodiment in which values of the input bits include multiple input bit values that are each placed both on a respective first bit index in the first subset, and on a respective second bit index in the second subset. The respective second bit indices are based on the interleaving (single segment) or are based on both the interleaving and unique segments of the bit indices in the second subset (multiple segment) that respectively correspond to unique segments of the bit indices in the first subset. Whether the respective second bit indices are based on the interleaving or are based on both the interleaving and the unique segments of the bit indices in the second subset may be dependent upon one or both of: a code length of the number of the encoded bits and a code rate of the number of the encoded bits.

Interleaving may also or instead be dependent upon one or both of a code length of the number of the encoded bits and a code rate of the number of the encoded bits.

The same code length and/or code rate may be used not only to select between single segment or multiple segment bit value placement, but also or instead to select between different interleaving options, different sort orders, and/or other options for features disclosed herein. Table 7 above provides an example of a parameter table in which various parameters, including interleaving, sorting, segmenting, and code rate reduction ratios, are specified for several code rates and code lengths. The parameters in FIG. 7 are illustrative of parameters or features that may be based on or dependent upon code rate and/or code length of a mother code, and may be referred to as code rate-dependent, code length-dependent, or jointly code rate and code length-dependent.

Features disclosed herein may also or instead be embodied in other forms. An ordered sequence of polar code bit indices, for example, may embody, or be modified to embody, disclosed features.

According to an embodiment, a method involves obtaining an ordered sequence indicating a plurality of bit indices for a polar code in an order of rank (by reliability for example) for placing values of input bits for encoding by the polar code to obtain a number of encoded bits. The order of rank indicated by the ordered sequence is for interleaving a subset of the encoded bits corresponding to the second subset of the bit indices and for reducing the number of the encoded bits, at 3508 in FIG. 35 for example. The bit indices include: a first set of bit indices of highest rank according to the ordered sequence, for placing the values of the input bits; and a second set of bit indices of lower rank than the highest rank according to the ordered sequence, for placing a predetermined bit value. The first set of bit indices includes a first subset of bit indices that includes a first bit index for placement of a first bit value of one of the input bits and a second subset of bit indices that includes a second bit index for placement of the first bit value Such a method may also involve encoding the input bits by the polar code according to the ordered sequence, to obtain the number of encoded bits at 3504 for example; interleaving the subset of the encoded bits corresponding to the second subset of the bit indices, at 3506 for example; and outputting the reduced number of the interleaved encoded bits at 3510 for example. Other features disclosed herein may also or instead be provided or supported in such a method.

Obtaining an ordered sequence may involve selecting from a number of available ordered sequences. For example, ordered sequences for different mother code lengths, transmitted or output code lengths, puncturing patterns, etc., may be pre-generated and specified in a communication standard or specification, and then selected for use in encoding based on encoding parameters or conditions. Another possible option for obtaining an ordered sequence involves modifying a base sequence that indicates the bit indices for the polar code in a base order of rank for placing the values of input bits for encoding by the polar code to obtain the number of encoded bits, and the base order of rank is for outputting the number of the encoded bits. In other words, a base sequence that does not take interleaving or partial code rate reduction as disclosed herein into account may be modified to obtain a sequence in which order of rank of bit indices, and thus the bit indices in each set, is for interleaving and reducing the number of the encoded bits and/or for providing or supporting other features disclosed herein. A communication standard or specification may specify one or more base sequences, and possibly instructions for modifying the base sequence(s) according to encoding parameters or conditions. A reliability sequence Q=[Q₁, Q₂ . . . Q_{N}], indicating bit indices in ascending reliability order, is an example of a base sequence.

At 3550, FIG. 35 illustrates various decoding and/or receiving counterparts of features shown at 3500. From a receiving device perspective, the receiving at 3552 represents receiving a reduced number of interleaved encoded bits that have been encoded by a polar code and interleaved before transmission. The receiving at 3552 may involve receiving the reduced number of interleaved encoded bits from a first communication device by a second communication device in a wireless communication network, for example. Encoded bits may be received through or via any of various types of interface, and embodiments are not in any way restricted to any particular type of interface.

The polar code, as in other embodiments herein, includes a number of bit indices for placing bit values before encoding, and the bit indices include a first set of bit indices for placing values of the input bits and a second set of bit indices for placing a predetermined bit value. The first set of bit indices includes a first subset of bit indices and a second subset of bit indices, and the values of the input bits include an input bit value that is placed on both a first bit index in the first subset and a second bit index in the second subset. The second bit index is based on interleaving of a subset of the encoded bits corresponding to the second subset of the bit indices. The subset is for reducing the number of the encoded bits.

The decoding at 3554 is intended to illustrate decoding the received reduced number of interleaved encoded bits to obtain decoded input bits. Decoding at 3554 may be implemented or performed by a decoder or a processor, for example.

In some embodiments, a decoder might not be a discrete device, but rather a block of logic in silicon or part of a system-on-chip that decodes and uses the decoded input bits. In other embodiments, the decoded input bits are output as shown at 3556, for processing and/or storage, for example.

Any or all of the features that are described herein in the context of encoder-side or transmitter-side methods, with reference to operations at 3500 in FIG. 35, for example, may also apply to or have counterpart features in a decoder-side or receiver-side method. Any one or more of the following features, for example, may be provided or supported, individually or in any of various combinations, in a decoder-side or receiver-side method:
the reduced number of the interleaved encoded bits may include a first reduced number of the interleaved encoded bits, and a method may also include receiving, in an incremental transmission from the first communication device by the second communication device, a second reduced number of the interleaved encoded bits corresponding to the second subset of bit indices, with the second reduced number of the interleaved encoded bits including one or more interleaved encoded bits not included in the first number of the interleaved encoded bits;
the number of bit indices is a number N, the first subset of bit indices is in an upper set of N/2 bit indices that includes (N/2+1)-th to N-th bit indices of the N bit indices, and the second subset of bit indices is in a lower set of N/2 bit indices that includes first to (N/2)-th bit indices of the N bit indices.

Other features related to decoding may also or instead be provided or supported in some embodiments. For example, the decoding at 3554 may involve decoding the values of the input bits from the reduced number of interleaved encoded bits according to a non-sequential decoding order. The non-sequential decoding order may enable decoding of the input bit value that is placed on both the first bit index and the second bit index based on decoding for the first bit index before decoding for the second bit index. For non-sequential decoding order, the first bit index is higher than the second bit index in an increasing order of bit indices. Non-sequential decoding may involve decoding for a u-code bit index before decoding for a v-code bit index, or more generally decoding bit indices out of order relative to a sequential order of those bit indices, as disclosed by way of example elsewhere herein.

Decoding at 3554 according to a non-sequential decoding order may involve switching between decoding for bit indices in the above-referenced first subset and decoding for bit indices in the second subset. This is disclosed at least in the context of Embodiment 7 above, and by way example in the context of switching between decoding for u-code bit indices (an example of bit indices the first subset) and decoding for bit indices in unique segments of the bit indices in the v-code (an example of bit indices in the second subset).

Switching during non-sequential decoding may involve segments in some embodiments. For example, FIG. 33 illustrates decoding of a u-code and three v-code segments, and decoding according to non-sequential decoding order in such an embodiment may involve switching between decoding for bit indices in the first subset (the u-code in FIG. 33) and decoding for bit indices in unique segments of the bit indices in the second subset (the v₁-code, the v₂-code, and the v₃-code in FIG. 33). Switching during decoding may also or instead involve switching between decoding for bit indices in different segments of the bit indices in the second subset, as shown by way of example for Option b (o₁-b, o₂-b, o₃-b) in FIG. 33.

In some embodiments, decoding may involve obtaining a decoding starting bit index for sequential decoding, and switching from sequential decoding to non-sequential decoding for one or more of the bit indices based on a switching condition. This is also illustrated by way of example in FIG. 33, for both Option a and Option b.

Switching during decoding may involve, consistent with Option a above for example, switching from decoding for the first bit index (a u-code index on which a bit value had been placed, for example) to decoding for the second bit index (a v-code index on which the same bit value had also been placed, for example). The decoding for the second bit index may be based on the decoding for the first index, and is described by way of example for Option a as decoding a v-code bit PC-frozen bit. The switching condition in this example is decoding for the first bit index, such that decoding for the second bit index (on which the same bit value was placed) can be based on the decoding for the first bit index.

After a switch during decoding, sequential decoding may resume. Thus, switching during decoding may also involve resuming sequential decoding. Option a is illustrative of an embodiment in which switching may involve resuming sequential decoding for one or more bit indices in the first subset (the u-code for example) that are subsequent to the first bit index, after the decoding for the second bit index. The switching condition for resuming sequential decoding is completion of decoding for the second bit index. There may be several switches back and forth between u-code decoding and v-code decoding as u-code bit values that had also been placed on v-code bit indices are decoded. A final switch back to resume u-code decoding as in Option a is illustrative of resuming sequential decoding to complete decoding of received encoded bits.

Another example of switching during decoding involves switching from sequential decoding for bit indices in the second subset that correspond to first received encoded bits of the subset (consistent with the Option b examples in FIG. 33, for example, where bits to the right of each starting bit index are the first received v-code bits) to decoding for bit indices in the second subset that correspond to second received encoded bits of the subset (to the left of each starting point in FIG. 33) that are received after the first received encoded bits. The switching condition in this example is completion of decoding for the bit indices corresponding to the first received encoded bits.

Switching during decoding may also involve switching from decoding for the bit indices in the second subset that correspond to the second received encoded bits to decoding for the bit indices in the first subset, after the decoding for the bit indices in the second subset that correspond to the second received encoded bits is complete. The progression from “2nd” to “3rd” in the Option b examples in FIG. 33 are illustrative of this type of switching. The switching condition in this example is completion of decoding for the bit indices that correspond to the second received encoded bits, or in other words completion of decoding all bits in the v-code in some embodiments.

A starting bit index may be obtained in any of various ways. For example, obtaining a decoding starting bit index may involve attempting to decode a reduced number of interleaved encoded bits by decoding from multiple decoding starting bit indices (three in the example shown in FIG. 34), and selecting one of the decoding starting bit indices for decoding the reduced number of interleaved encoded bits based on results of attempting to decode from each of the starting bit indices.

The decoding starting bit indices from which decoding is attempted may be or include starting bit indices that are selected from a predetermined set of decoding starting bit indices. Examples of such a set are described at least above for Embodiment 7 and shown in FIG. 34. Selection of starting bit indices from which decoding is to be attempted may be based on the number of interleaved encoded bits in the reduced number of interleaved encoded bits, or the code length of the received encoded bits. In the example shown in FIG. 34, selecting of decoding starting bit indices is based on code length, and involves selecting a number (three in the example shown) of starting bit indices in the set that are closest to the code length.

A sequence-based approach, described in an example above from an encoding perspective, may have counterpart receiving, decoding, and other features. A method may involve receiving a reduced number of interleaved encoded bits encoded by a polar code, with the polar code comprising bit indices for placing values of input bits, and the bit indices comprising: a first set of bit indices of highest rank according to an ordered sequence, for placing the values of the input bits before encoding; and a second set of bit indices of lower rank than the highest rank according to the ordered sequence, for a predetermined bit value. The ordered sequence indicates the bit indices in an order of rank for placing the values of the input bits for encoding by the polar code. The first set of bit indices comprises a first subset of bit indices that includes a first bit index for placement of a first bit value of one of the input bits and a second subset of bit indices that includes a second bit index for placement of the first bit value. The order of rank is for interleaving a subset of the encoded bits corresponding to the second subset of the bit indices and for reducing the number of the encoded bits. Such a method may also involve decoding the reduced number of interleaved encoded bits to obtain decoded input bits. A sequence-based method of this type is also consistent with a method shown in FIG. 35, including receiving at 3552 and decoding at 3554.

The ordered sequence in this example may have been obtained by selecting from among available sequences, or may have been obtained by modifying a base sequence. The base sequence may indicate the bit indices for the polar code in a base order of rank for placing the values of input bits for encoding by the polar code to obtain the number of encoded bits, with the base order of rank being for outputting the number of the encoded bits rather than the reduced number of the encoded bits.

Embodiments may involve other features or operations as well. For example, some embodiments may involve communicating signaling that is indicative of any of various parameters, such as any one or more of: code length, puncturing pattern, base sequence for determining an information set and a frozen set, etc. Communicating of signaling may involve transmitting the signaling by an encoder/encoding device or a transmitter/transmitting device that is to transmit encoded bits, to a decoder/decoding device or a receiver/receiving device. The communicating may also or instead involve receiving the signaling by a decoder/decoding device or a receiver/receiving device from an encoder/encoding device or a transmitter/transmitting device. Signaling need not necessarily be between, or only between, communication devices by which encoded bits are to be transmitted or received. For example, a network device such as a gNB or a base station may transmit signaling to configure parameters at one or more communication devices. Therefore, a method may involve a network device transmitting signaling, and an encoder/encoding device or a transmitter/transmitting device receiving the signaling from the network device, and/or a decoder/decoding device or a receiver/receiving device receiving the signaling from the network device.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor that is configured, by executing programming for example, to cause the apparatus to perform a method or operations, or to provide or support features, disclosed herein. An apparatus may also include a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to, or a processor, device, or other component may otherwise be configured to, encode a number of input bits by a polar code to obtain encoded bits, with the polar code comprising a number of bit indices for placing bit values before encoding. The bit indices include: a first set of bit indices for placing values of the input bits and a second set of bit indices for placing a predetermined bit value.

Programming may also include instructions to or to cause a processor to, or a processor, device, or other component may otherwise be configured to, interleave a subset of the encoded bits corresponding to the second subset of the bit indices. The subset is for reducing the number of the encoded bits.

The values of the input bits include an input bit value placed on both a first bit index in the first subset and a second bit index in the second subset, and the second bit index is based on the interleaving.

Programming may also include instructions to or to cause a processor to, or a processor, device, or other component may otherwise be configured to, output the reduced number of the interleaved encoded bits corresponding to the second subset of bit indices.

Apparatus embodiments are not limited to the foregoing examples, or to processor-based or programming-based embodiments. An apparatus may also or instead include, for example, an encoder for encoding the input bits by the polar code, an interleaver coupled to the encoder for interleaving the subset of the encoded bits, and an interface coupled to the interleaver for outputting the reduced number of the interleaved encoded bits corresponding to the second subset of bit indices. Encoded bits may be output via any of various types of interface, including a communication interface in the case of transmitting the encoded bits. Embodiments are not in any way restricted to any particular type of interface, the implementation of which may be based at least in part on how encoded bits are to be output.

FIG. 36 is a block diagram illustrating an apparatus in which embodiments may be implemented or supported. The example apparatus 3600 includes a polar encoder 3602, an interleaver 3604 coupled to the polar encoder, and a rate matching module 3606 coupled to the interleaver. Input bits for encoding are shown as input TB or payload bits, and rate-matched encoded bits are shown as an output of the rate matching module 4106. An interface for transmitting or otherwise outputting the reduced number of encoded bits may be provided by, incorporated into, or coupled to, any one or more of the polar encoder 3602, the interleaver 3604, and the rate matching module 3606.

Encode-side or transmit-side features or functions, and other features or functions herein, may be implemented in any of various ways, such as in hardware, firmware, or one or more components that execute software. The present disclosure is not limited to any specific type of implementation, and implementation details may vary between different devices, for example.

The rate matching module 3606 is shown as an example of a component or device that may provide or support reducing the number of interleaved encoded bits that are output, for transmission for example. Encoded bit reduction may be provided or supported in a different manner than shown.

In an embodiment, an apparatus includes the polar encoder 3602 for encoding input bits by a polar code to obtain a number of encoded bits. The polar code comprises a number of bit indices for placing bit values before encoding, and the bit indices include a first set of bit indices for placing values of the input bits and a second set of bit indices for placing a predetermined bit value. The first set of bit indices includes a first subset of bit indices and a second subset of bit indices.

The interleaver 3604 is coupled to the polar encoder for interleaving a subset of the encoded bits corresponding to the second subset of the bit indices, and the subset is for reducing the number of the encoded bits (by the rate matching module 3606, for example). The values of the input bits comprise an input bit value that is placed on both a first bit index in the first subset and a second bit index in the second subset. The second bit index is based on the interleaving.

An interface (not shown) may be provided by or otherwise coupled to the interleaver 3604, directly or through the rate matching module 3606 in the example shown, for outputting the reduced number of the interleaved encoded bits corresponding to the second subset of bit indices.

More generally, an apparatus or a component thereof such as an encoder 3602 or a processor may be configured to encode (or for encoding) input bits, or programming may include instructions to encode (or for encoding) input bits or to cause a processor to encode input bits, to obtain encoded bits. An apparatus or a component thereof such as an interleaver 3604 coupled to an encoder may be configured to interleave (or for interleaving), or programming may include instructions to interleave (or for interleaving) or to cause a processor to interleave, a subset of the encoded bits corresponding to the second subset of bit indices. An apparatus or a component thereof such as an interface coupled to the interleaver may be configured to output (or for outputting), or programming may include instructions to output (or for outputting) or to cause a processor to output, encoded bits, such as a reduced number of interleaved encoded bits corresponding to the second subset of bit indices.

Embodiments related to such apparatus or non-transitory computer readable storage media may include any one or more of the following features, for example, which are also discussed elsewhere herein:
the apparatus or a component thereof such as the interface may be configured or further configured to transmit (or for transmitting), or programming may include instructions to transmit (or for transmitting) or to cause a processor to transmit: the reduced number of the interleaved encoded bits from a first communication device to a second communication device in a wireless communication network;
the reduced number of the interleaved encoded bits comprises a first reduced number of the interleaved encoded bits, and the apparatus or a component thereof such as the interface may be configured or further configured to transmit (or for transmitting), or programming may include instructions to transmit (or for transmitting) or to cause a processor to transmit: in an incremental transmission from the first communication device to the second communication device, a second reduced number of the interleaved encoded bits corresponding to the second subset of bit indices, the second reduced number of the interleaved encoded bits comprising one or more of the interleaved encoded bits not included in the first number of the interleaved encoded bits;
the first bit index is based on an ascending order of rank associated with the first set of bit indices;
the second bit index is based on an interleaved order of the encoded bits;
the first bit index is based on an ascending index order associated with the first set of bit indices;
the subset of the encoded bits comprises one of a plurality of unique subsets of the encoded bits, with each unique subset including fewer than all of the encoded bits corresponding to the second subset of the bit indices, and the apparatus or a component thereof such as the interleaver may be configured or further configured to separately interleave (or for separate interleaving of), or programming may include instructions to separately interleave (or for separate interleaving of) or to cause a processor to separately interleave: the encoded bits in each subset of the plurality of subsets of the encoded bits, including the subset;
the values of the input bits comprise a plurality of input bit values that are each placed both on a respective first bit index in the first subset, and on a respective second bit index in the second subset based on the interleaving, with a number of the bit indices in the second subset being based on a reduced code rate;
the values of the input bits comprise a plurality of input bit values that are each placed both on respective first bit indices in unique segments of the bit indices in the first subset, and on respective second bit indices in the second subset based on the interleaving and unique segments of the bit indices in the second subset that respectively correspond to the unique segments of the bit indices in the first subset, with a number of the bit indices in each of the unique segments of the bit indices in the second subset being based on a reduced code rate;
the values of the input bits comprise a plurality of input bit values that are each placed both on respective first bit indices in unique segments of the bit indices in the first subset, and on respective second bit indices in the second subset based on the separate interleaving and unique segments of the bit indices in the second subset that respectively correspond to the unique segments of the bit indices in the first subset and to the unique subsets of the encoded bits, with a number of the bit indices in each of the unique segments of the bit indices in the second subset being based on a respective reduced code rate;
the second bit index is further dependent upon one or both of: a code length of the number of the encoded bits and a code rate of the number of the encoded bits;
the values of the input bits comprise a plurality of input bit values that are each placed both on a respective first bit index in the first subset, and on a respective second bit index in the second subset; and the respective second bit indices are based on the interleaving or are based on both the interleaving and unique segments of the bit indices in the second subset that respectively correspond to unique segments of the bit indices in the first subset;
whether the respective second bit indices are based on the interleaving or are based on both the interleaving and the unique segments of the bit indices in the second subset is dependent upon one or both of: a code length of the number of the encoded bits and a code rate of the number of the encoded bits;
the interleaving is dependent upon one or both of: a code length of the number of the encoded bits and a code rate of the number of the encoded bits;
the interleaving is dependent upon one or both of: the code length of the number of the encoded bits and the code rate of the number of the encoded bits;
the number of bit indices is a number N, the first subset of bit indices is in an upper set of N/2 bit indices that includes (N/2+1)-th to N-th bit indices of the N bit indices, and the second subset of bit indices is in a lower set of N/2 bit indices that includes first to (N/2)-th bit indices of the N bit indices.

In another apparatus embodiment, an apparatus includes an encoder such as 3602 for obtaining an ordered sequence and encoding input bits by a polar code according to the ordered sequence, to obtain a number of encoded bits; an interleaver such as 3604; and an interface. The ordered sequence indicates a plurality of bit indices for the polar code in an order of rank for placing values of input bits for encoding by the polar code, and the bit indices comprise: a first set of bit indices of highest rank according to the ordered sequence, for placing the values of the input bits before encoding; and a second set of bit indices of lower rank than the highest rank according to the ordered sequence, for placing a predetermined bit value. The first set of bit indices comprises a first subset of bit indices that includes a first bit index for placement of a first bit value of one of the input bits and a second subset of bit indices that includes a second bit index for placement of the first bit value. The order of rank is for interleaving a subset of the encoded bits (by the interleaver 3604 for example) corresponding to the second subset of the bit indices and for reducing the number of the encoded bits (by the rate matching module 3606 for example).

In an embodiment, an interleaver such as the interleaver 3604 is coupled to the encoder for interleaving the subset of the encoded bits corresponding to the second subset of the bit indices, and an interface is coupled to the interleaver, directly or through one or more other components or devices such as the rate matching module 3606, for outputting the reduced number of the interleaved encoded bits corresponding to the second subset of bit indices.

In some embodiments, the apparatus or a component thereof such as the encoder 3602 may be configured to obtain (or for obtaining), or programming may include instructions to obtain (or for obtaining) or to cause a processor to obtain, the ordered sequence by modifying a base sequence. The base sequence indicates the plurality of bit indices for the polar code in a base order of rank for placing the values of input bits for encoding by the polar code to obtain the number of encoded bits, and the base order of rank is for outputting the number of the encoded bits.

For a decoder-side or receiver-side apparatus or a computer program product comprising a non-transitory computer readable storage medium to support decoder-side or receiver-side operations, the apparatus or a component thereof such as an interface may be configured to receive (or for receiving), or programming may include instructions to receive (or for receiving) or to cause a processor to receive, a reduced number of interleaved encoded bits that have been encoded by a polar code. Such an apparatus or a component thereof such as a decoder may be configured to decode (or for decoding), or programming may include instructions to decode (or for decoding) or to cause a processor to decode, the reduced number of interleaved encoded bits to obtain decoded input bits. As in other embodiments, the polar code comprises bit indices for placing bit values before encoding, and the bit indices comprise: a first set of bit indices for values of input bits and a second set of bit indices for a predetermined bit value. The first set of bit indices includes a first subset of bit indices and a second subset of bit indices, the values of the input bits include an input bit value placed on both a first bit index in the first subset and a second bit index in the second subset, the second bit index is based on interleaving of a subset of the encoded bits corresponding to the second subset of the bit indices, and the subset is for reducing the number of the encoded bits.

Embodiments related to such apparatus or non-transitory computer readable storage media may include any one or more of the following features, for example, which are also discussed elsewhere herein:
the apparatus or a component thereof such as an interface may be configured or further configured to receive (or for receiving), or programming may include instructions to receive (or for receiving) or to cause a processor to receive, the reduced number of interleaved encoded bits from a first communication device by a second communication device in a wireless communication network;
the reduced number of the interleaved encoded bits comprises a first reduced number of the interleaved encoded bits, and the apparatus or a component thereof such as an interface may be configured or further configured to receive (or for receiving), or programming may include instructions to receive (or for receiving) or to cause a processor to receive, receive, in an incremental transmission from the first communication device by the second communication device, a second reduced number of the interleaved encoded bits corresponding to the second subset of bit indices, the second reduced number of the interleaved encoded bits comprising one or more interleaved encoded bits not included in the first number of the interleaved encoded bits;
the apparatus or a component thereof such as a decoder may be configured to decode (or for decoding), or programming may include instructions to decode (or for decoding) or to cause a processor to decode, the values of the input bits from the reduced number of interleaved encoded bits according to a non-sequential decoding order;
the non-sequential decoding order enables decoding of the input bit value placed on both the first bit index and the second bit index based on decoding for the first bit index before decoding for the second bit index;
the decoding according to the non-sequential decoding order comprises switching between decoding for bit indices in the first subset and decoding for bit indices in the second subset;
the decoding according to the non-sequential decoding order comprises switching between decoding for bit indices in the first subset and decoding for bit indices in unique segments of the bit indices in the second subset;
the apparatus or a component thereof such as a decoder may be configured to decode (or for decoding), or programming may include instructions to decode (or for decoding) or to cause a processor to decode, by: obtaining a decoding starting bit index for sequential decoding, and switching from the sequential decoding to non-sequential decoding for one or more of the bit indices based on a switching condition;
the apparatus or a component thereof such as a decoder may be configured to switch (or for switching), or programming may include instructions to switch (or for switching) or to cause a processor to switch, by: switching from decoding for the first bit index to decoding for the second bit index, the decoding for the second bit index being based on the decoding for the first index, and resuming sequential decoding for a bit index in the first subset that is subsequent to the first bit index, after the decoding for the second bit index;
the apparatus or a component thereof such as a decoder may be configured to switch (or for switching), or programming may include instructions to switch (or for switching) or to cause a processor to switch, by: switching from sequential decoding for bit indices in the second subset that correspond to first received encoded bits of the subset to decoding for bit indices in the second subset that correspond to second received encoded bits of the subset received after the first received encoded bits; and switching from decoding for the bit indices in the second subset that correspond to the second received encoded bits to decoding for the bit indices in the first subset, after the decoding for the bit indices in the second subset that correspond to the second received encoded bits is complete;
the apparatus or a component thereof such as a decoder may be configured to obtain (or for obtaining), or programming may include instructions to obtain (or for obtaining) or to cause a processor to obtain, the decoding starting bit index by: attempting to decode the reduced number of interleaved encoded bits by decoding from a plurality of decoding starting bit indices; and selecting one of the decoding starting bit indices for decoding the reduced number of interleaved encoded bits based on results of the attempting to decode;
the plurality of decoding starting bit indices comprise decoding starting bit indices selected from a predetermined set of decoding starting bit indices based on the number of interleaved encoded bits in the reduced number of interleaved encoded bits;
the number of bit indices is a number N, the first subset of bit indices is in an upper set of N/2 bit indices that includes (N/2+1)-th to N-th bit indices of the N bit indices, and the second subset of bit indices is in a lower set of N/2 bit indices that includes first to (N/2)-th bit indices of the N bit indices.

In another apparatus embodiment, an apparatus includes an interface for receiving a reduced number of interleaved encoded bits encoded by a polar code. The polar code comprising a number of bit indices for placing bit values before encoding, and the bit indices comprise: a first set of bit indices of highest rank according to an ordered sequence, for placing values of input bits; and a second set of bit indices of lower rank than the highest rank according to the ordered sequence, for placing a predetermined bit value. the ordered sequence indicates the plurality of bit indices in an order of rank for placing the values of the input bits for encoding by the polar code, the first set of bit indices comprises a first subset of bit indices that includes a first bit index for placement of a first bit value of one of the input bits and a second subset of bit indices that includes a second bit index for placement of the first bit value, and the order of rank for interleaving a subset of the encoded bits corresponding to the second subset of the bit indices and for reducing the number of the encoded bits. Such an apparatus may also include a decoder, coupled to the interface, for decoding the reduced number of interleaved encoded bits to obtain decoded input bits.

In some embodiments, the apparatus or a component thereof such as the decoder may be configured to obtain (or for obtaining), or programming may include instructions to obtain (or for obtaining) or to cause a processor to obtain, the ordered sequence by modifying a base sequence. More generally, the ordered sequence may be or may have been obtained by modifying a base sequence. The base sequence indicates the plurality of bit indices for the polar code in a base order of rank for placing the values of input bits for encoding by the polar code to obtain the number of encoded bits, and the base order of rank is for outputting the number of the encoded bits.

Apparatus embodiments are not in any way restricted to single devices. A system, for example, may include a first communication device and a second communication device. The first communication device may be configured to transmit (or for transmitting) a reduced number of interleaved encoded bits obtained by encoding input bits by a polar code and interleaving a subset of a number of encoded bits obtained by the encoding. The second communication device may be configured to receive (or for receiving) the reduced number of the interleaved encoded bits from the first communication device, and to decode the reduced number of the interleaved encoded bits to obtain decoded input bits. The polar code comprises a number of bit indices for placing bit values before encoding, and the bit indices comprise: a first set of bit indices for placing values of the input bits and a second set of bit indices for placing a predetermined bit value. The first set of bit indices comprises a first subset of bit indices and a second subset of bit indices. The subset of the encoded bits corresponds to the second subset of the bit indices, and the subset is for reducing the number of the encoded bits. The values of the input bits comprise an input bit value placed on both a first bit index in the first subset and a second bit index in the second subset, and the second bit index is based on the interleaving.

The first communication device in a system may also or instead implement, provide, or support other encode-side or transmit-side features disclosed herein, and similarly the second communication device in a system may also or instead implement, provide, or support other decode-side or receive-side features disclosed herein.

More generally, other features disclosed herein may also or instead be provided in method, apparatus, and/or system embodiments.

Embodiments disclosed herein encompass various aspects of polar coding, including encoding and decoding.

Disclosed embodiments may provide a fundamental upgrade of polar codes, and may make polar codes applicable for a much wider set of scenarios.

For example, disclosed embodiments may be implemented as part of a channel coding scheme, and may thus be applicable wherever channel coding is used. This covers a very wide range of scenarios. The flexibility provided by embodiments disclosed herein may help make the associated channel coding scheme particularly suitable for wireless communications.

Possible product deployments, in or in conjunction with which embodiments may be implemented, include network devices such as base stations, access devices such as UEs, robots, sensors, cars, drones, and satellites. Service deployment examples include enhanced mobile broadband (eMBB), ultra-reliable low latency communications (URLLC), massive machine type communications (mMTC)/Internet of things (IoT), and vehicular and industry scenarios. Network deployment examples include 5G+, 6G, WiFi, non-terrestrial networks (NTNs), optical networks, distributed networks, and self-organized networks. These are illustrative and non-limiting examples, and other deployments, implementations, or applications are possible.

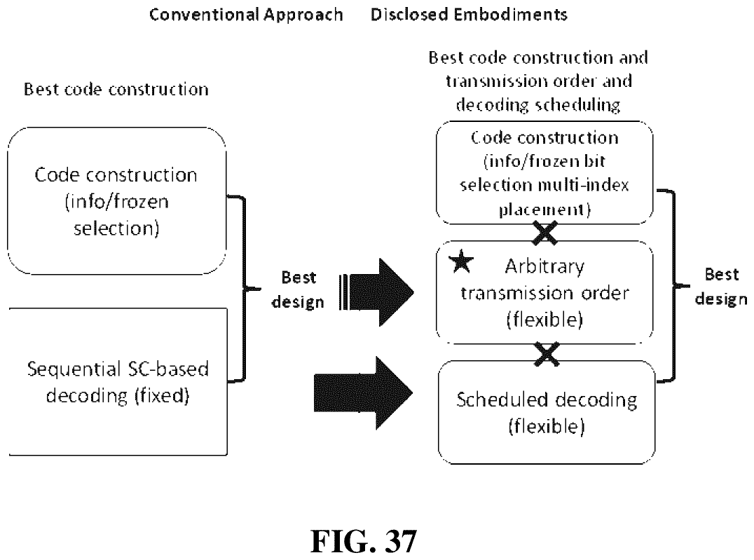

Three components that are considered in detail herein include specific code construction approaches, specific bit transmission order, and scheduled decoding. FIG. 37 is a block diagram illustrating code construction and decoding scheduling consistent with the present disclosure, compared with a conventional approach to code construction. Code construction as disclosed herein involves placing bit values on more than one bit index (optionally using bit labeling), and potentially partial rate reduction by placing fewer of such bits on multiple bit indices. Encoded bit transmission order, with partial interleaving and encoded bit reduction as disclosed herein (such as half-interleaved rate matching as an example), provides for arbitrary and flexible order of transmission of encoded bits. Scheduled decoding may be SC-based in some embodiments, but is flexible rather than fixed sequential decoding according to the conventional approach as shown in FIG. 37. The three components of code construction, transmission order, and scheduled decoding may be combined in manners disclosed herein, and may together create or provide more degrees of freedom for higher polar coding gain.

Some embodiments herein also provide simple descriptions that may be desirable for communication standards or specifications. For example, only a few sequences and/or parameters may be used to unambiguously specify rateless polar codes, such as a reliability ordered sequence to support code length up to Nₘₐₓ, a set of parameters (number, width, height) for one or more block interleavers, and a set of parameters (v-code segmentation and/or rate reduction ratio) for segmentation with partial rate reduction. Other parameters may be used in other embodiments. For example, the number of interleavers need not be explicitly specified, and an example that uses only interleaver row size to specify interleaving is provided herein. V-code segmentation could be used in bit value placement without partial rate reduction, and this illustrates that not all parameters need necessarily always be specified.

Decoding as disclosed herein may be beneficial in helping avoid catastrophic performance degradation that may otherwise affect conventional approaches that use or support only sequential decoding.

More generally, embodiments may be advantageous in helping to achieve true ratelessness for polar codes. Consistent with aspects of the present disclosure, a length Nₘₐₓ code may be constructed only once and used for all code lengths up to length Nₘₐₓ, by extracting an (M, K) polar code for arbitrary K≤M≤Nₘₐₓ from the length Nₘₐₓ code. The coding gain of an independently constructed (M, K) polar code can be provided without having to independently construct the (M, K) polar code.

Some embodiments combine bit placement (using bit labeling for example), partial code rate reduction, partial interleaving, and scheduled decoding. Such features may help achieve true ratelessness for polar codes, and/or performance comparable to that of existing non-rateless polar codes at various code lengths and rates.

As an example, rateless polar codes consistent with the present disclosure may have stable and significant coding gain over repetition polar codes, which simply repeat an (N/2, K) polar code to achieve a longer (M, K) polar code. Rateless polar codes consistent with the present disclosure are also expected to have similar performance to 5G NR polar codes and Gaussian-approximation-constructed polar codes. More importantly, rateless polar codes with partial interleaving as proposed herein may outperform similar codes without partial interleaving.

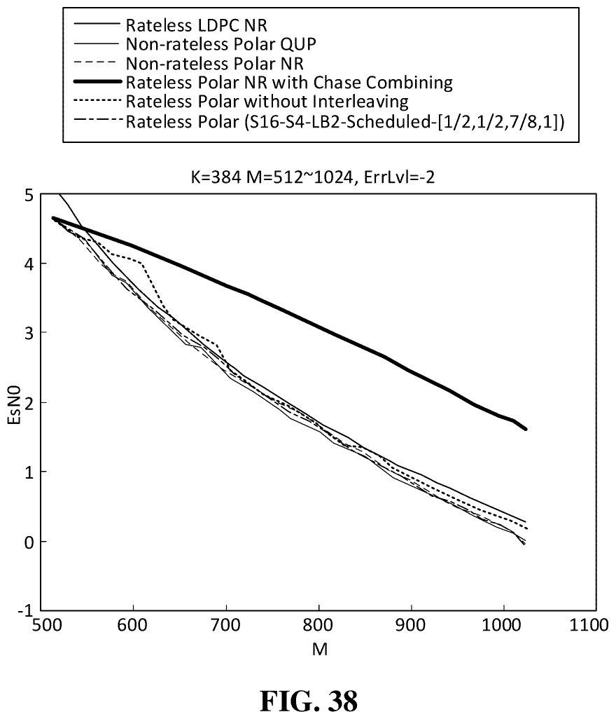

FIG. 38 includes plots illustrating error correction performance. The plot for a rateless polar code consistent with the present disclosure is labelled “Rateless Polar (S16-S4-LB2-Scheduled-[½, ½, ⅞, 1])” and has stable and significant coding gain over a repetition polar code (“Rateless Polar NR with Chase Combining” in the legend), which simply repeats an (N/2, K) polar code to achieve a longer (M, K) polar code. The example rateless polar code consistent with the present disclosure also has similar performance to 5G NR polar codes (“Non-rateless Polar NR” in the legend”) and Gaussian-approximation-constructed polar codes (“Non-rateless Polar QUP” in the legend”). FIG. 38 also illustrates that the example rateless polar code with partial interleaving consistent with the disclosure herein outperforms an example rateless polar code without partial interleaving (“Rateless Polar without Interleaving” in the legend”) in the example shown. A comparative plot for an example rateless LDPC NR code is also shown in FIG. 38. The plots in FIG. 38 are for an example of K=384 and M=512 to 1024 for a range of code lengths and code rates. Similar or different performance may be observed under similar or different conditions.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

What is claimed is:

1. A method comprising:
encoding input bits by a polar code to obtain a number of encoded bits, the polar code comprising a number of bit indices for placing bit values before encoding, the bit indices comprising: a first set of bit indices for placing values of the input bits and a second set of bit indices for placing a predetermined bit value, the first set of bit indices comprising a first subset of bit indices and a second subset of bit indices; and
interleaving a subset of the encoded bits corresponding to the second subset of bit indices, the subset of the encoded bits for reducing the number of the encoded bits and obtaining a reduced number of interleaved encoded bits, the values of the input bits comprising an input bit value placed on both a first bit index in the first subset and a second bit index in the second subset, the second bit index being based on the interleaving; and
outputting the reduced number of the interleaved encoded bits corresponding to the second subset of bit indices.

2. The method of claim 1, further comprising:
transmitting the reduced number of the interleaved encoded bits from a first communication device to a second communication device in a wireless communication network, wherein the reduced number of the interleaved encoded bits comprises a first reduced number of the interleaved encoded bits; and
transmitting, in an incremental transmission from the first communication device to the second communication device, a second reduced number of the interleaved encoded bits corresponding to the second subset of bit indices, the second reduced number of the interleaved encoded bits comprising one or more of the interleaved encoded bits not included in the first reduced number of the interleaved encoded bits.

3. The method of claim 1, wherein the first bit index is based on an ascending order of rank associated with the first set of bit indices or an ascending index order associated with the first set of bit indices, and the second bit index is based on an interleaved order of the encoded bits.

4. The method of claim 1,
wherein the subset of the encoded bits comprises one of a plurality of unique subsets of the encoded bits, each unique subset including fewer than all of the encoded bits corresponding to the second subset of the bit indices, and
wherein the interleaving comprises separate interleaving of the encoded bits in each subset of the plurality of unique subsets of the encoded bits, including the subset of the encoded bits.

5. The method of claim 1,
wherein the values of the input bits comprise a plurality of input bit values that are each placed both on a respective first bit index in the first subset, and on a respective second bit index in the second subset based on the interleaving, and
wherein a number of the bit indices in the second subset is based on a reduced code rate.

6. The method of claim 1,
wherein the values of the input bits comprise a plurality of input bit values that are each placed both on respective first bit indices in unique segments of the bit indices in the first subset, and on respective second bit indices in the second subset based on the interleaving and unique segments of the bit indices in the second subset that respectively correspond to the unique segments of the bit indices in the first subset, and
wherein a number of the bit indices in each of the unique segments of the bit indices in the second subset is based on a reduced code rate.

7. A method comprising:
receiving a reduced number of interleaved encoded bits encoded by a polar code, the polar code comprising a number of bit indices for placing bit values before encoding, the bit indices comprising: a first set of bit indices for placing values of input bits and a second set of bit indices for placing a predetermined bit value, the first set of bit indices comprising a first subset of bit indices and a second subset of bit indices,
the values of the input bits comprising an input bit value placed on both a first bit index in the first subset and a second bit index in the second subset, the second bit index being based on interleaving of a subset of the encoded bits corresponding to the second subset of the bit indices, and the subset of the encoded bits for reducing the number of the encoded bits; and
decoding the reduced number of interleaved encoded bits to obtain decoded input bits.

8. The method of claim 7, wherein the receiving comprises:
receiving the reduced number of interleaved encoded bits from a first communication device by a second communication device in a wireless communication network, wherein the reduced number of the interleaved encoded bits comprises a first reduced number of the interleaved encoded bits; and
receiving, in an incremental transmission from the first communication device by the second communication device, a second reduced number of the interleaved encoded bits corresponding to the second subset of bit indices, the second reduced number of the interleaved encoded bits comprising one or more interleaved encoded bits not included in the first reduced number of the interleaved encoded bits.

9. The method of claim 7, wherein the decoding comprises decoding the values of the input bits from the reduced number of interleaved encoded bits according to a non-sequential decoding order.

10. The method of claim 7, wherein the decoding comprises:
obtaining a decoding starting bit index for sequential decoding; and
switching from the sequential decoding to non-sequential decoding for one or more of the bit indices based on a switching condition.

11. An apparatus comprising:
an encoder for encoding input bits by a polar code to obtain a number of encoded bits, the polar code comprising a number of bit indices for placing bit values before encoding, the bit indices comprising: a first set of bit indices for placing values of the input bits and a second set of bit indices for placing a predetermined bit value, the first set of bit indices comprising a first subset of bit indices and a second subset of bit indices; and
an interleaver, coupled to the encoder, for interleaving a subset of the encoded bits corresponding to the second subset of the bit indices, the subset of the encoded bits for reducing the number of the encoded bits and obtaining a reduced number of interleaved encoded bits, the values of the input bits comprising an input bit value placed on both a first bit index in the first subset and a second bit index in the second subset, and the second bit index being based on the interleaving; and
an interface coupled to the interleaver, for outputting the reduced number of the interleaved encoded bits corresponding to the second subset of bit indices.

12. The apparatus of claim 11, the interface being further configured to:
transmit the reduced number of the interleaved encoded bits from a first communication device to a second communication device in a wireless communication network, wherein the reduced number of the interleaved encoded bits comprises a first reduced number of the interleaved encoded bits; and
transmit, in an incremental transmission from the first communication device to the second communication device, a second reduced number of the interleaved encoded bits corresponding to the second subset of bit indices, the second reduced number of the interleaved encoded bits comprising one or more of the interleaved encoded bits not included in the first reduced number of the interleaved encoded bits.

13. The apparatus of claim 11, wherein the first bit index is based on an ascending order of rank associated with the first set of bit indices or an ascending index order associated with the first set of bit indices, and the second bit index is based on an interleaved order of the encoded bits.

14. The apparatus of claim 11,
wherein the subset of the encoded bits comprises one of a plurality of unique subsets of the encoded bits, each unique subset including fewer than all of the encoded bits corresponding to the second subset of the bit indices, and
wherein the interleaver is configured for separate interleaving of the encoded bits in each subset of the plurality of unique subsets of the encoded bits, including the subset of the encoded bits.

15. The apparatus of claim 11,
wherein the values of the input bits comprise a plurality of input bit values that are each placed both on a respective first bit index in the first subset, and on a respective second bit index in the second subset based on the interleaving, and
wherein a number of the bit indices in the second subset is based on a reduced code rate.

16. The apparatus of claim 11,
wherein the values of the input bits comprise a plurality of input bit values that are each placed both on respective first bit indices in unique segments of the bit indices in the first subset, and on respective second bit indices in the second subset based on the interleaving and unique segments of the bit indices in the second subset that respectively correspond to the unique segments of the bit indices in the first subset, and
wherein a number of the bit indices in each of the unique segments of the bit indices in the second subset is based on a reduced code rate.

17. An apparatus comprising:
an interface for receiving a reduced number of interleaved encoded bits encoded by a polar code, the polar code comprising a number of bit indices for placing bit values before encoding, the bit indices comprising: a first set of bit indices for placing values of input bits and a second set of bit indices for placing a predetermined bit value, the first set of bit indices comprising a first subset of bit indices and a second subset of bit indices, the values of the input bits comprising an input bit value placed on both a first bit index in the first subset and a second bit index in the second subset, the second bit index being based on interleaving of a subset of the encoded bits corresponding to the second subset of the bit indices, the subset of the encoded bits for reducing the number of the encoded bits to obtain a reduced number of interleaved encoded bits; and
a decoder, coupled to the interface, for decoding the reduced number of interleaved encoded bits to obtain decoded input bits.

18. The apparatus of claim 17, wherein the interface is configured to:
receive the reduced number of interleaved encoded bits from a first communication device by a second communication device in a wireless communication network, wherein the reduced number of the interleaved encoded bits comprises a first reduced number of the interleaved encoded bits; and
receive, in an incremental transmission from the first communication device by the second communication device, a second reduced number of the interleaved encoded bits corresponding to the second subset of bit indices, the second reduced number of the interleaved encoded bits comprising one or more interleaved encoded bits not included in the first reduced number of the interleaved encoded bits.

19. The apparatus of claim 17, wherein the decoder is configured for decoding the values of the input bits from the reduced number of interleaved encoded bits according to a non-sequential decoding order.

20. The apparatus of claim 17, wherein the decoder is configured for decoding by:
obtaining a decoding starting bit index for sequential decoding; and
switching from the sequential decoding to non-sequential decoding for one or more of the bit indices based on a switching condition.
